(19) United States
(12) Patent Application Publication
(10) Pub. No.: US 2013/0297371 A1
(43) Pub. Date: Nov. 7, 2013

(54) SYSTEM AND METHOD FOR AN INTEGRATED WORKFLOW PROCESS, SOCIAL, CONTACT AND WEB MARKETING SOLUTION

(71) Applicant: TIM VASKO, VICTORIA (CA)

(72) Inventor: TIM VASKO, VICTORIA (CA)

(21) Appl. No.: 13/847,401

(22) Filed: Mar. 19, 2013

Related U.S. Application Data
(63) Continuation of application No. 13/368,893, filed on Feb. 8, 2012.

(51) Int. Cl. G06Q 10/06; G06Q 50/00

(52) U.S. Cl. CPC G06Q 10/0633; G06Q 50/01
USPC 705/7.27

(57) ABSTRACT

This invention relates to data processing for financial, business practice, management or cost/price determination applications where there is a computerized arrangement for the management of interaction between individuals or entities that are connected by social networking and specifically to a system and method for an integrated workflow process, social, contact and web management solution.

### CROSS-REFERENCE TO RELATED APPLICATIONS

This submission is a continuation application of Ser. No. 13368893 Filed on Feb. 8, 2012.

### FEDERAL SPONSORSHIP

N/A

### TECHNICAL FIELD

This invention relates to the data processing for financial, business practice, management or cost/price determination applications where there is a computerized arrangement for the management of interaction between individuals or entities that are connected by social networking and specifically to a system and method for an integrated workflow process, social, contact and web management solution.

### BACKGROUND ART

In 2009 e-mail marketing generated over $26 billion dollars in sales. Millions of businesses are using opt-in marketing to communicate better with their customers, remind them of products, sales and special events. When done right, opt-in e-mail marketing can create a loyal, profitable customer base. However, business marketing methods and systems have yet to take full advantage of the marketing opportunities presented by social media and the creation of social spaces. The evolution of communication and information sharing through social media combined with cloud based computing has given rise to a plethora of ‘spaces’ that a business or individual needs to participate in and track by having access to efficient workflow processes. To date, social networking application such as Twitter™ and FaceBook™, Blog™, LinkedIn™ Profile, YouTube™ and Flickr™ are used in a disconnected matter. Having to keep up with the many ways that people communicate and interact presents a challenge for businesses wanting to create and maintain a profile and active presence on social networks as well as track and participate in customer communications over social networking applications. There are three major problems associated with placing and keeping a business in the market;

1. Presence: the business has to be able to locate where its clients are conversing, searching and socializing. With so many social networking applications, finding the client is often hit and miss.

2. Maintenance: the business must spend a large amount of resources to learn and update the various social networking applications and spaces used by clients to socialize and search.

3. Connections: the business must identify the correct market and then manage information on the large number of connections by responding to communications and capturing data. This includes e-mail, cellular phone texting, instant messenger, blogs, telephones and faxes.

### TECHNICAL PROBLEM

Therefore, there is a continued need for a social media aggregation site that can customize for any business and bring together various social media. The creation of a social space can bring together a disconnected social media presence and make it easy for customers to see what a business has been Tweeting, posting and talking about.

### DISCLOSURE OF INVENTION

### Technical Solution

The present invention is a system and method for establishing workflow process for an integrated social, contact and web marketing solution. The system involves a series of multi-dimensional workflows and state machines within interactive process spaces. The process model has particular elements from the state machine and workflow engine that provide a user interface by exposing traditional linear functions in workflows to the user and through interaction the users performing the redaction (the redactors) add process elements of their own. This has the effect of creating a new state machine flow and opportunity for the redactor (user) to have control via the altered state machine created by the redactor.

The state machines are combined in sequence to allow users to interact at various levels not previously accessible. In the case of a workflow in a pharmacy, for an example, a doctor at the point of care with a patient, can take a credit card, change and address at the same time as accessing an active formulary and providing a prescription on a real time basis. The state machine workflows on the pharmacy floor typically handle a linear fill, ship and bill process. In the business process object integration model the processes of formulary access, billing and shipping or any other workflow based process at the pharmacy level including but not limited to compounding medications, medication and over the counter products and combinations of these are accessed at the point of care.

The combination of workflows is provided through specific space application gadgets, where the interface is grouped using targeted data calls directly into the workflow purpose. This model modifies the traditional state machine algorithm and flow. The variable of outside influence is added by users through permission mechanisms. The interaction of these outside users creates a multi-level state machine variance where new states are introduced. These are merged through ‘function points’ into the existing state to create a new state flow.

The invention is a computer driven system and method for generating an enterprise customized workflow management process. The process includes the integration of social marketing to business process work and process flows. The method comprises the following major processes: an enrolment process, a set-up process, a process to create a computer driven workflow environment for the enterprise and a process to create a customized dashboard as a user interface so that the user can use the dashboard to access the customized workflow management process. The method is scalable for any size enterprise ranging from a single individual to a family to a large corporation.

### Advantageous Effects

The following advantages apply to one or more aspects of the invention:

1. Power- automated connectivity that makes business information flow faster at less expense;

2. Flexibility- easily customized to any business;

3. Reliability- outstanding record of 99% uptime.

4. These and other advantages of one or more aspects of the invention will become apparent from a consideration of the ensuing description and accompanying drawings.

### DESCRIPTION OF DRAWINGS

FIG. 1 is a depiction of an enrolment screen of the invention.

FIG. 2 is a registration confirmation screen of the invention.

FIG. 3 is an account creation confirmation screen of the invention.

FIG. 4 is a user log-in screen of the invention.

FIG. 5A is a password recover screen of the invention.

FIG. 5B is a password reset screen of the invention.

FIG. 6 is a model used in the questionnaire of the invention.

FIG. 7 is a diagram of the invention used to describe core market sectors and zones.

FIG. 8 is a diagram of the invention used to describe the role of the individual in the enterprise.

FIG. 9 is an inventory of technology and communication software sheet of the invention.

FIG. 10 is a work flow process map of the invention. Letters A to H identify portions expanded on subsequent FIGS. 10a to 10h for greater clarity.

FIG. 10a illustrates work flow inputs for portion A.

FIG. 10b illustrates work flow inputs for portion B.

FIG. 10c illustrates work flow inputs for portion C.

FIG. 10d illustrates work flow inputs for portion D.

FIG. 10e illustrates work flow inputs for portion E.

FIG. 10f illustrates work flow inputs for portion F.

FIG. 10g illustrates work flow inputs for portion G.

FIG. 10h illustrates workflow inputs for portion H.

FIG. 11 is a visualization tool used in the invention.

FIG. 12 is set-up wizard of the invention to configure a project space.

FIG. 13 (canceled)

FIG. 14 is the set up wizard to define business processes.

FIG. 15 is the set-up wizard to import contacts.

FIG. 16 is the set-up wizard to import contact files.

FIG. 17 is a spreadsheet of contacts generated by the invention.

FIG. 18 a screen for downloading a landing page template of the invention.

FIG. 19 is a page for configuring the landing page by HTML.

FIG. 20 is the finish page for the set-up wizard of the invention.

FIG. 21 is a customized dashboard of one embodiment of the invention.

FIG. 22 is a help and support page of the invention.

FIG. 23 is a user message screen of one embodiment of the invention.

FIG. 24 is a preferences screen for customizing a contact card of the invention.

FIG. 25 illustrates activity gadgets of the invention.

FIG. 26 is a screen to edit attendees for a task.

FIG. 27 is a calendar feature of the dashboard.

FIG. 28 is a screen to upload files to a task.

FIG. 29A illustrates a files gadget of the invention.

FIG. 29B illustrates a screen for adding files.

FIG. 30A to FIG. 30D illustrate report preparation of the invention.

FIG. 30E illustrates a report prepared as a bar graph in the invention.

FIG. 31 illustrates dashboard functionality for charting contacts.

FIG. 32 illustrates favourite contact operations of the invention.

FIG. 33 illustrates a favourite contact profile.

FIG. 34 illustrates contact groups.

FIG. 35 illustrates the contact duplication resolution feature of the invention.

FIG. 36 illustrates the contact merging facility of the invention.

FIG. 37A shows contact editing features of the invention.

FIG. 37B shows the contact tagging features of the invention.

FIG. 38 shows the bulk notes feature of the invention.

FIG. 39 shows the new groups addition feature of the invention.

FIG. 40 shows a record bulk note screen of the invention.

FIG. 41A shows the importing contacts gadget of the invention.

FIG. 41B shows contacts imported from OUTLOOK®.

FIG. 41C shows the contacts imported confirmation screen of the invention.

FIGS. 42A to 42D show contact operations of the invention.

FIG. 43A to 43C show contacts being searched using filters.

FIGS. 44A to 44C show associating a contact with a project.

FIG. 45 shows task creation for contacts.

FIG. 46 also shows task creation for contacts.

FIG. 47 is a user log-in screen of the invention.

FIG. 48 shows a new task addition screen.

FIG. 49 shows a new file addition screen.

FIG. 50 illustrate the campaign creator gadget of the invention.

FIG. 51 illustrates template creation of the invention.

FIG. 52 illustrates a variety of templates available to a user of the invention.

FIG. 53 (canceled)

FIG. 54 shows the template editing window of the invention.

FIG. 55A to FIG. 55D show linking features of the invention.

FIG. 56A and FIG. 56B show further linking features of the invention.

FIG. 57 shows a preview e-mail template of the invention.

FIG. 58 shows the e-mail reporting function.

FIGS. 59A to 59C shows the e-mail confirmation function.

FIGS. 60A to 60C show contact editing features.

FIGS. 61A to 61C show bulk operations.

FIG. 62 illustrates the e-mails opened.

FIG. 63 illustrates the list of e-mails sent.

FIG. 64 illustrates the number of e-mails clicked.

FIG. 65 illustrates the number of e-mails unopened.

FIG. 66 illustrates the number of e-mails opened.

FIG. 67 shows an Automatic Drive Editor of the invention.

FIG. 68 shows the social spaces screen.

FIG. 69 shows the adding social spaces screen.

FIG. 70 shows components of the social spaces.

FIG. 71 shows editing the icon portion of the screen.

FIG. 72 shows uploading the icon to a thumb view.

FIG. 73 shows RSS™ feed settings.

FIG. 74 shows enabling RSS™ feed settings.

FIG. 75 shows LINKEDIN™ settings.

FIG. 76 shows enabling LINKED-IN™ settings.

FIG. 77 shows expanding the LINKEDIN™ network.

FIG. 78 shows FACEBOOK™ settings.

FIG. 79 shows FACEBOOK™ enabling.

FIG. 80 shows FLICKR™ settings.

FIG. 81 shows adding or deleting FLICKR™ accounts.

FIG. 82 shows adding the idGettr™ link.

FIG. 83 shows adding Twitter™ accounts.

FIG. 84 shows adding gadgets to social spaces.

FIG. 85 also shows adding gadgets to social spaces.

FIG. 86 shows previewing a social space.

FIG. 87 shows deleting a social space.

FIG. 87A shows selecting settings under the Administration Tab.

FIG. 88 shows editing contact ranks.

FIG. 89 further shows editing of contact ranks.

FIG. 90 shows deleting contact ranks.

FIG. 91 shows functionality of the roles gadget.

FIG. 92 shows roles selection functionality.

FIG. 93 shows the adding roles function.

FIG. 94 shows a project spaces screen.

FIG. 95 shows adding project spaces functionality.

FIGS. 96 and 97 show editing project spaces.

FIG. 98 shows adding distribution groups.

FIG. 99 shows bulk user options.

FIG. 100 shows editing profiles.

FIG. 101 shows adding new users to the system.

FIGS. 102A to 102D show additional user functionality.

FIG. 103 illustrates the screen for creating and maintaining process types.

FIG. 104 shows adding new process types.

FIG. 105 shows editing process types.

FIG. 106 shows cloning of process types.

FIG. 107 shows editing of cloned process types.

FIG. 108 shows a feedback screen of the invention.

FIG. 109 shows a dashboard configuration of one example of the invention.

FIG. 110 shows recertification of prescription medications.

FIG. 111 shows that the physician can add SOAP notes.

FIG. 112 shows that the physician can use the calendar to add patient appointments.

FIG. 113 shows that new patients can be added.

FIG. 114 shows that the patient database can be searched by a variety of fields.

FIGS. 115 to 118 show further management attributes of this example of the invention.

FIG. 119 (canceled)

### BEST MODE

### Mode for Invention

The invention creates a connected market space system that will incorporate features such as managing contacts, sales processes and organizational gadgets, and incorporate them into a toolkit. The invention will keep the user and the enterprise organized and keeps marketing conversations going. The invention integrates Facebook™, Twitter™, RSS™ Feeds, Blogs™ and LinkedIn™ presence all in one place allowing the user to take advantage of the powerful marketing capabilities of social media. It also allows the user to replicate the functionality of SharePoint™, Dropbox™ and Google™ documents in one system.

The invention permits the user to work smarter and replaces such legacy programs as Evernote™, Outlook™ and Basecamp™ with one easy-to-use system. As a connected market space the system has the same powerful features as SalesForce™, Microsoft Dynamics™ and Highrise™.

Setting up An Account

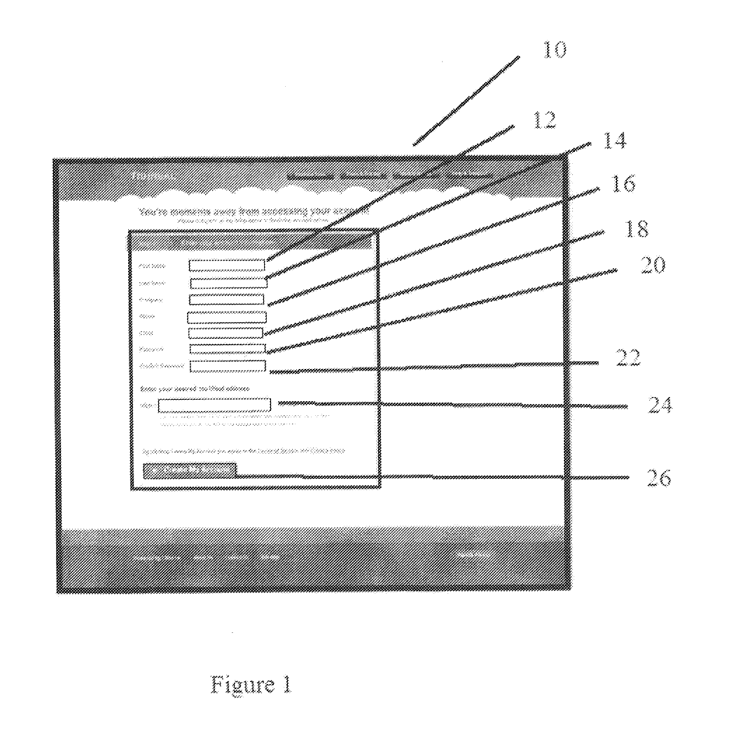

Since the invention is provided on a subscription-fee basis, there is requirement for the user to establish an account in order to access the system. The system provides for the user enrolment as shown in FIG. 1 screen 10. The enrolment process requires the user to provide such information as: first name 12, last name 14, enterprise name 16, contact phone number 18, contact e-mail address 20, and the insertion of a password 22. The user then can select a desired “.com” address for the user homepage 24. The user then clicks the ‘create my account’ button 26 in order to create a user account.

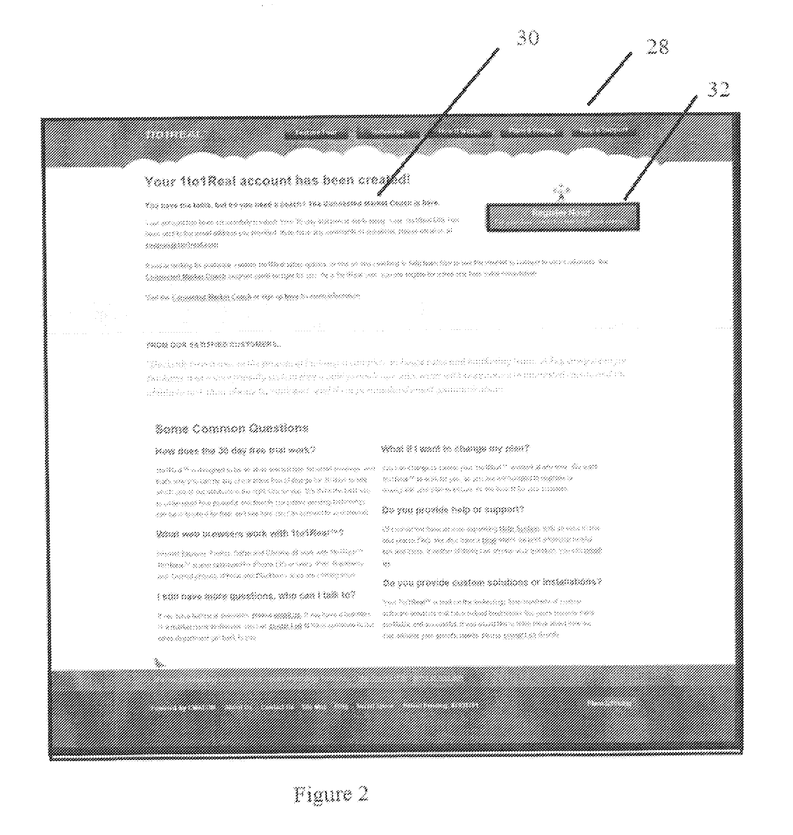

Referring to FIG. 2, registration is confirmed by a success screen 28. This system provides for a 30 day trial 30. The user can alternatively register with the system at this point by clicking button 32 and will be taken to a payment screen since the system is operated on a subscription-fee basis.

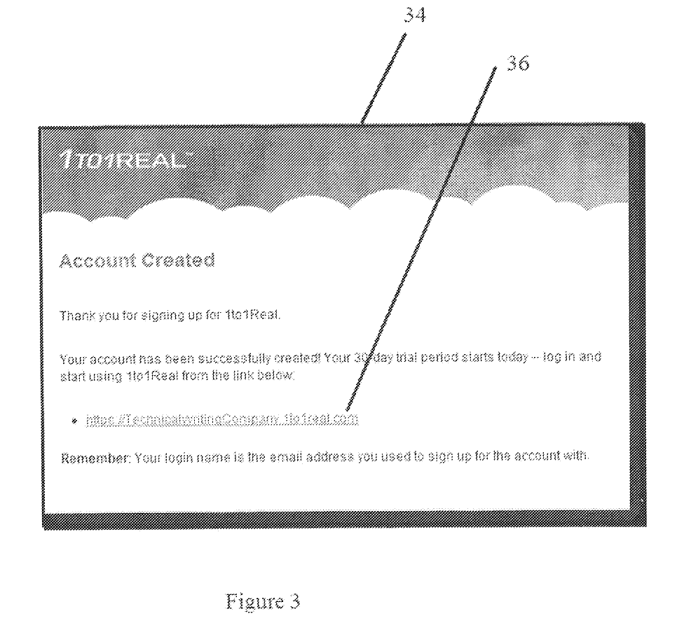

Referring to FIG. 3 the system will send an e-mail 34 to the user indicating that the account has been created and request that the user log into the system by clicking onto a link 36.

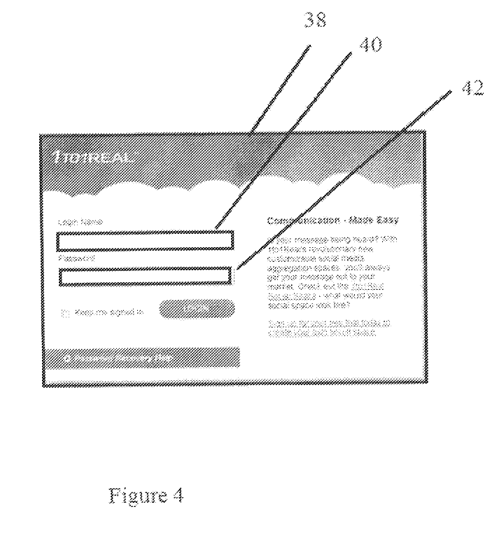

Referring to FIG. 4 the user is presented with a log in screen 38 and by entering the user log in name 40 and user password 42 the user is taken into the system.

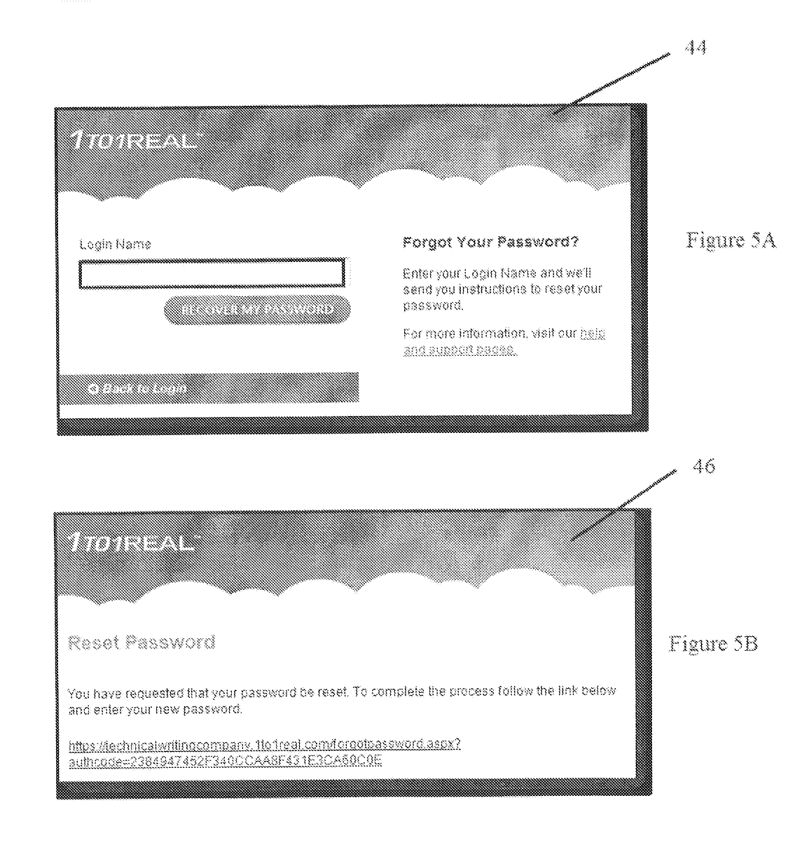

Referring to FIGS. 5A and 5B the system provides the user with a password recovery screen 44 and a password reset mechanism 46.

The Set-up Process

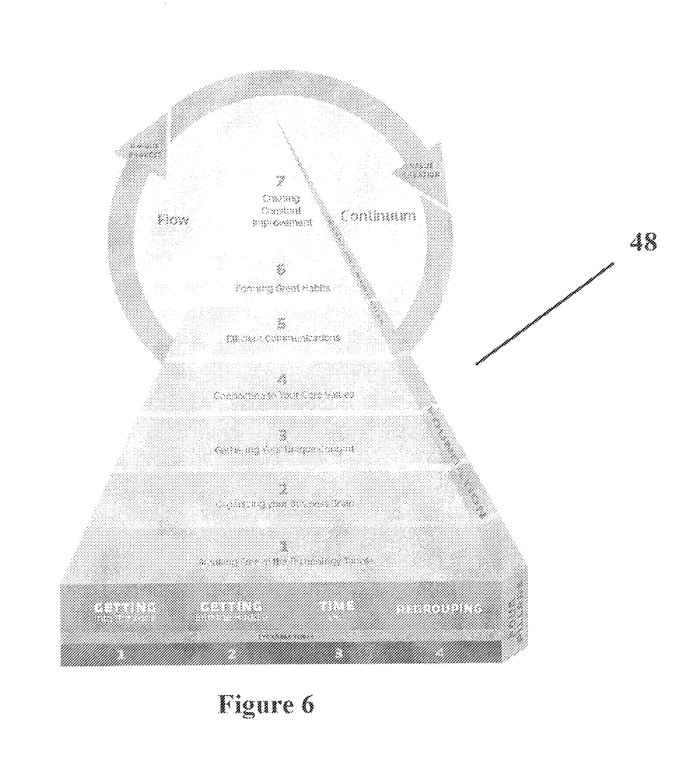

Since the successful operation of the present invention is dependent upon the enterprise user having an awareness of current enterprise connectivity, goals, structure, clients, suppliers and software tools the user is presented with a diagnostic tool to assist her in mapping the current enterprise process. In one embodiment of the invention the user is presented with a diagnostic tool in a software-based format. The diagnostic tool is based on a questionnaire. The questionnaire relies on a model 48 illustrated in FIG. 6. The following diagrams illustrate some examples of the information that the user should have prior to configuring the enterprise project spaces in the next step described below.

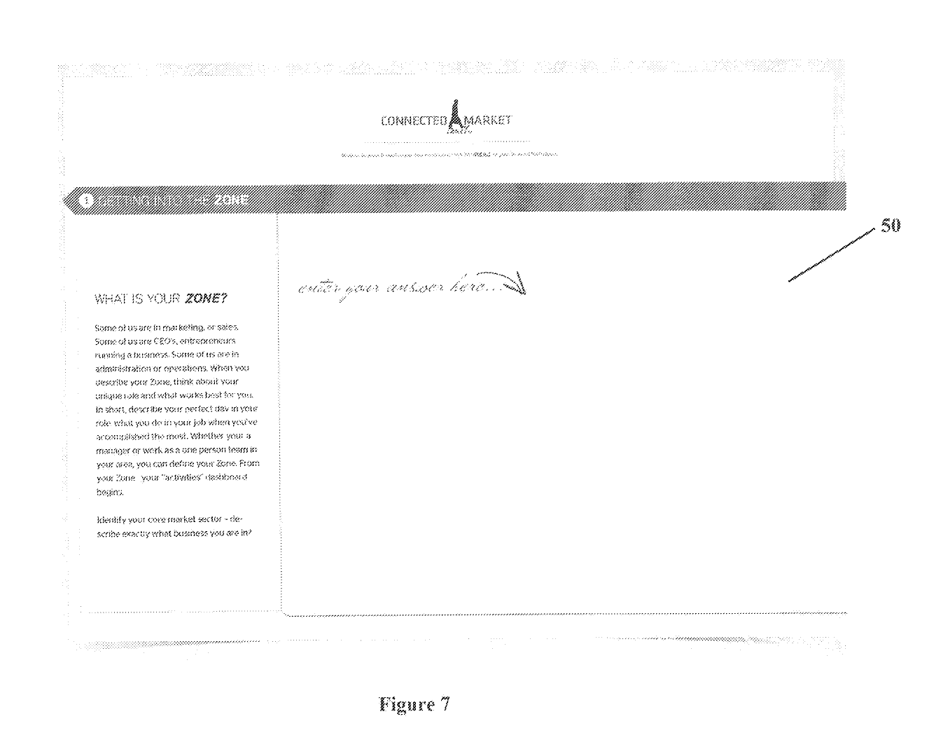

Identification of core market sector or zone as shown in FIG. 7 Item 50.

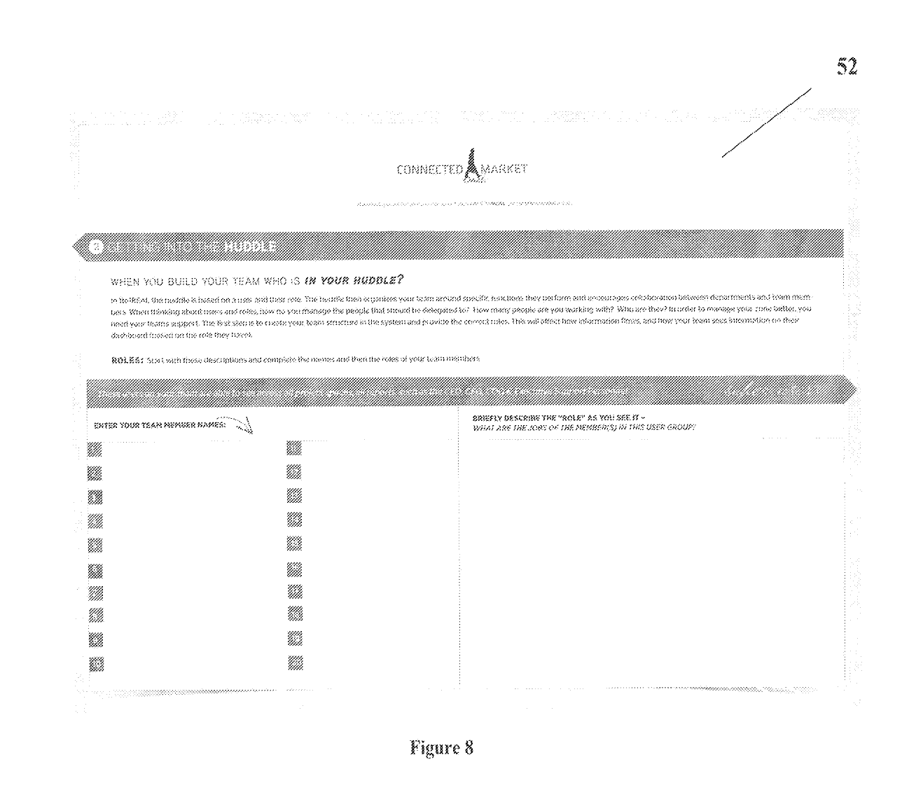

The role of the user as an individual within the enterprise as shown in FIG. 8 Item 52.

The role of the enterprise also addressed in FIG. 8, Item 52, including, the goods and services produced by the enterprise, the personnel structure or ‘organization chart’ of the enterprise and reporting and feedback processes.

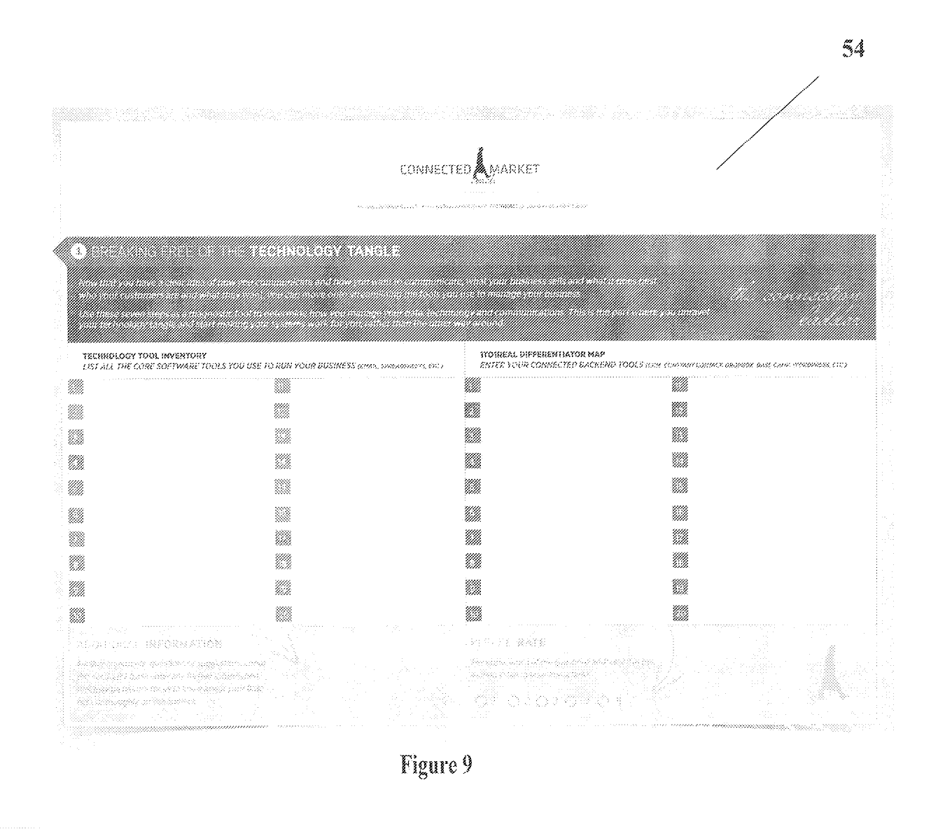

An inventory of technology and communication software used by the enterprise is listed in FIG. 9 Item 54, including, identification of all client, supplier and enterprise record databases, an inventory of social networking practices and the identification of social media used by the enterprise, review of the communications and internal interconnectivity between various groups within the enterprise and external connectivity with clients and suppliers and identifying the ‘best practices’ as process flows used by the enterprise.

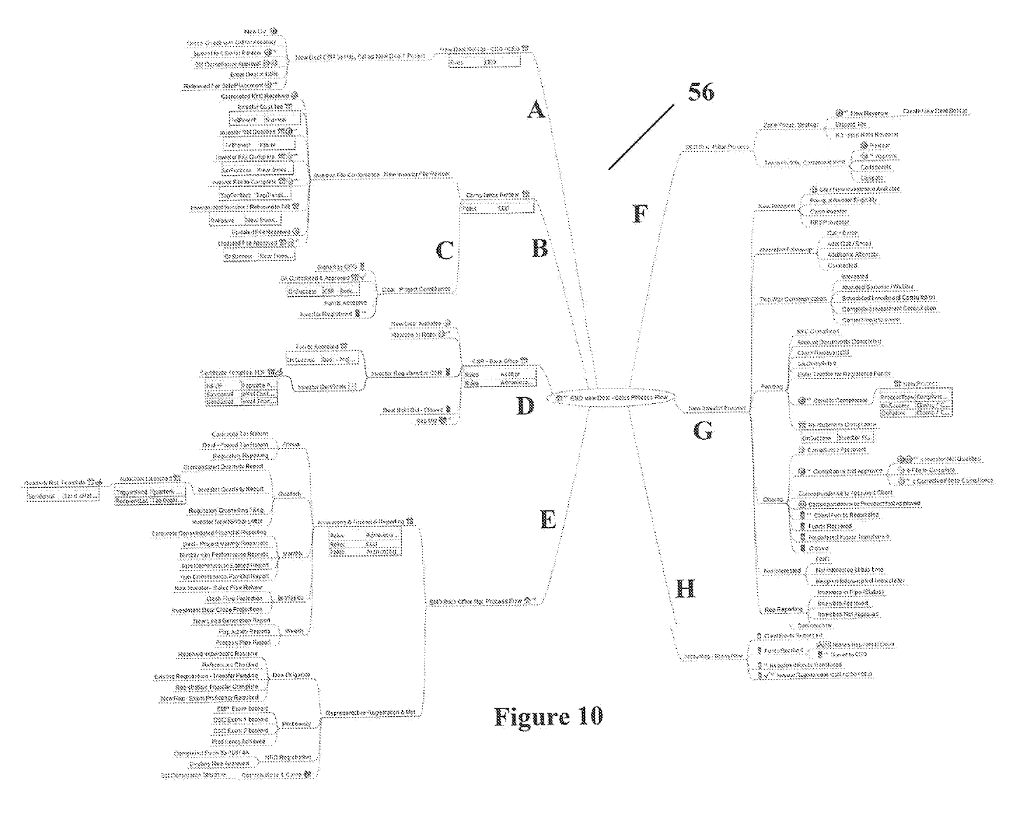

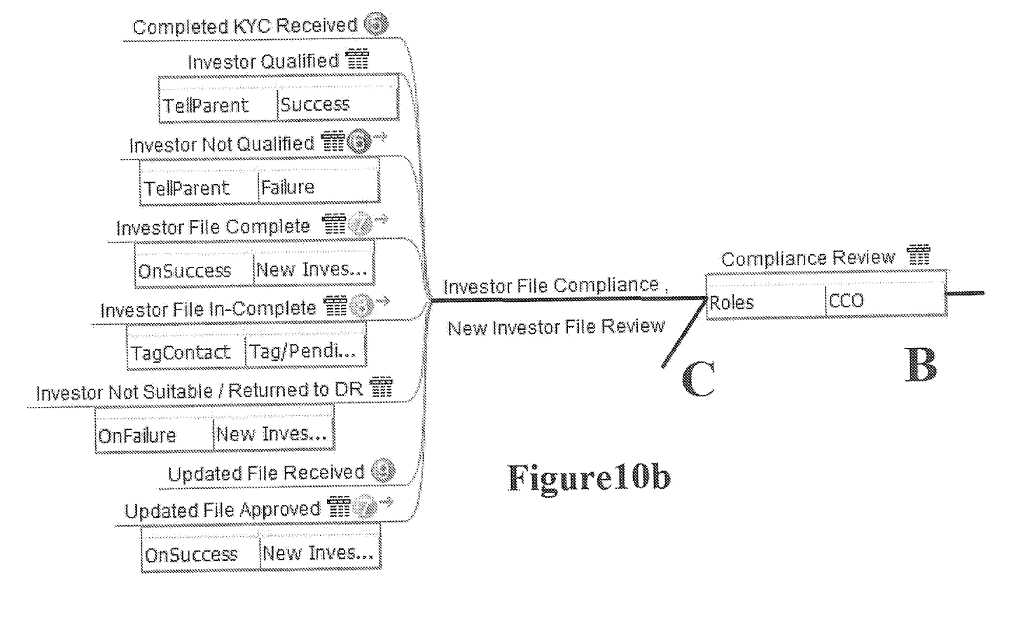

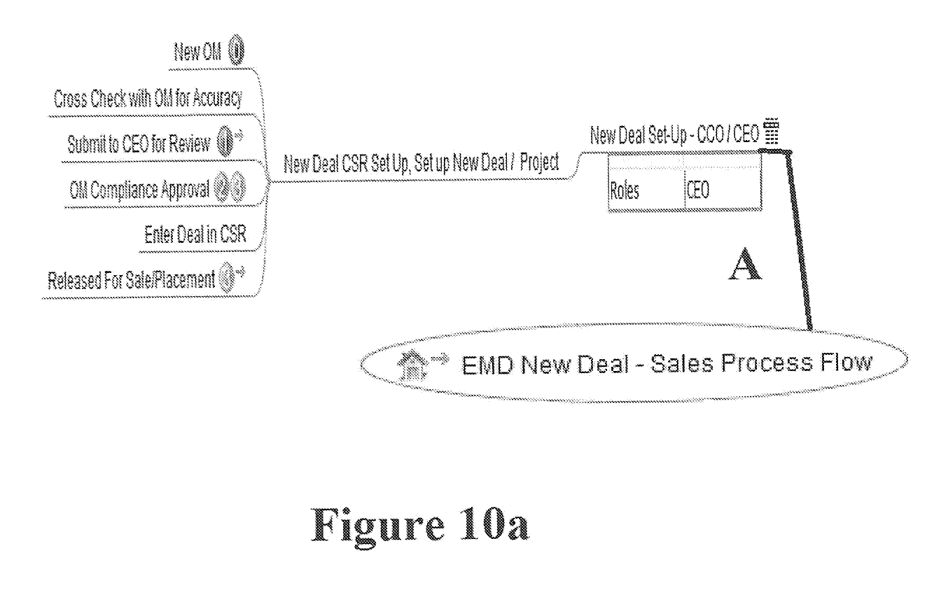

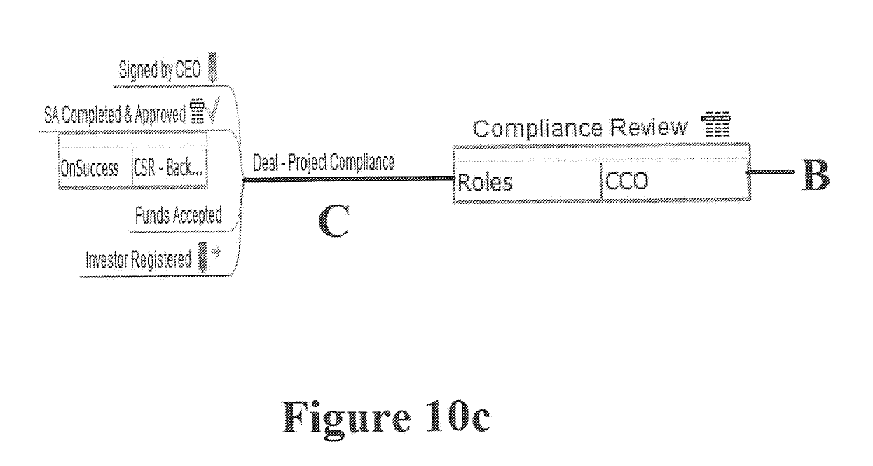

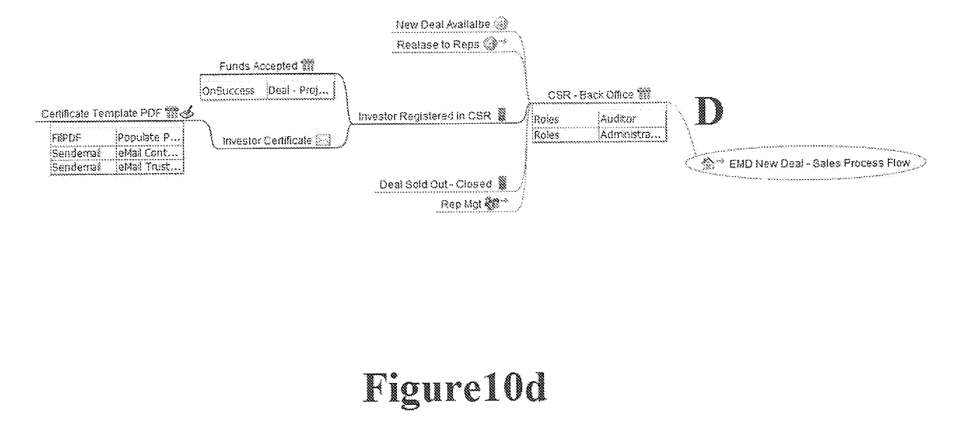

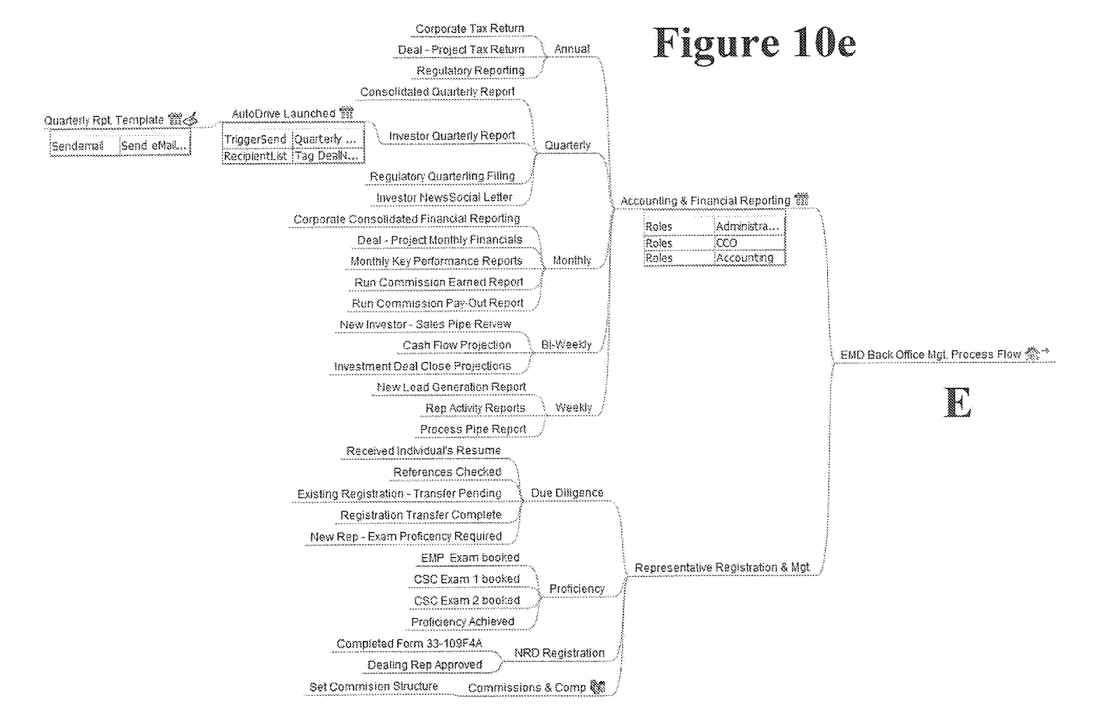

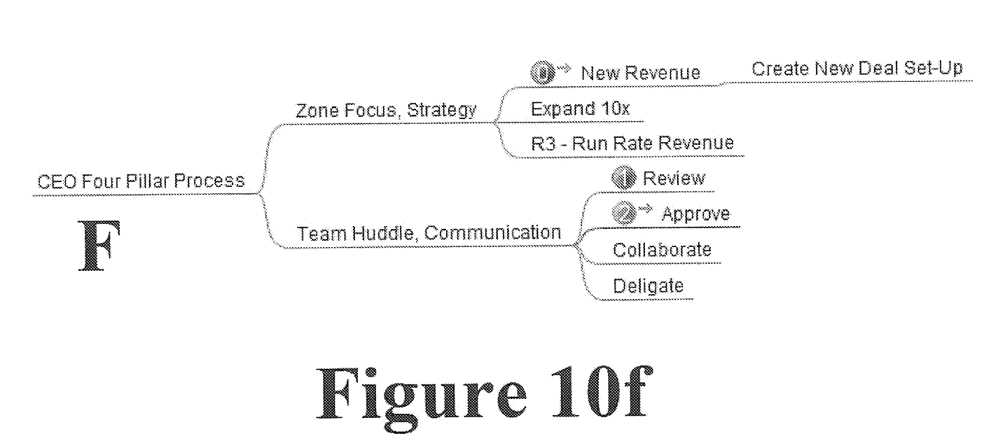

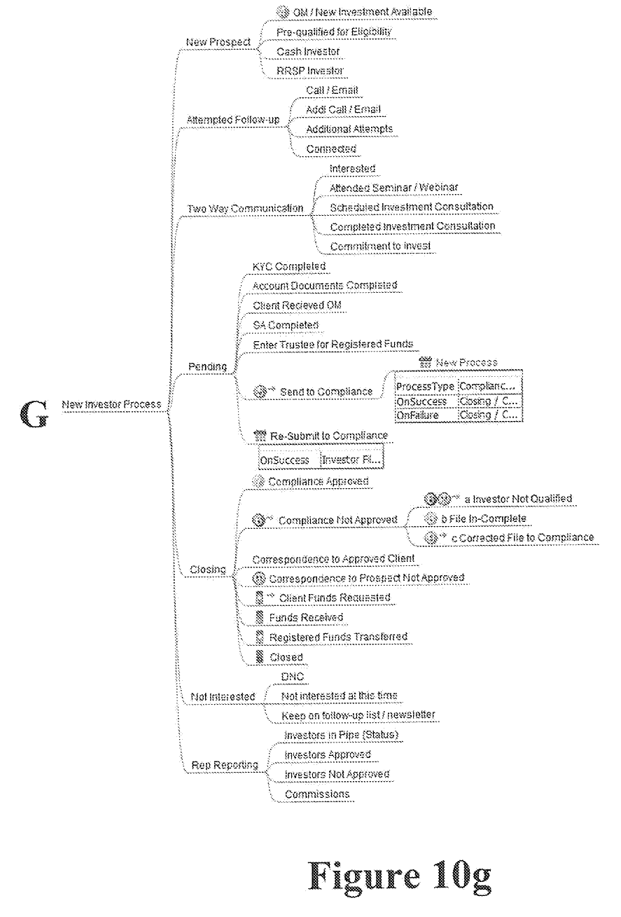

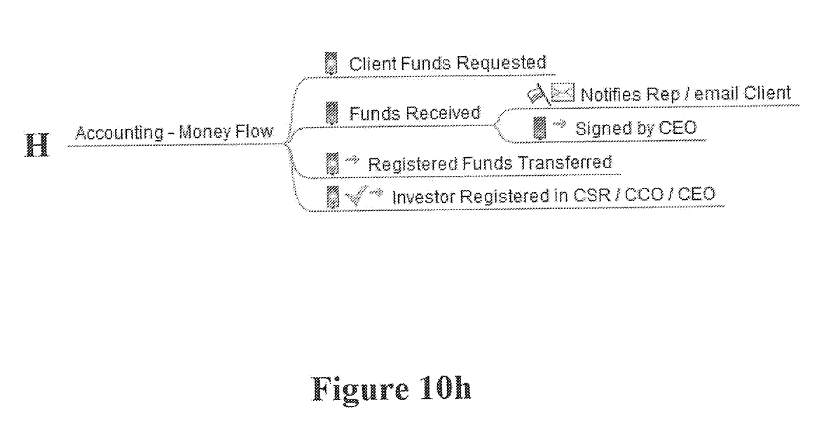

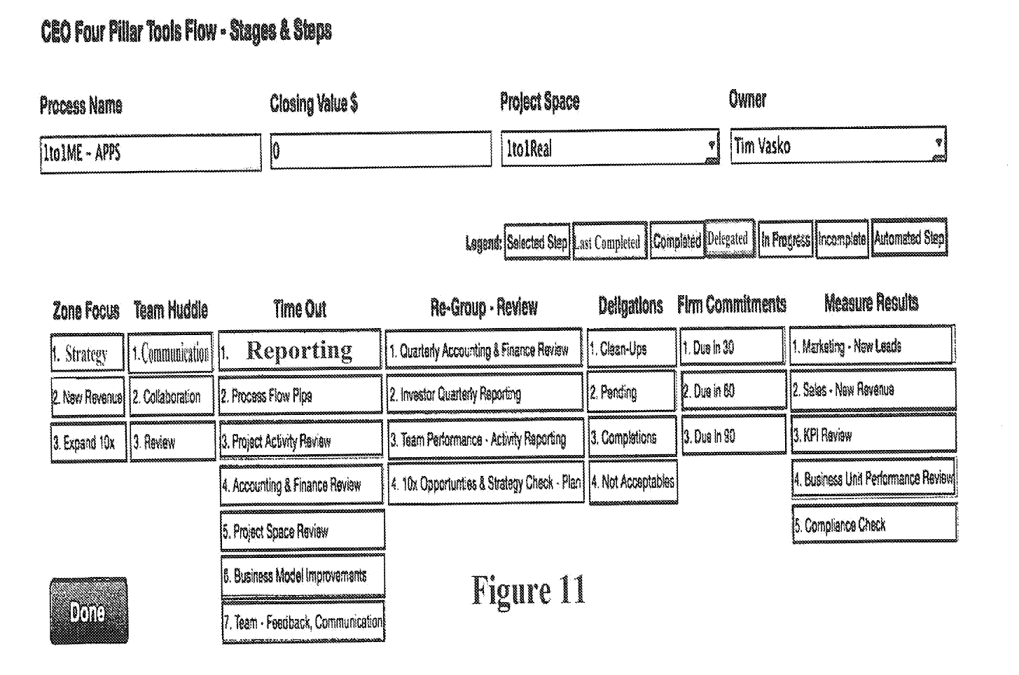

The best practices process flows can be derived in a variety of ways. The most useful ways for a user to identify work flow processes within an enterprise is by using a visualization tool such as MIND MAP® as illustrated in FIG. 10 Item 56 or MIND JET® or in the format derived from an Excel® spread sheet as shown in FIG. 11 Item 58. Since FIG. 10 is difficult to see as is, portions of FIG. 10 corresponding with portions of the work flow process have been expanded in FIGS. 10a to 10h.

The diagnostic tool further requires the user to identify goals and achievements that the enterprise wants to meet such as capturing new sales prospects, creating a customer survey or delivering information reports that would be personalized for each customer. The workflow analysis address every aspect of enterprise operation from the most trivial to the most sophisticated.

Workflow Process Environment Creation

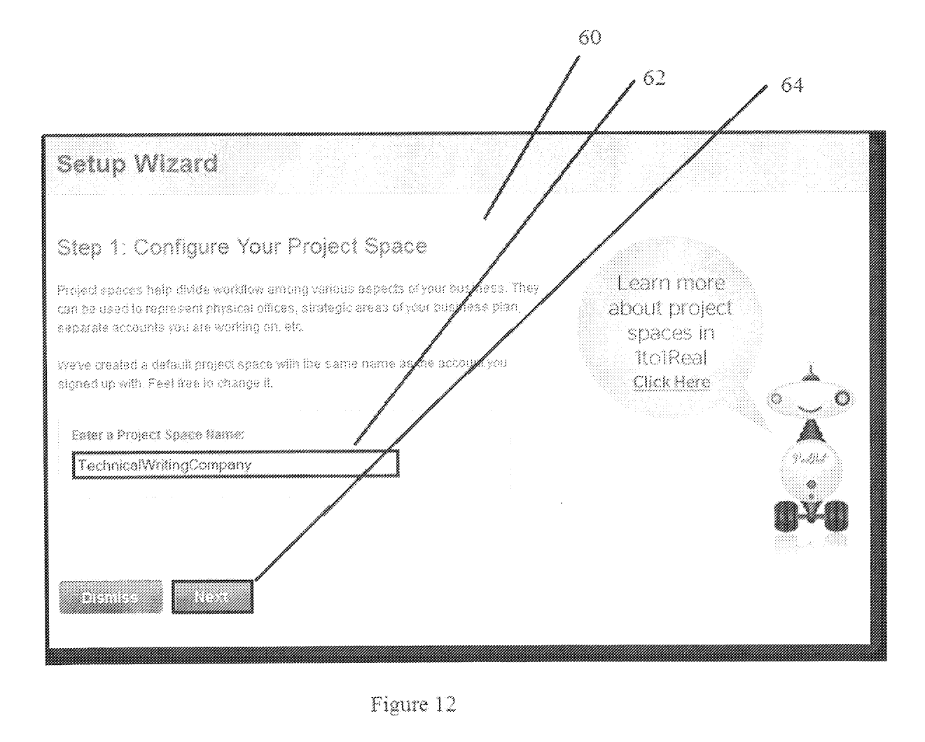

Once all the available information is obtained by the user from the initial diagnostic process, she will be guided through a setup process by a data input wizard. The setup process is illustrated commencing on FIG. 12. The setup wizard creates a user interface by preparing and presenting the user with a sequence of dialog boxes that leads the user through a series of well-defined steps to create a customized user interface or dashboard. The setup wizard comprises a number of steps as described and illustrated below;

Step 1. Configure a project space. Referring to FIG. 12 Item 60 there is shown a screen to guide the user through the first step of the setup process. The wizard will instruct the user to enter the name of a project space in field 62. The user has previously identified a number of project spaces which divides the enterprise workflow among the various aspects of the enterprise. For example they can be used to represent physical offices, strategic areas of the enterprise business plan or separate client accounts that the enterprise works with. In the example shown in FIG. 12 the user has entered the name of the enterprise as a project space, namely, “Technical Writing Company” in data field 62. When this is completed the user moves onto the next step 64.

Step 2. Add users. The setup wizard will then instruct the user to enter the e-mail addresses in an appropriate data field of all the enterprise individuals that will have access to the user account. These would be members of the enterprise or members of a specific team tasked with specific activity. The user in the initial exercise of identifying the structure of the enterprise has identified the roles of each of these individuals and the setup wizard requests that the users identify the role from a pull-down menu for each of the individuals entered in the appropriate data field. By clicking on a “+” symbol the user can the person to the list of users having access to the account and by clicking on a “[−]” symbol the user can delete the entry. The user also has a facility to add roles that are not available from the default menu. Once this step is completed the user can press a button and proceed to the next step.

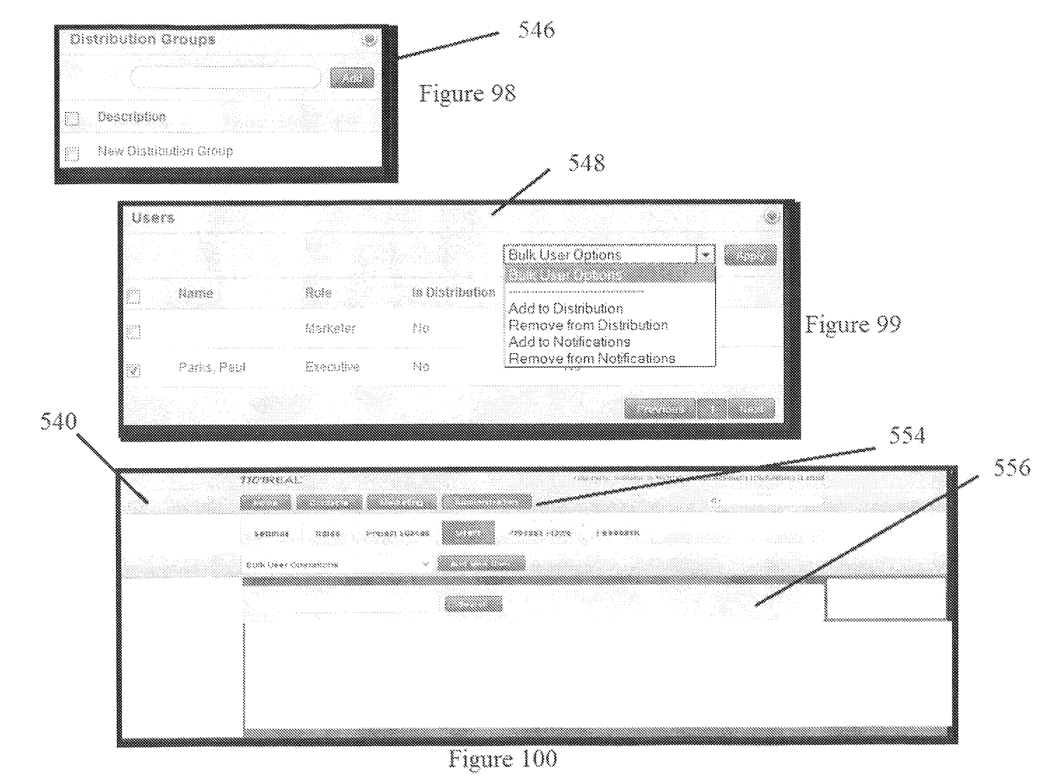

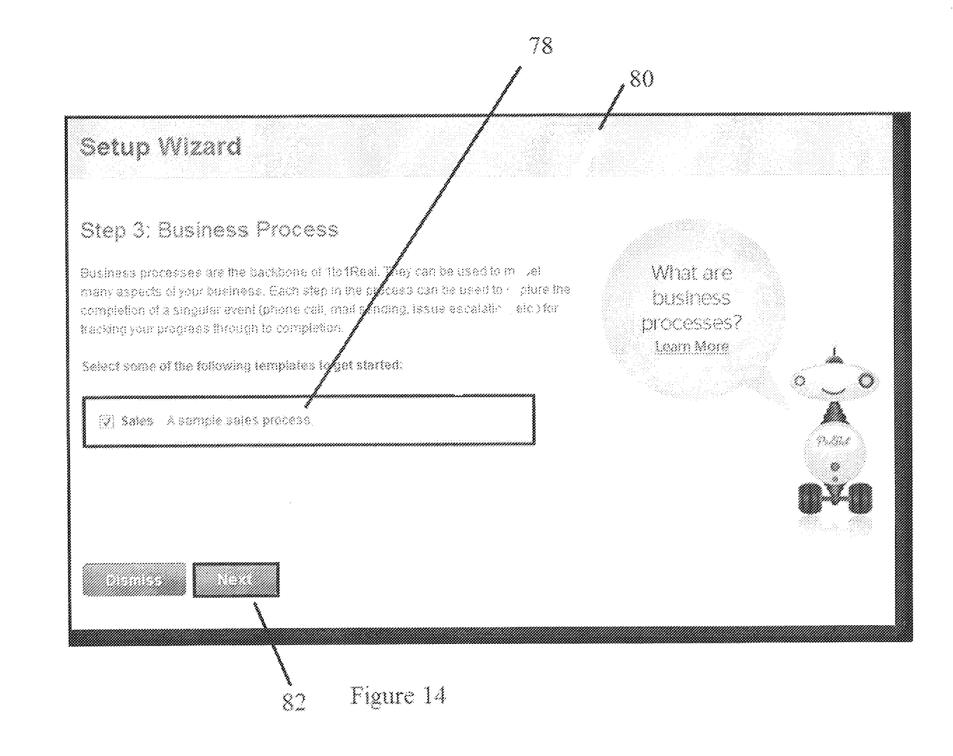

Step 3. Business Processes. Referring now to FIG. 14, the setup wizard will then instruct the user to identify the various business processes of the enterprise and enter those into data field 78. Data field 78 provides an example template for use by the user ‘a sample sales process’ however screen 80 can also provide a full menu of processes that the user has identified in the previous diagnostic exercise. Once this step is completed the user can proceed to the next step by clicking button 82.

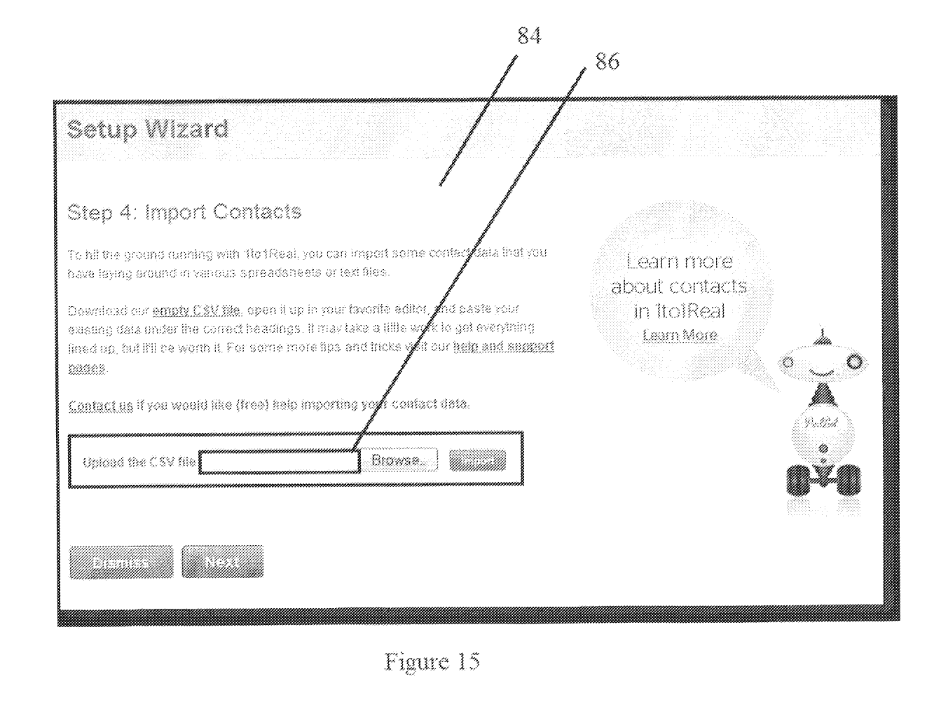

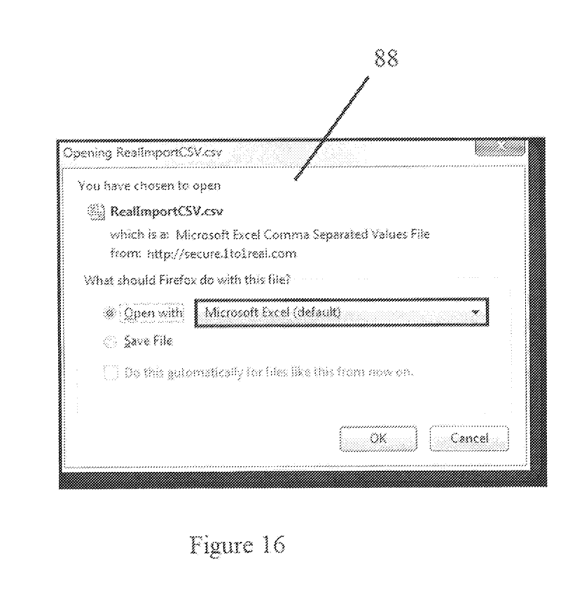

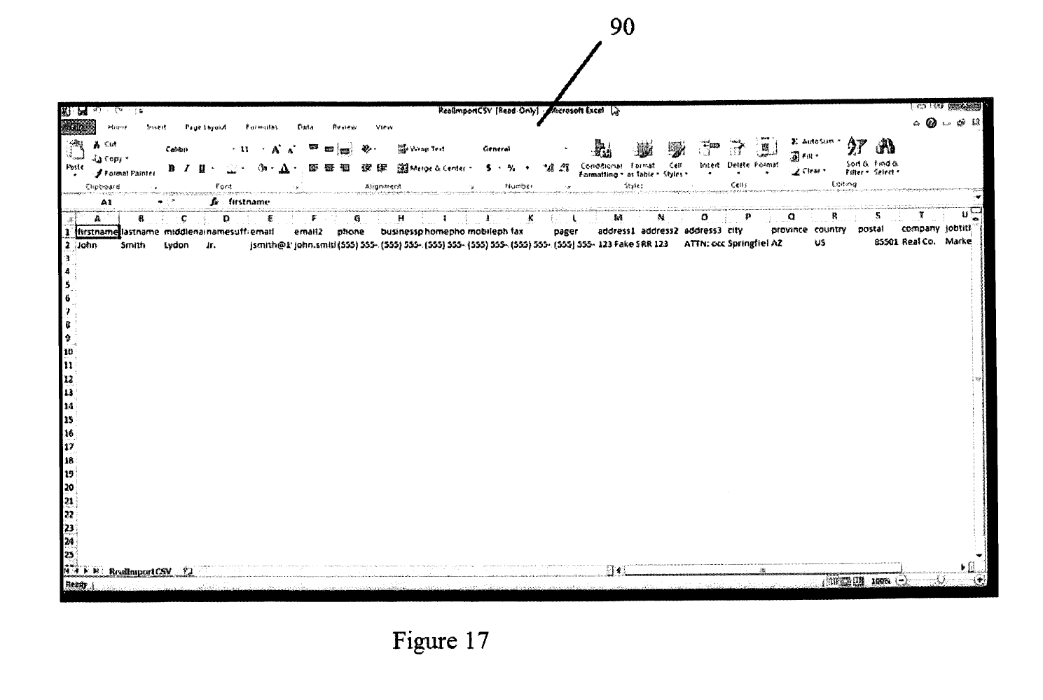

Step 4. Import Contacts. Referring to FIG. 15, Screen 84, the wizard will instruct the user to input all contacts into the system using data entry field 86. These contacts have been previously identified in the diagnostic exercise. The contacts will be consolidated by the system so all contact lists will be entered into the system. The system uses a ‘csv’ import gadget. Referring to FIG. 16 Item 88 the system will request that the user open the csv file to generate the Excel spreadsheet illustrated in FIG. 17, Item 90.

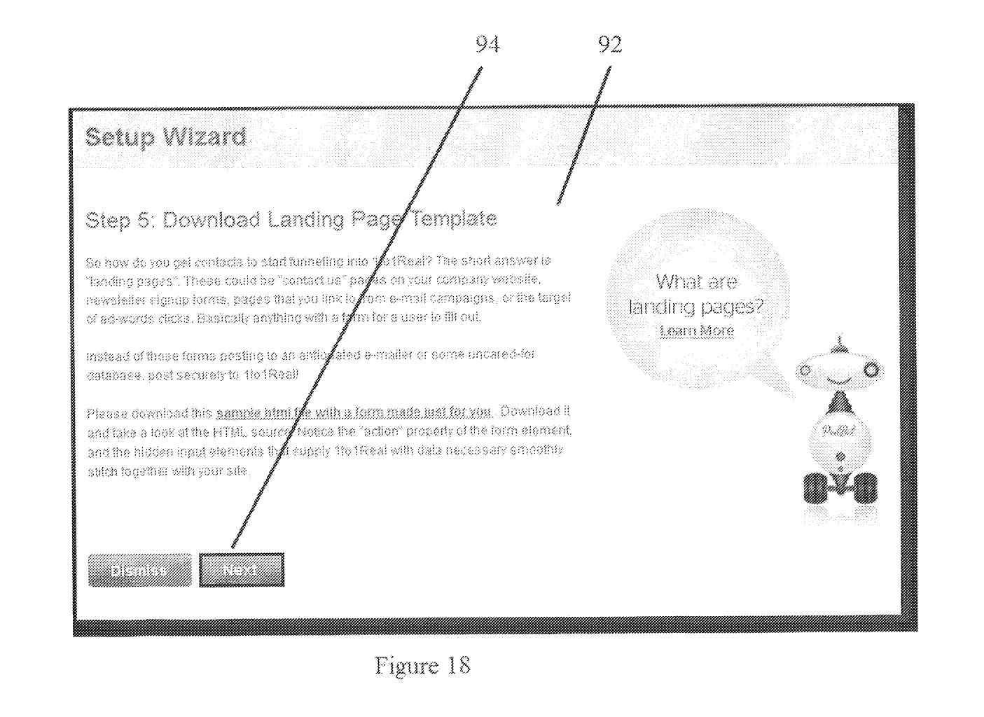

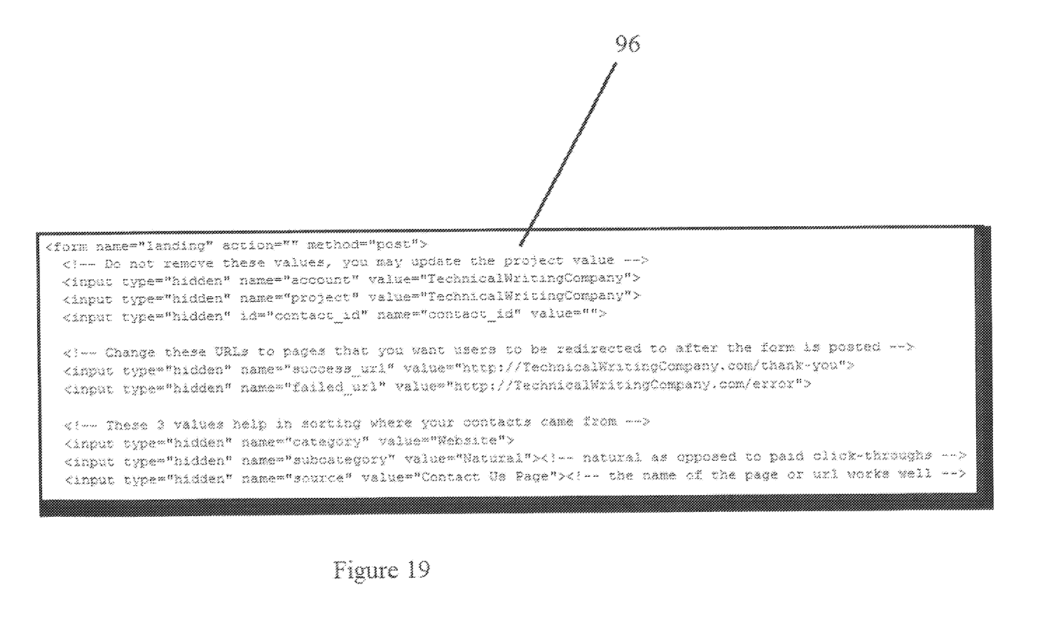

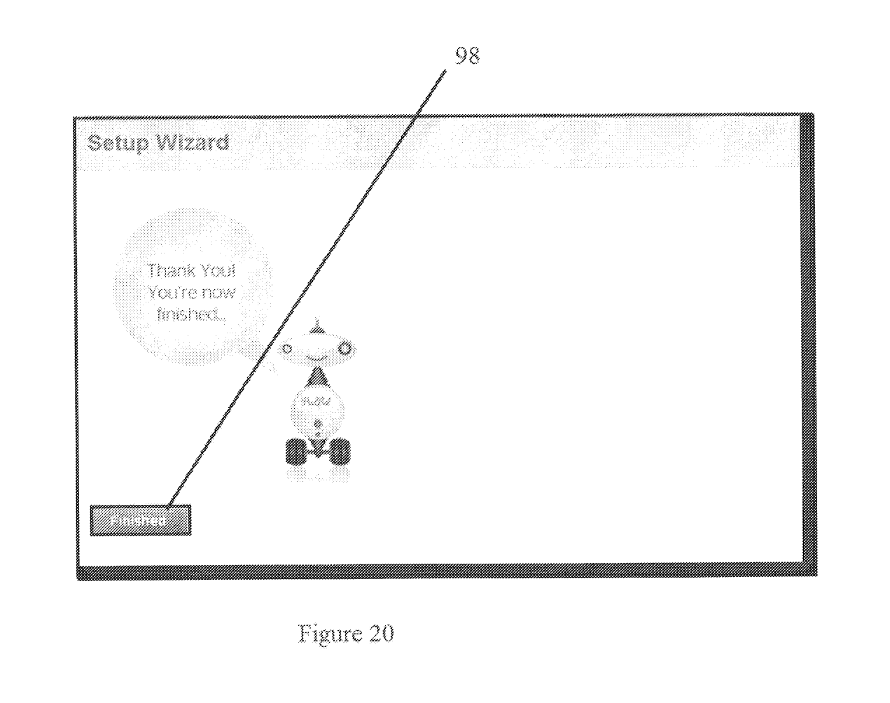

Step 5. Download Landing Page Template. Referring to FIG. 18 and screen 92 the next step in the setup process is to have the user download a landing page template. The landing page is used by all contacts to enter information into the system. For example, a landing page could be a ‘contact us’ page on the company website which would request a user to input a response or request which would be directed into the system and subsequently displayed to the user. Referring to FIG. 19 the user can configure the landing page by using the HTML source code set out at Item 96. By pressing button 94 the user is taken to the final screen in the setup process illustrated in FIG. 20 and completes the process by pressing the ‘finishing button’ at Item 98.

Using a Customized Dashboard

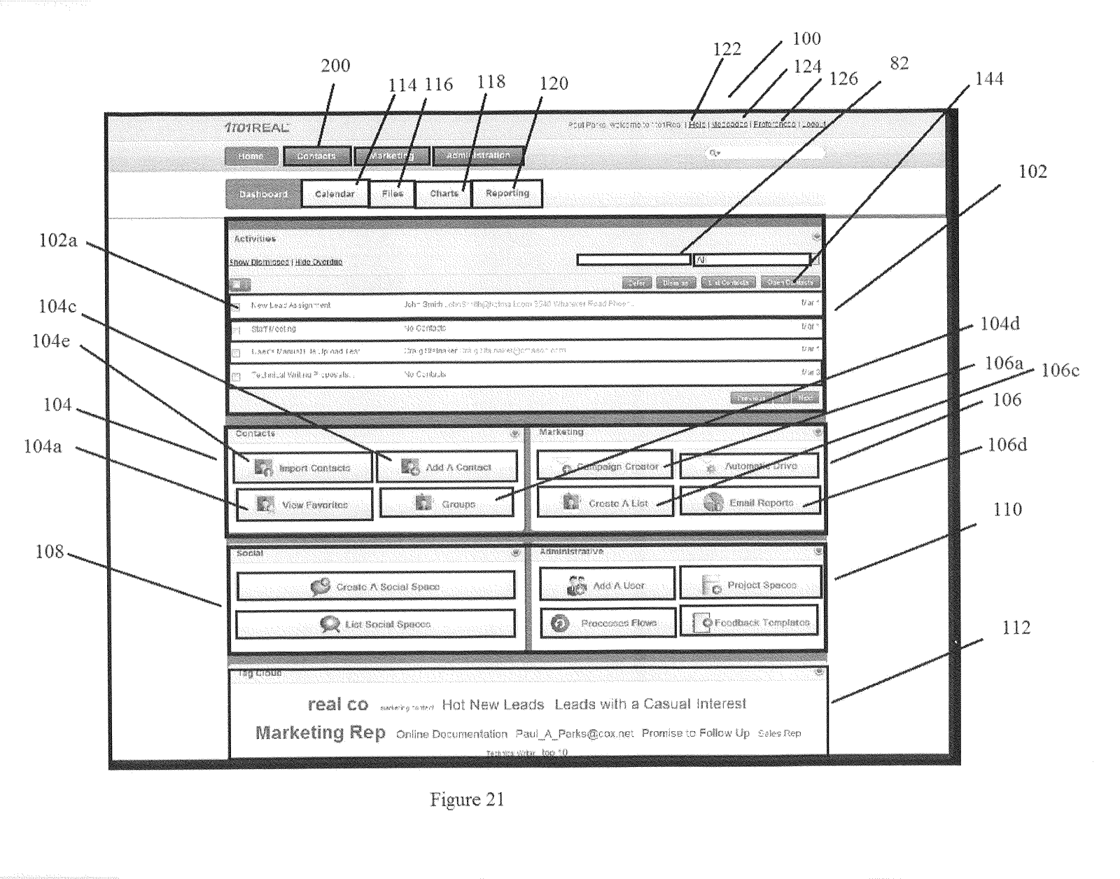

Once the wizard has completed the setup process the system will generate a customized dashboard for the user. One embodiment of the dashboard is shown in FIG. 21 at screen 100. The dashboard can take other configurations as desired by the enterprise user but will generally contain sufficient data fields to capture all of the operation aspects of enterprise activities, marketing and social connectivity regardless of the size of the enterprise.

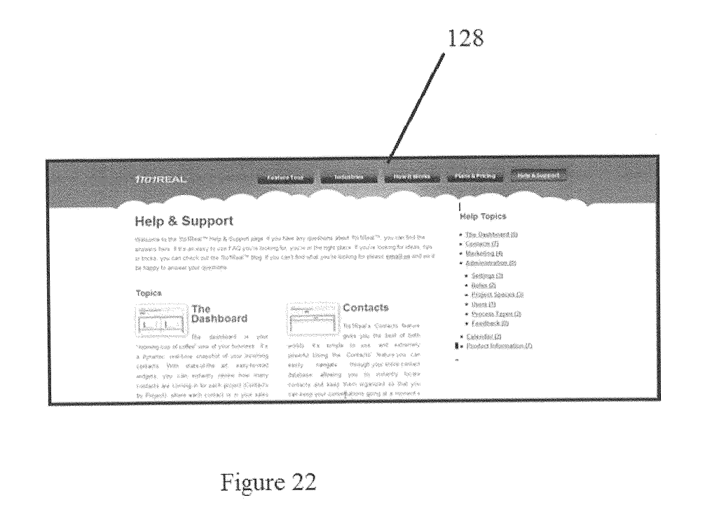

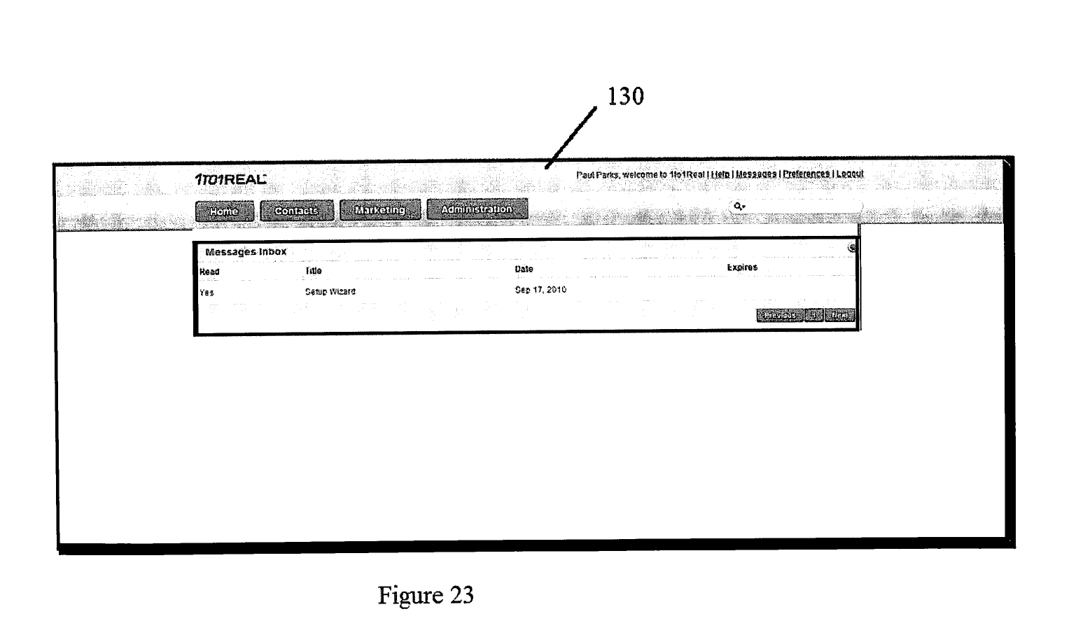

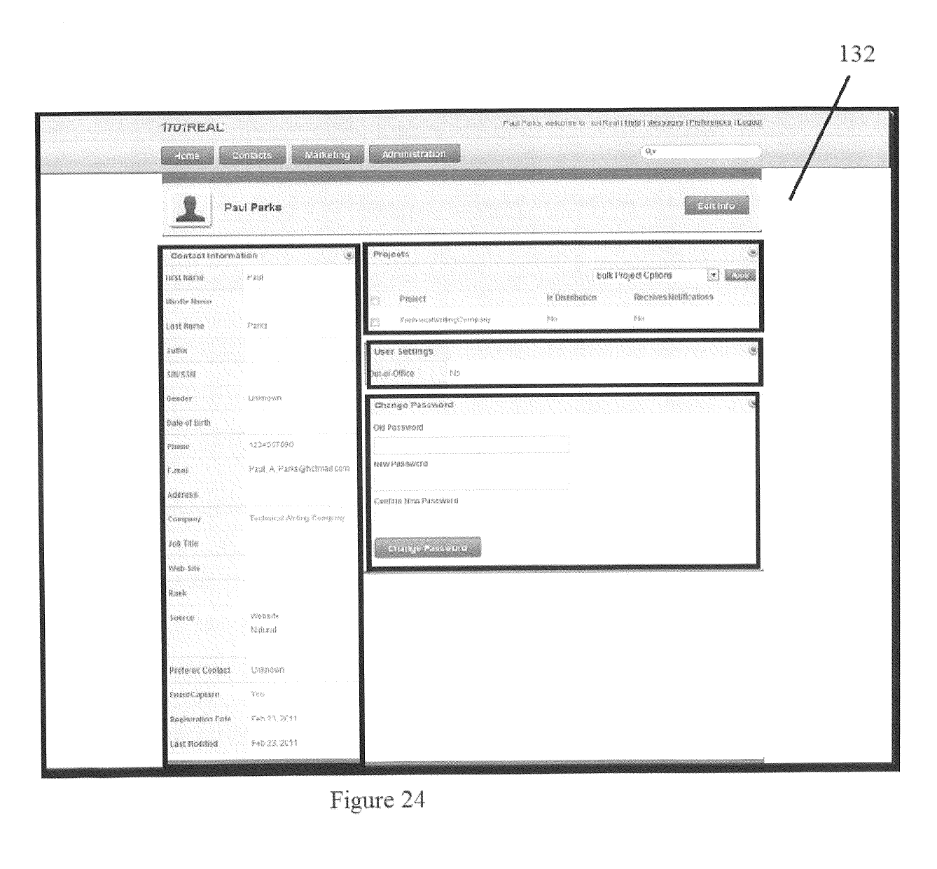

The dashboard is suitable for an individual, a family or a large corporation. In the embodiment illustrated the dashboard comprises at least six activity areas or sub-tabs. In the embodiment illustrated in FIG. 21 those areas are: activities 102, contacts 104, marketing 106 which can also be labelled communications management, social networking 108, administrative 110 and a tag cloud area 112. Other area labels can be used. The dashboard screen provides for a user calendar 114, a facility to upload files relative to any particular activity 116, the ability to generate activity charts 118 and a reporting feature 120. The template illustrated in FIG. 21 also has a help facility at link 122, the ability to permit the user to access e-mail messages at link 124 and a preferences page so that the user can customize her contact chart at link 126. Referring to FIG. 22 the user when requesting help at link 122 is taken to a help and support page Screen 128. FIG. 23 illustrates the user message Screen 130 from link 124. It is an advantage of the invention that the user does not have to exit the system and go into another e-mail program to access e-mail messages. E-mail messages can be directly imported into the system. FIG. 24 illustrates the preferences from link 1 to 6 so that the user can customize its contact card as shown on Screen 132.

Activities

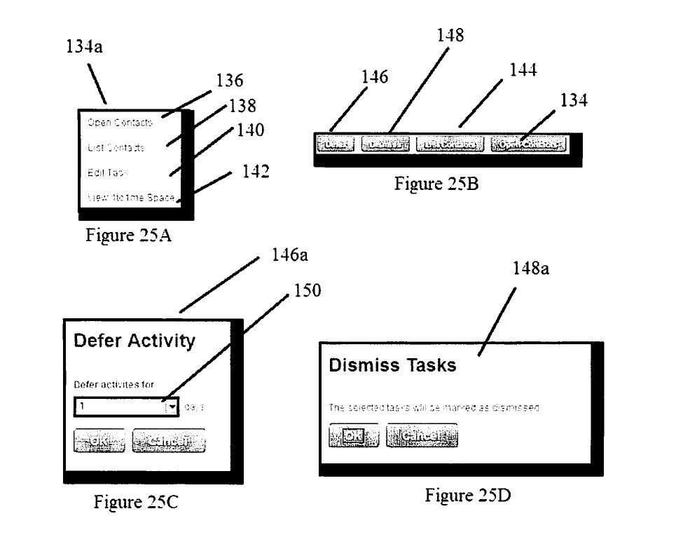

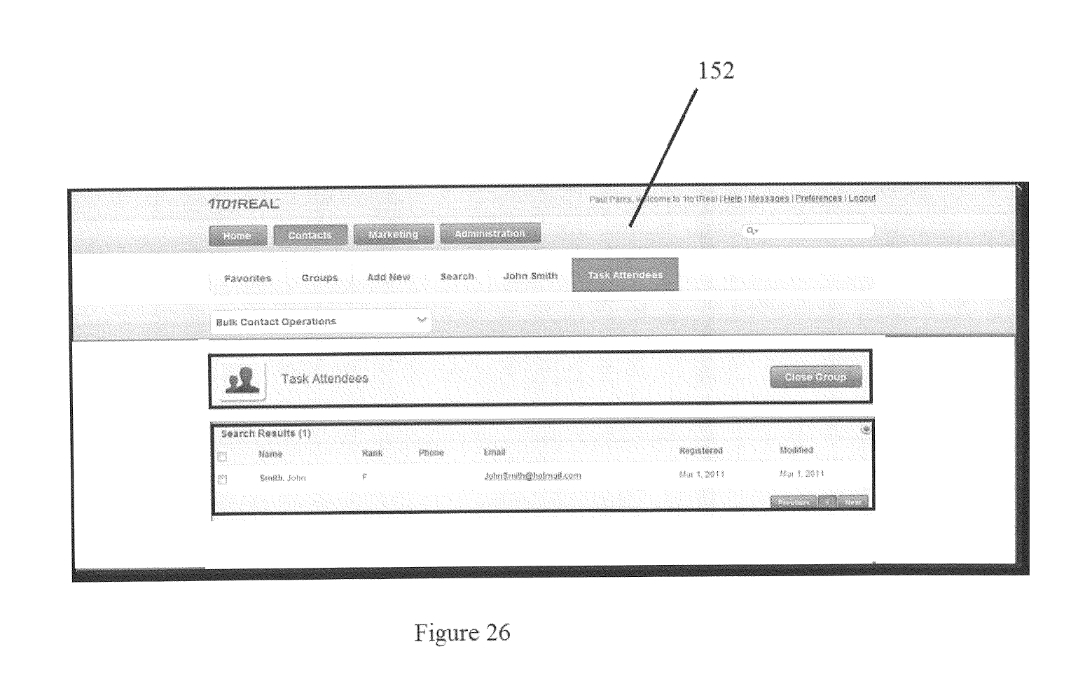

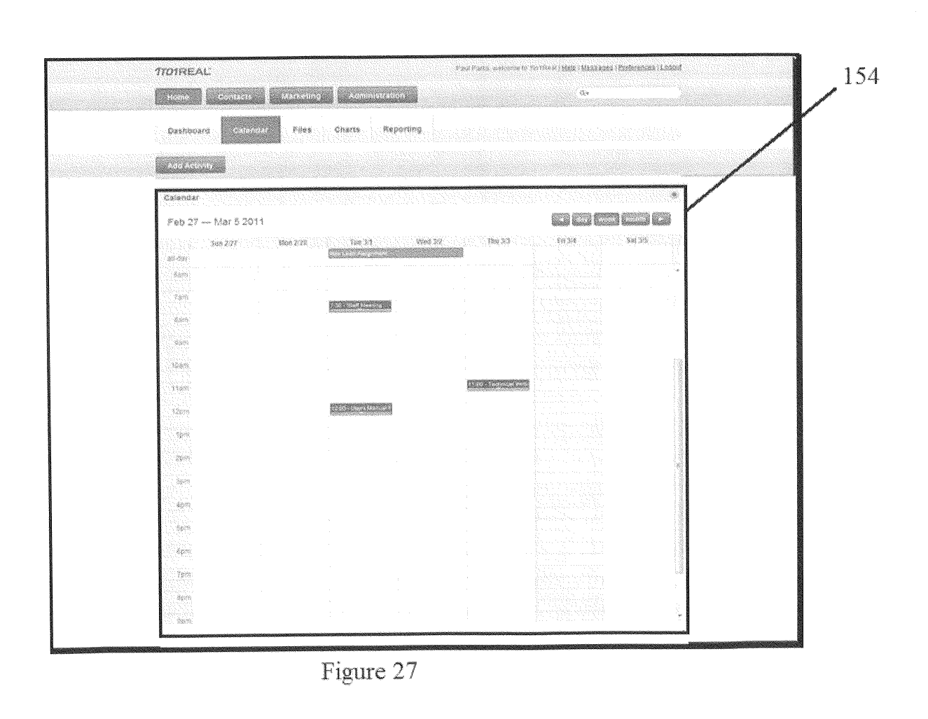

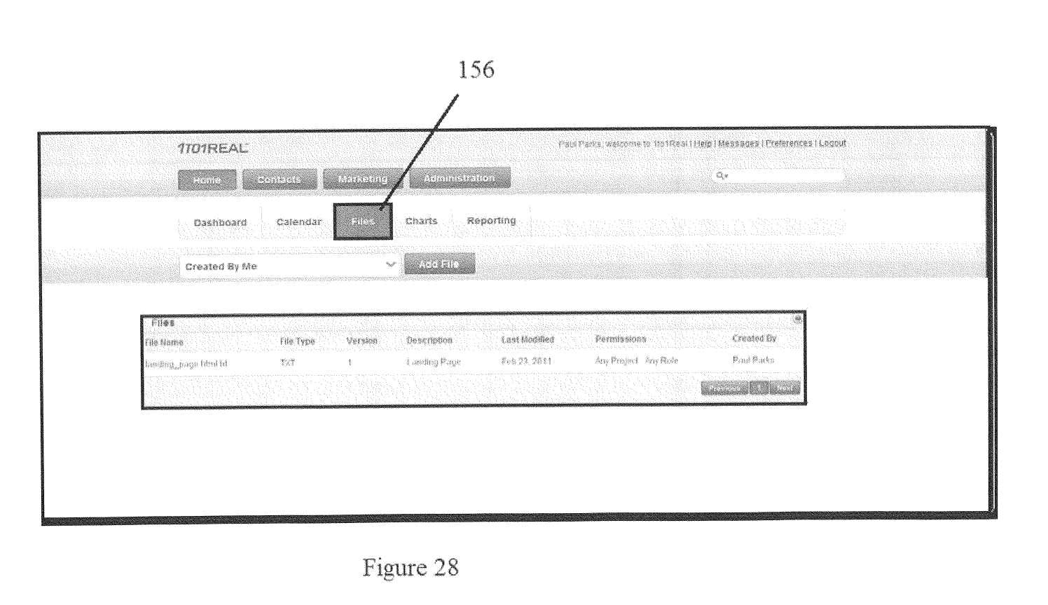

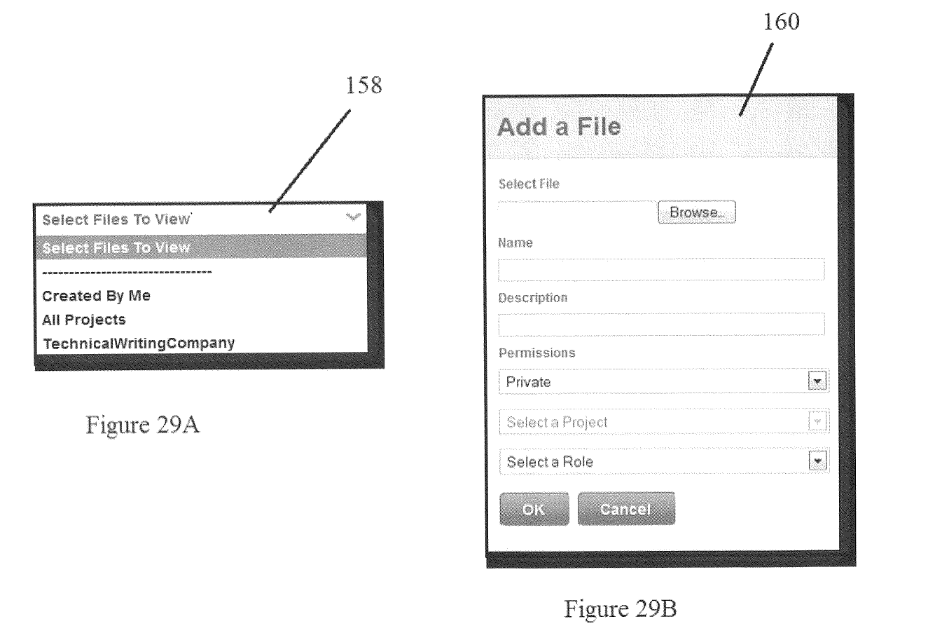

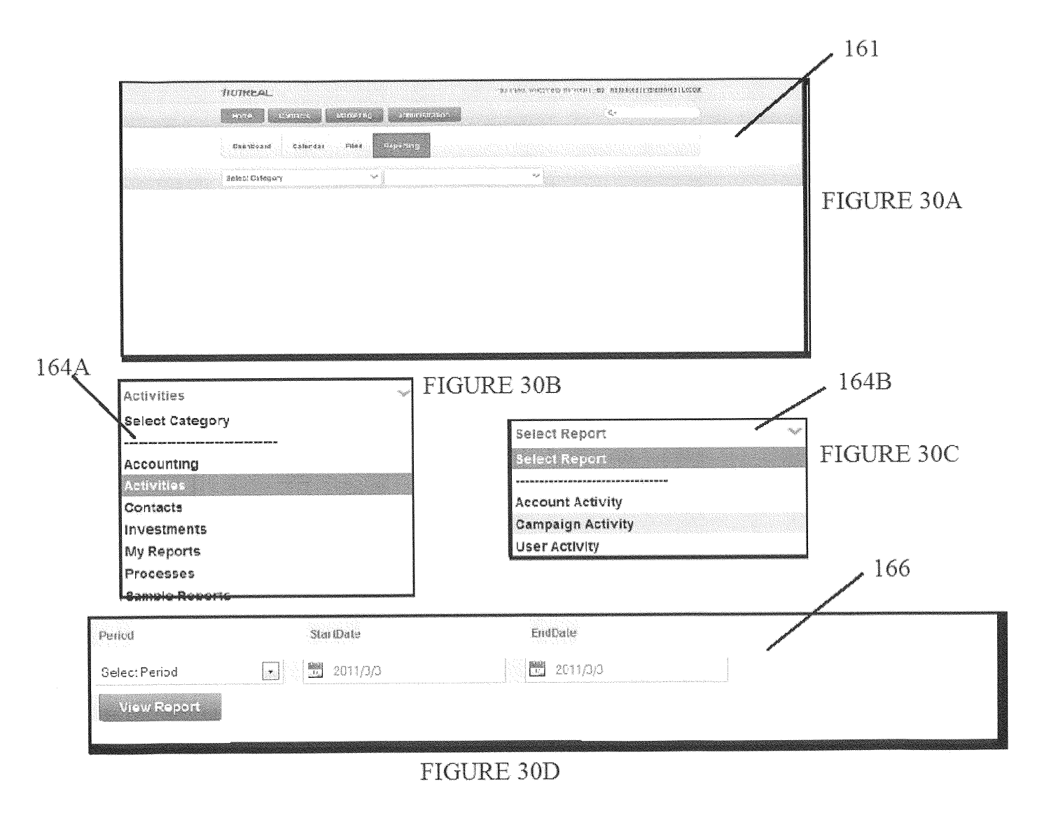

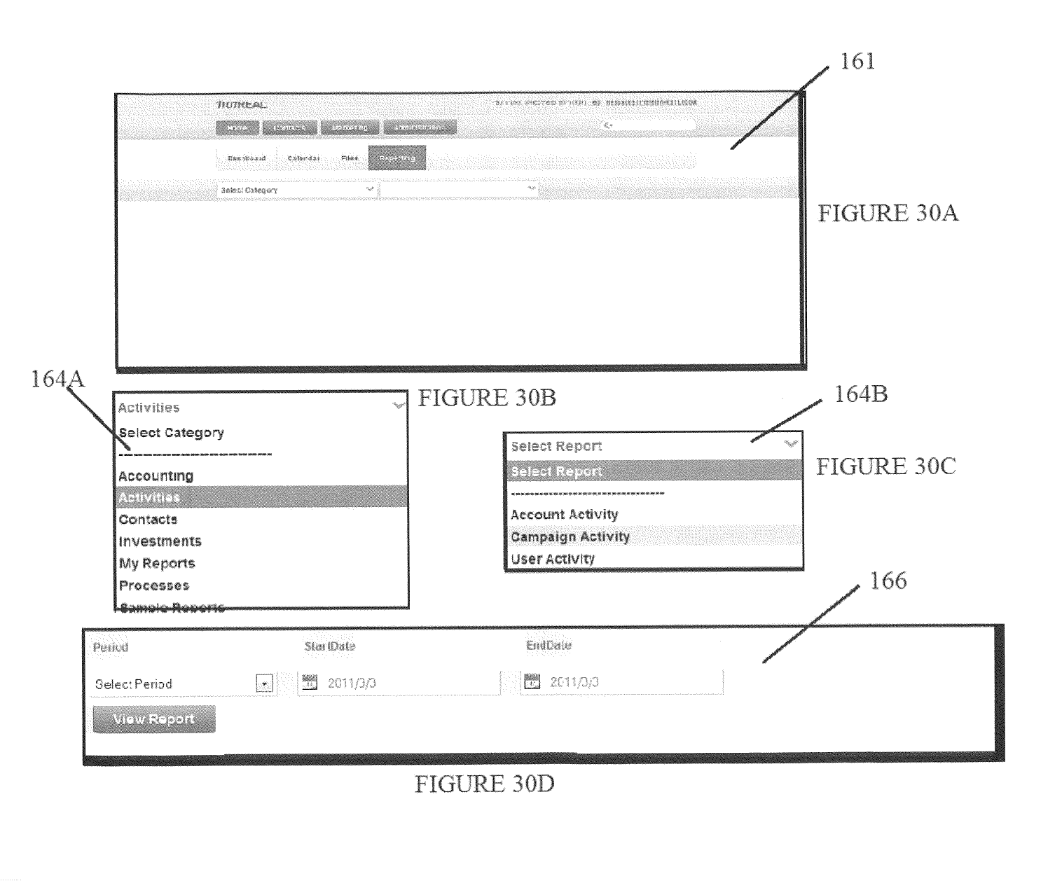

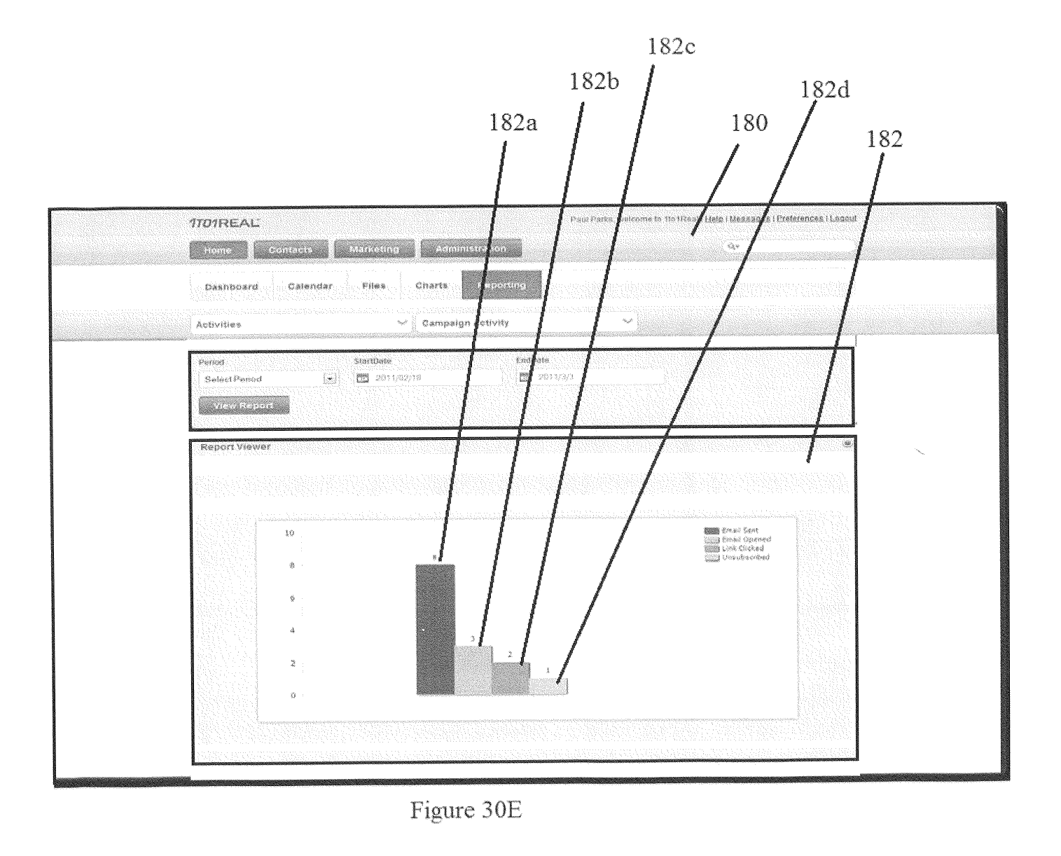

Referring back to FIG. 21 and screen 100 of the dashboard the activities gadget 102 displays all of the activities 102A that a user will have to complete within a specific period of time. Referring to FIG. 25 the activities gadget permits functionality from a variety of pop-up menus. Menu 134a shows functionality of opening contacts 136, listing contacts 138, editing a task 140, and entering into on-line discussion groups with other users associated with a specific activity 142. The on-line meeting place identified as ‘View 1 to 1 ME Space’ is an on-line meeting space where users can have discussions and post files. Once a discussion space is crated, notifications can be sent to participants who have been invited to ‘connect’ through the space at any time in order to continue an ongoing discussion. This facility is advantageous in that the user does not have to exit the system in order to access other e-mail programs to schedule meeting sessions with associated activity users. Menu bar 144 lists other functionalities such as deferring an activity 146 or dismissing a task, Button 148 and Screen 148a. Activities can be deferred 146a for a specific number of days by using the pull-down menu 150. Referring to FIG. 26 and screen 152 the activities gadgets including a facility to permit the user to identify, add or delete attendees associated with any task. Referring to FIG. 27 the dashboard includes a calendar feature as illustrated by screen 154. The dashboard also includes a facility to upload files in respect of any task as illustrated in FIG. 28 in screen 156. As illustrated in FIGS. 29A and 29B the files gadget in the activities area includes a menu screen 158 which can filter files for listing in the activities area and screen 160 permits user to add files. The reporting function illustrated in the dashboard FIG. 21 at item 120 is further detailed in FIGS. 30A to 30D. The reporting function permits reports to be selected and filtered according to Screens 164A and 164B. The reports can be provided over specifically set time periods as shown in Screen 166. Referring to FIG. 30E reports can be prepared graphically for the user as shown at screen 180. In the example shown in FIG. 30E the report shows by way of a bar graph 182 the number of e-mails sent 182a, opened 182b, the number of links clicked 182c and the number of users that were unsubscribed 182d.

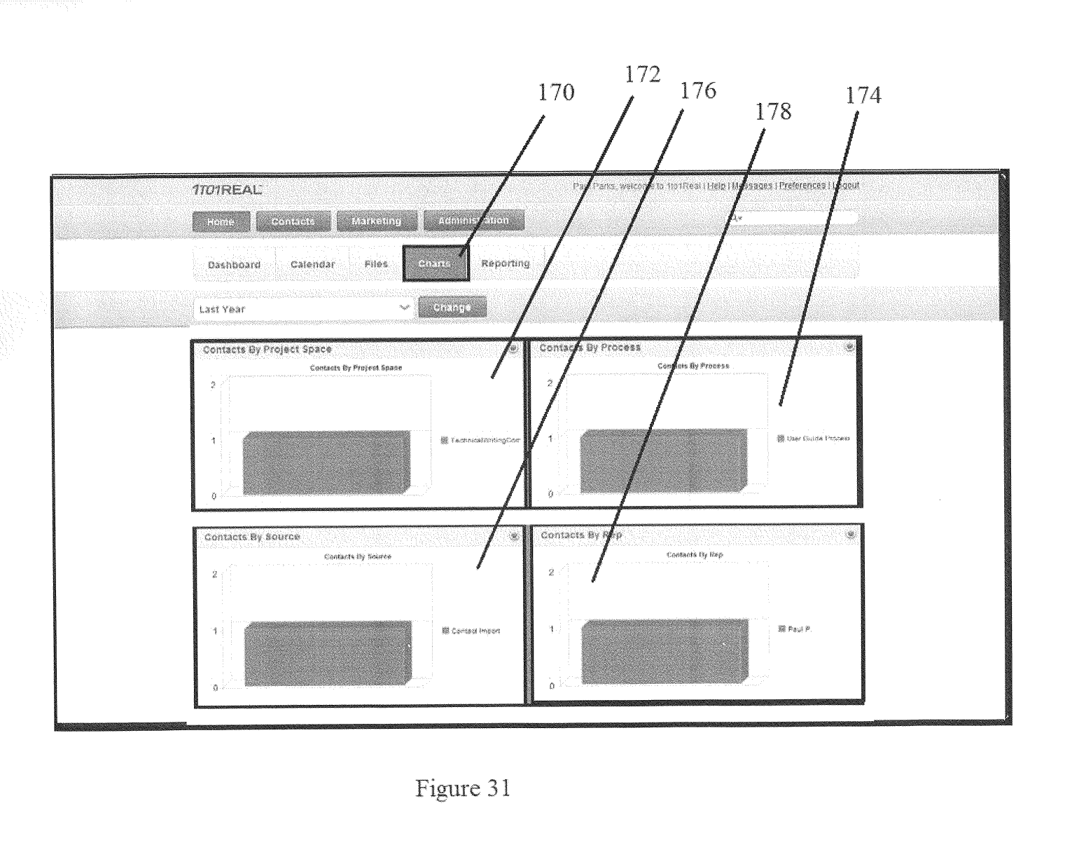

Referring now to FIG. 31 the dashboard includes functionality at item 118 on FIG. 21 for charting contact sources by project space as illustrated in screen 170. Screen 170 illustrates that the charting of contacts can be filtered by project space 172, the process 174, source 176 and by representative 178.

Contacts

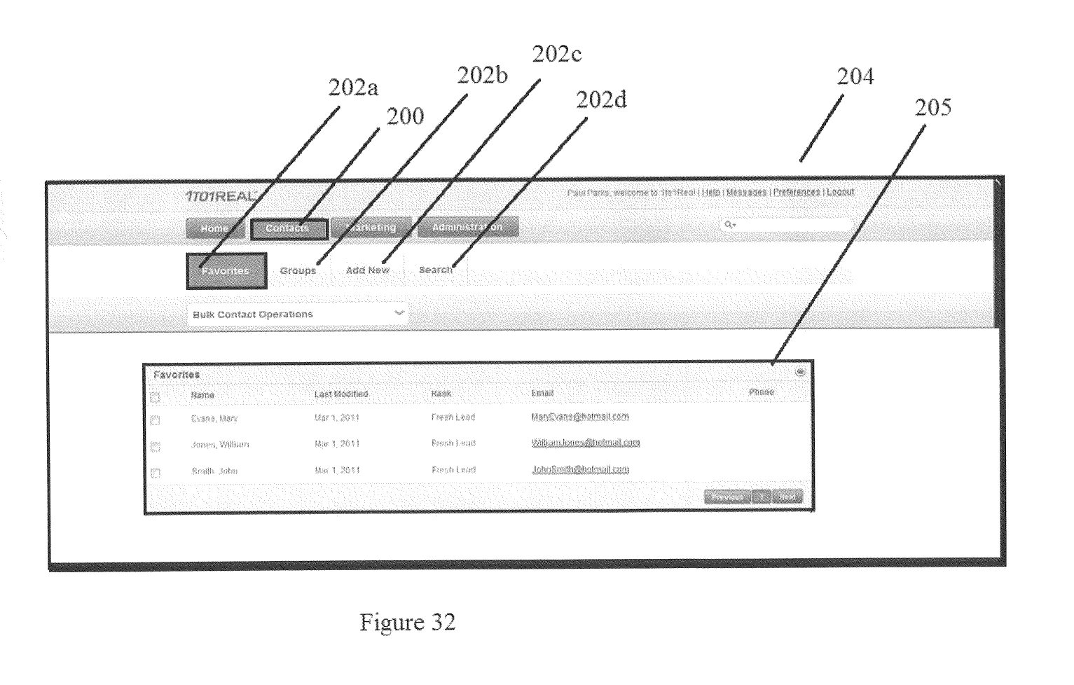

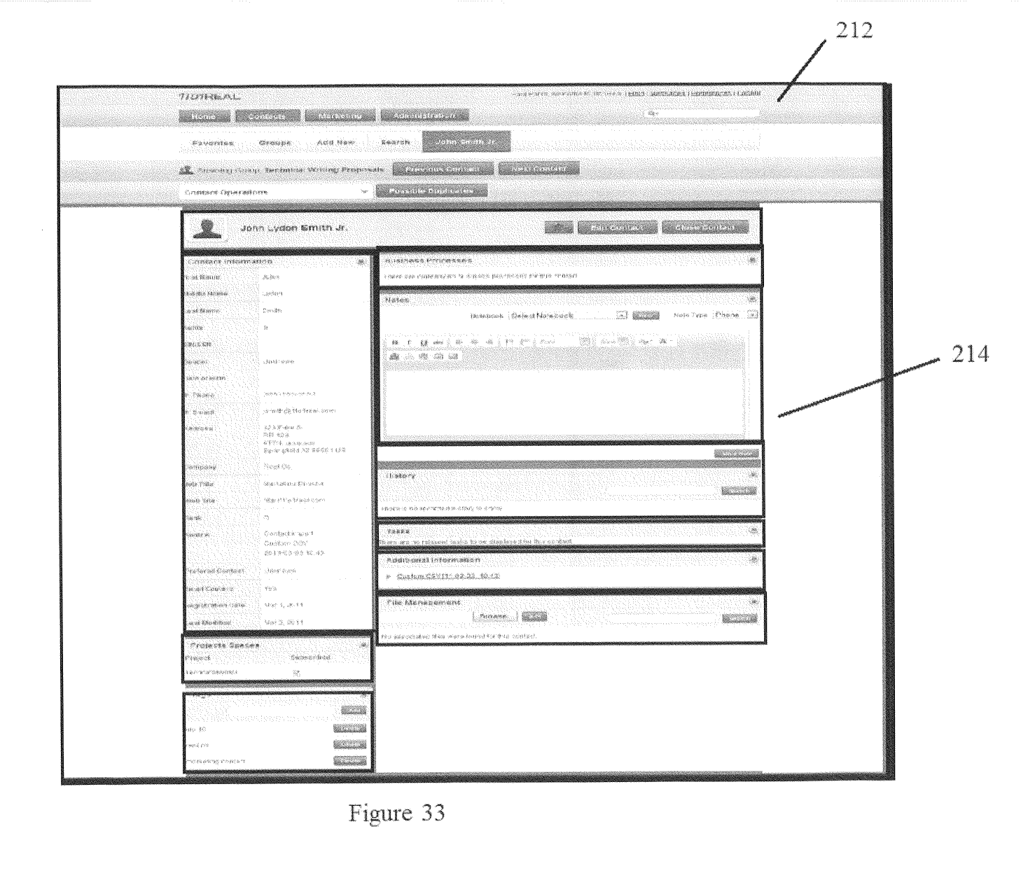

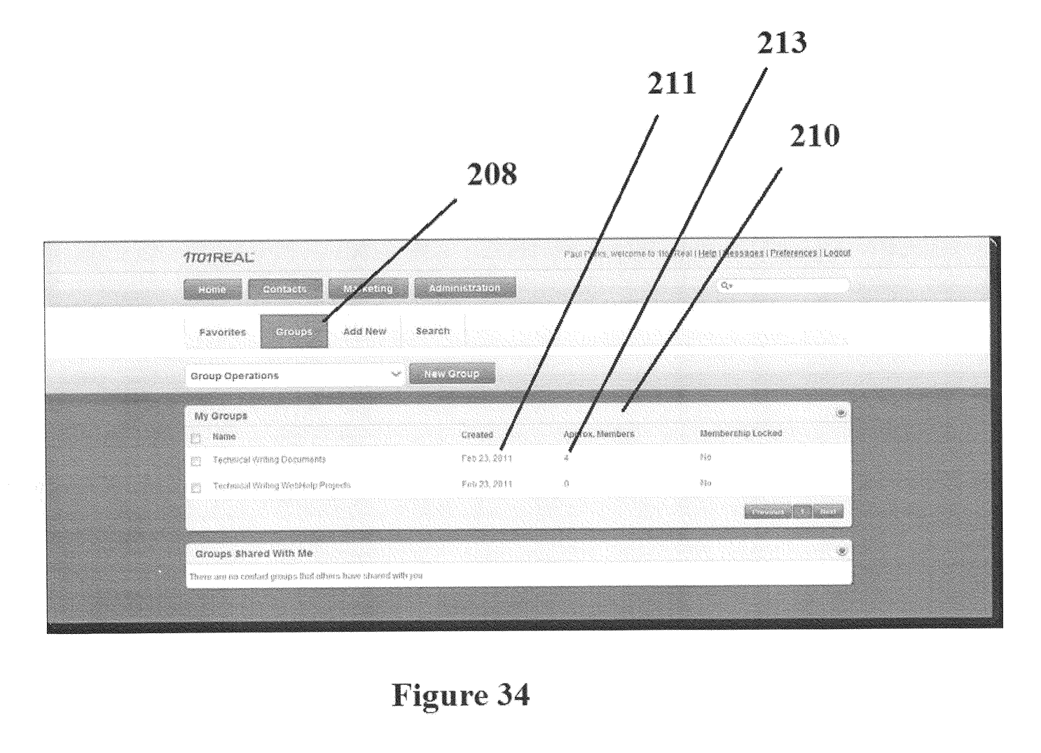

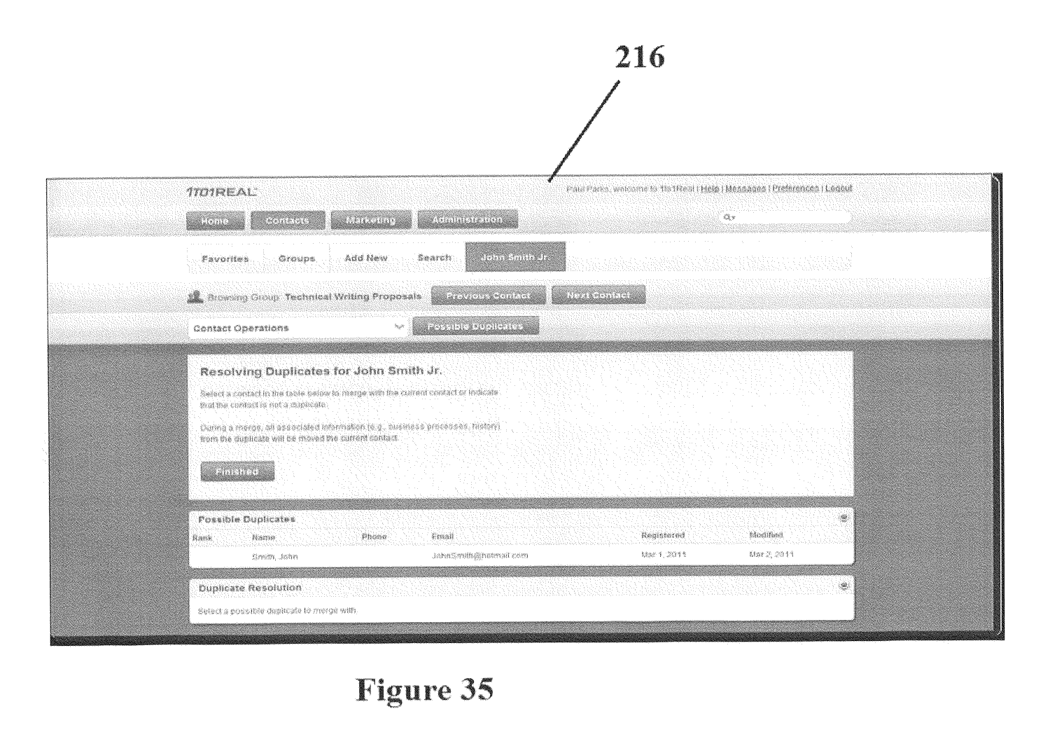

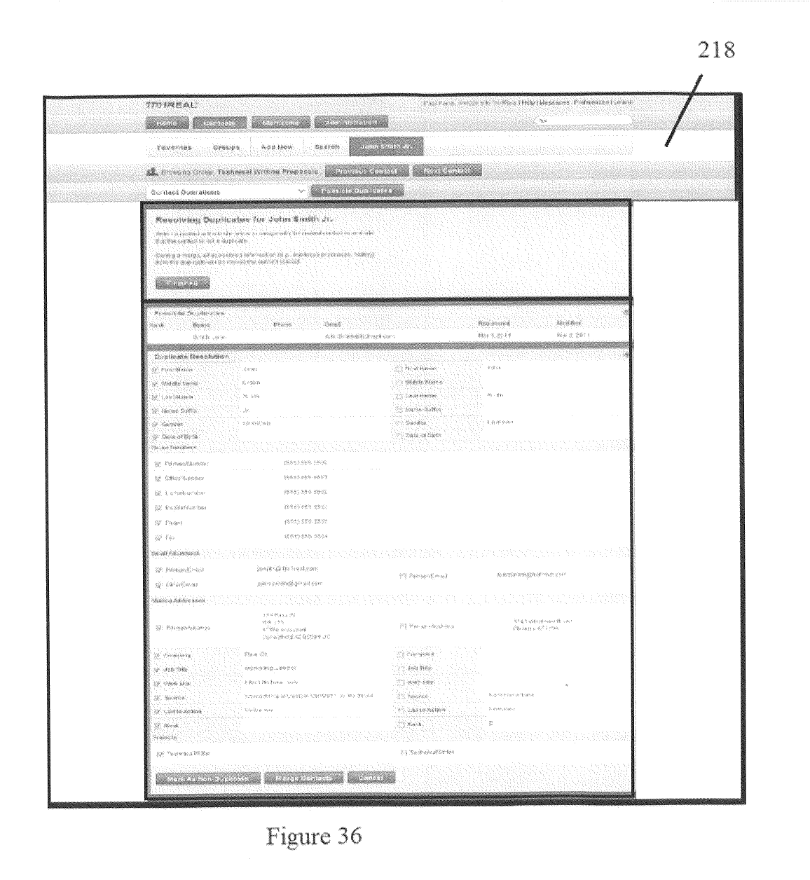

Referring back to the dashboard illustrated in FIG. 21 the activity area for contacts 104 shows a number of gadgets comprising at least four gadgets in this embodiment comprising import contacts 104a, view favourites 104b, add a contact 104c and contact groups 104d. Referring to FIG. 32, Screen 204, clicking on the contacts button 200 on the dashboard 100 in FIG. 21 will produce a menu bar comprising the gadgets favourites 202a, groups 202b, add new 202c and search 202d. For the favourites gadget 202a screen 204 in FIG. 32 will illustrate a list of contacts that can be designated by the user as favourite contacts. Each of the designated favourite contacts 205 will have a profile illustrated in FIG. 33 at screen 212 window 214. The contacts area provides for a group gadget at FIG. 34 item 208 which permits the user to work with contact groups. Contact groups are displayed in the “my groups” list window 210 which shows the date which the group was created 211 and the number of members in the group 213. Groups can be edited, shared and deleted. Any duplication of contacts can be resolved through a mechanism illustrated in FIG. 35 screen 216. In FIG. 36 screen 218 contacts can be merged and all associated information such as business processes and history from any duplicate contact will be moved to the current contact.

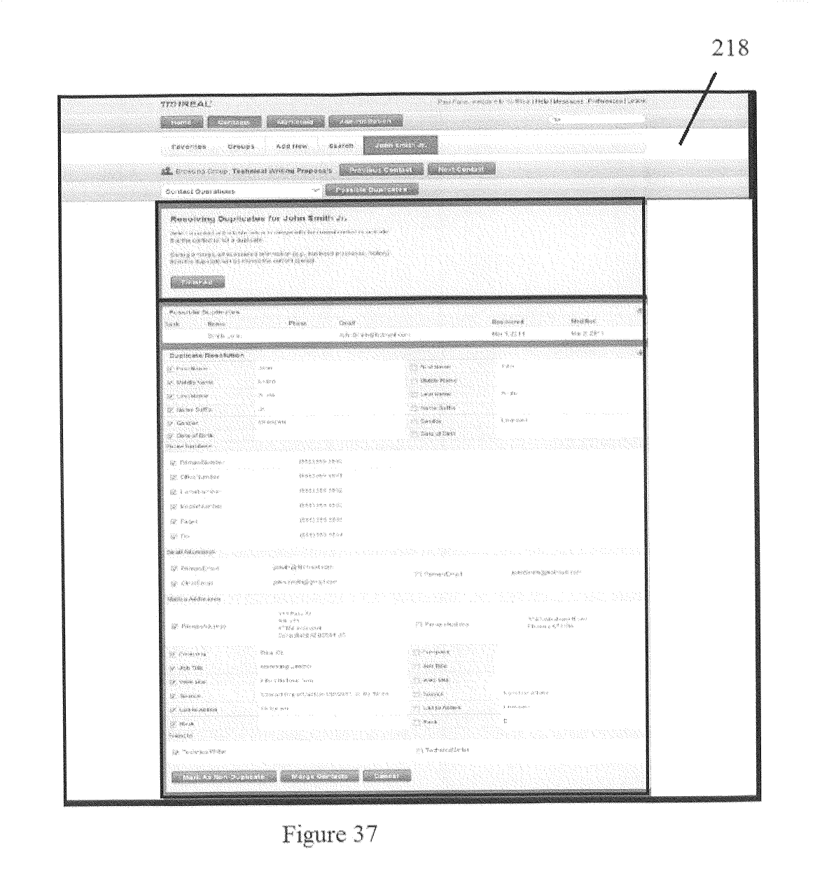

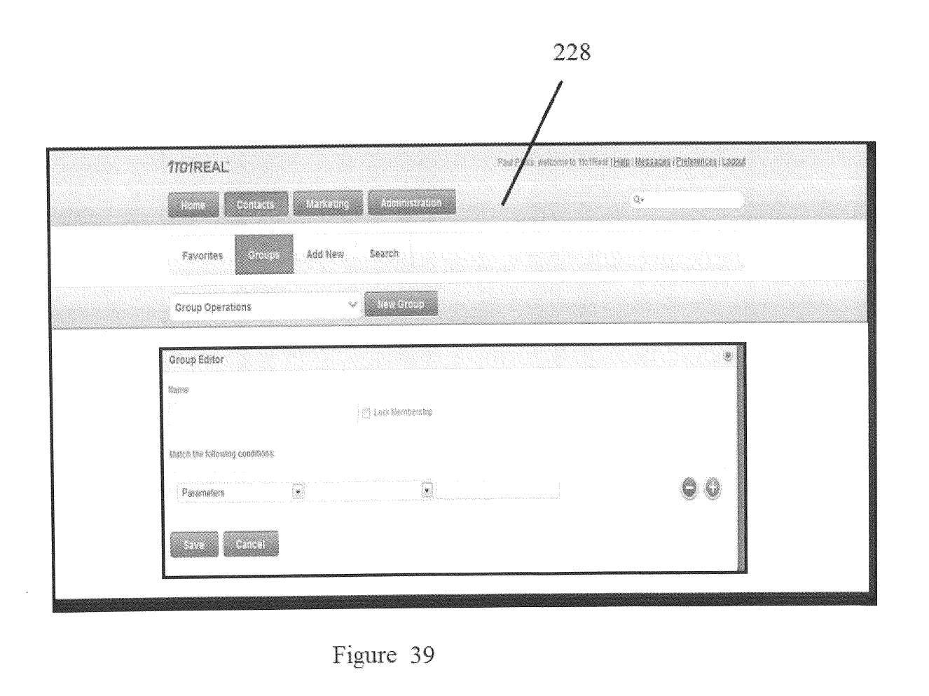

Referring to FIG. 37A screen 220 contact groups can be edited and screen 222 shows a variety of group operations in FIG. 37B including tagging contacts 222a, recording notes 222b for distribution to a contact list, creating a campaign 222c for distribution to a contact list and the automatic drive feature 222d to be discussed below. Referring to FIG. 39 the automatic drive editor is illustrated in screen 224.

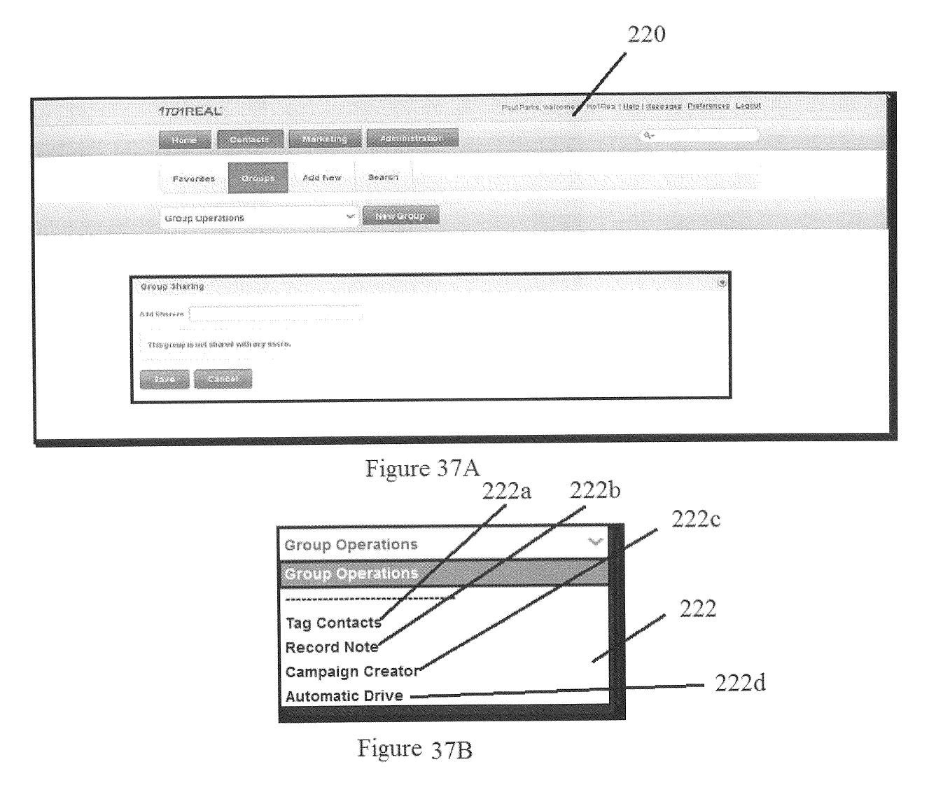

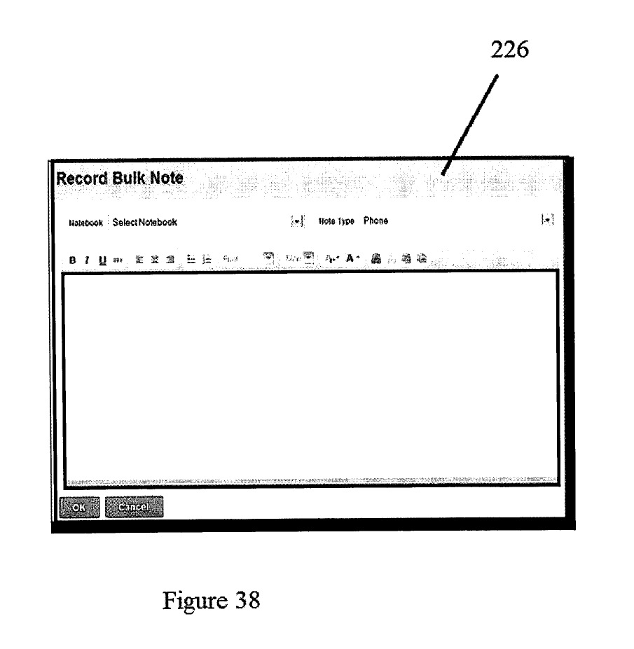

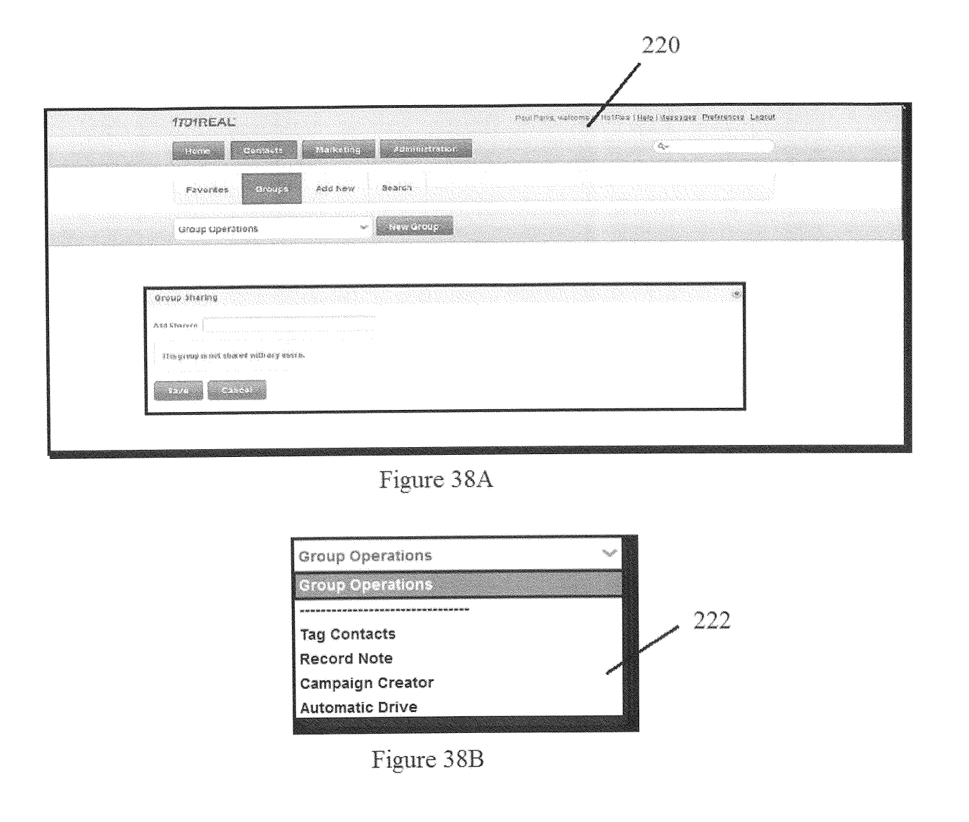

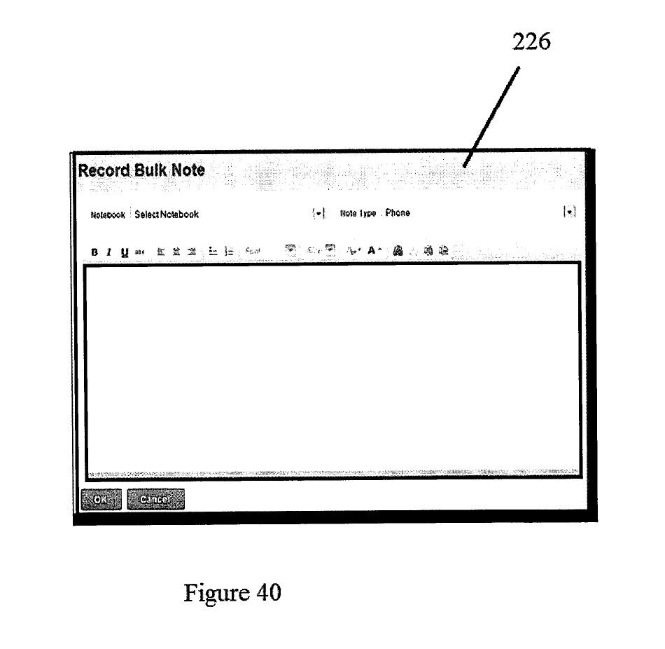

Referring to FIG. 38 screen 226 a bulk note can be created and delivered to a selected group. Referring to FIG. 39 screen 228 new groups can also be added to the system. In FIG. 40 in screen 232 a contact group can be shared 233 with other users of the system.

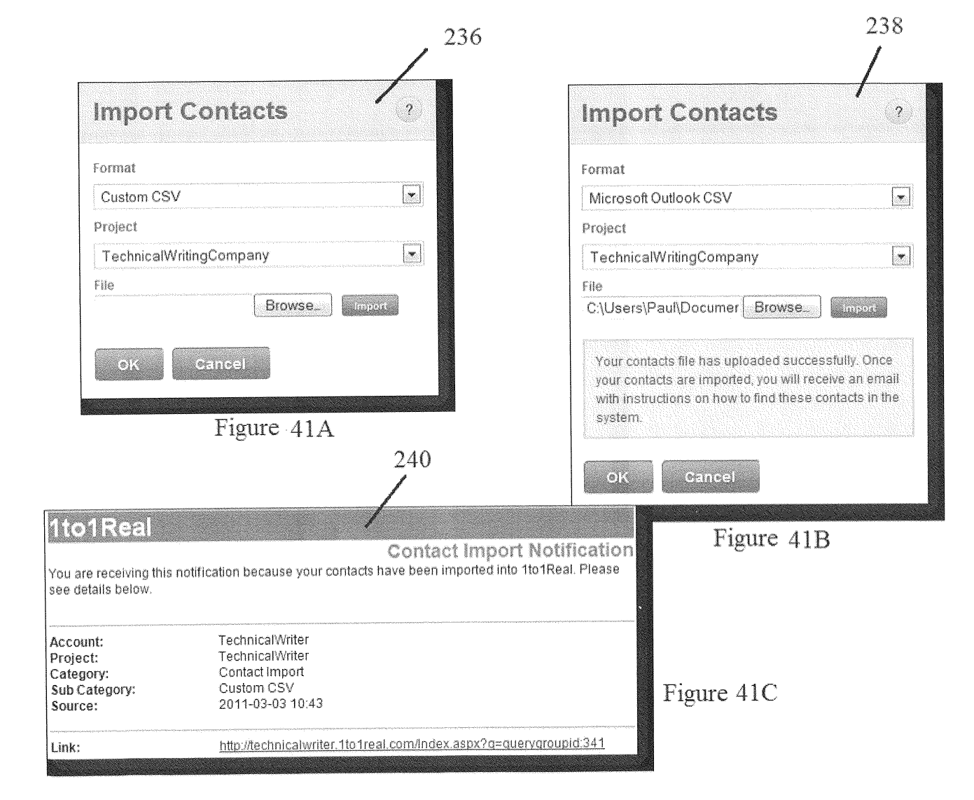

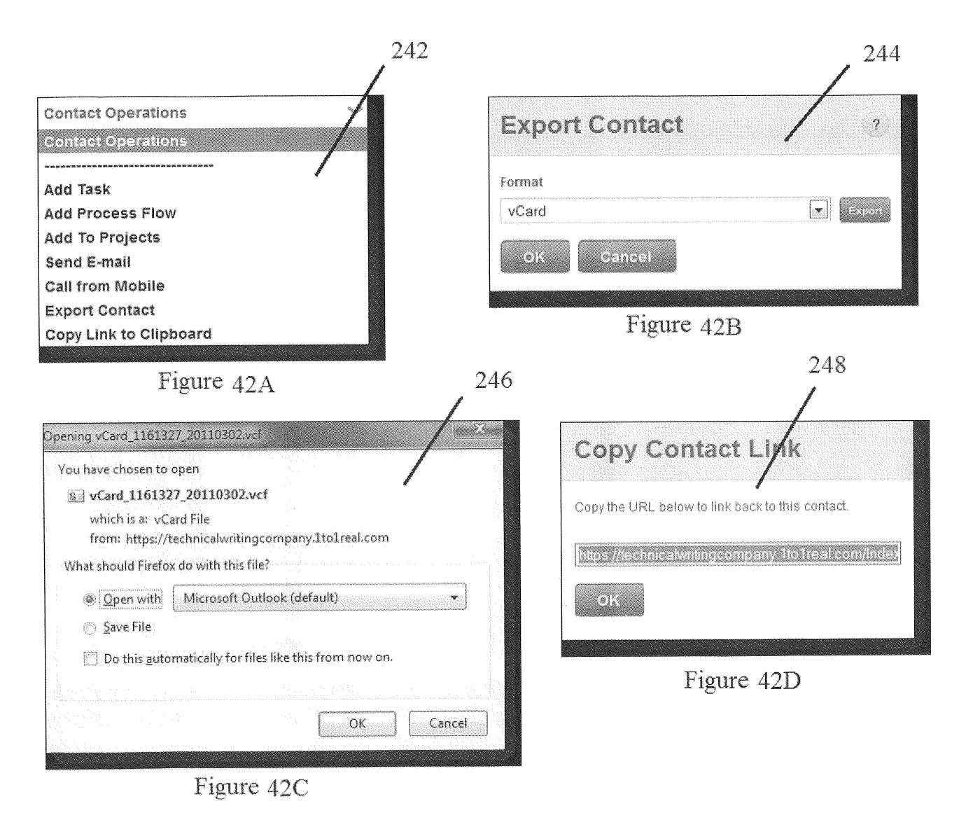

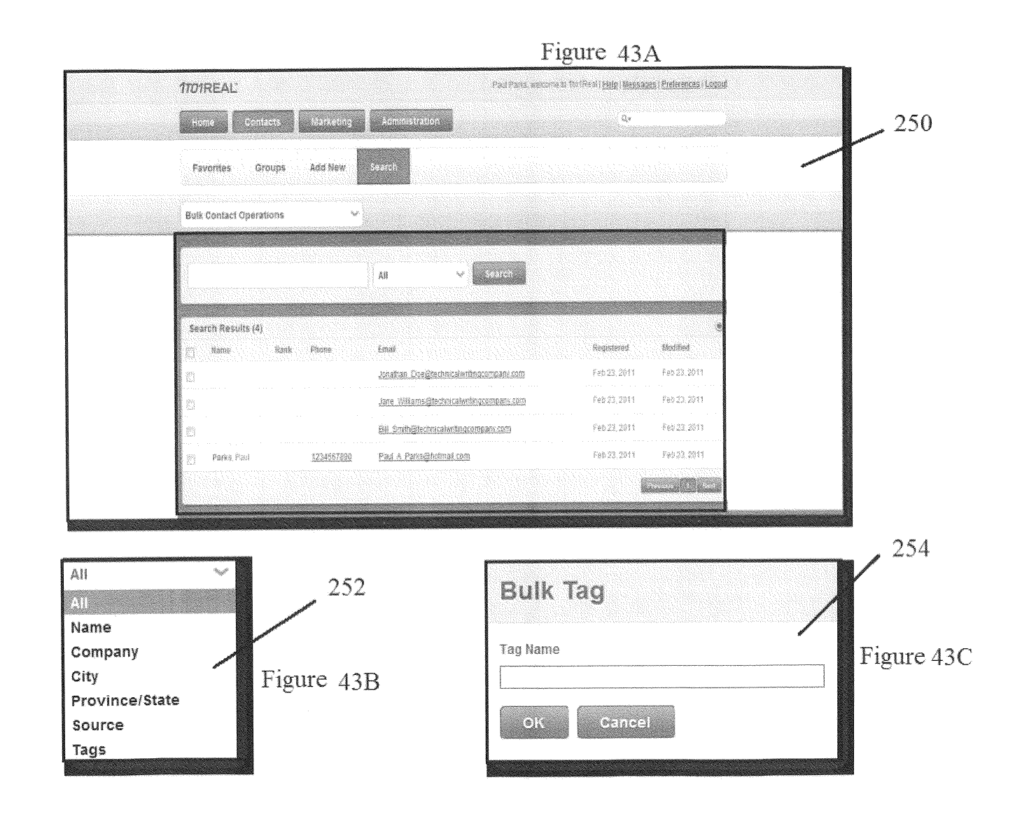

Referring to FIG. 41A there is a gadget for importing contacts into the system as shown in window 236. Contacts can be imported from such programs as Outlook® as shown in FIG. 41B screen 238. Confirmation that contacts have been important into the system is sent to the user as shown in FIG. 41C in window 240. Referring to FIG. 42A to 42D window 242 lists a variety of contact operations. For example, window 244 shows that contacts can be exported in a vCard format and opened with Microsoft Outlook® as shown in window 246 or a contact link can be established which allows the user to copy a contact's information into the windows clipboard. This is illustrated in windows 248. Referring to FIG. 43A to 43C and screen 250 contacts can be searched by using the filters shown in window 252. Window 254 shows that a group of individual contacts can be tagged using a bulk tag dialog. Referring to FIG. 44A to 44C a group of individual contacts can be associated project and/or process type by using the feature noted at window 256. A project is selected from the pull-down list 258, a list of assignees is chosen from the assignees list in filed 260 and a process is chosen from the menu 262 a note can be recorded to contacts on a list using the record bulk note editor.

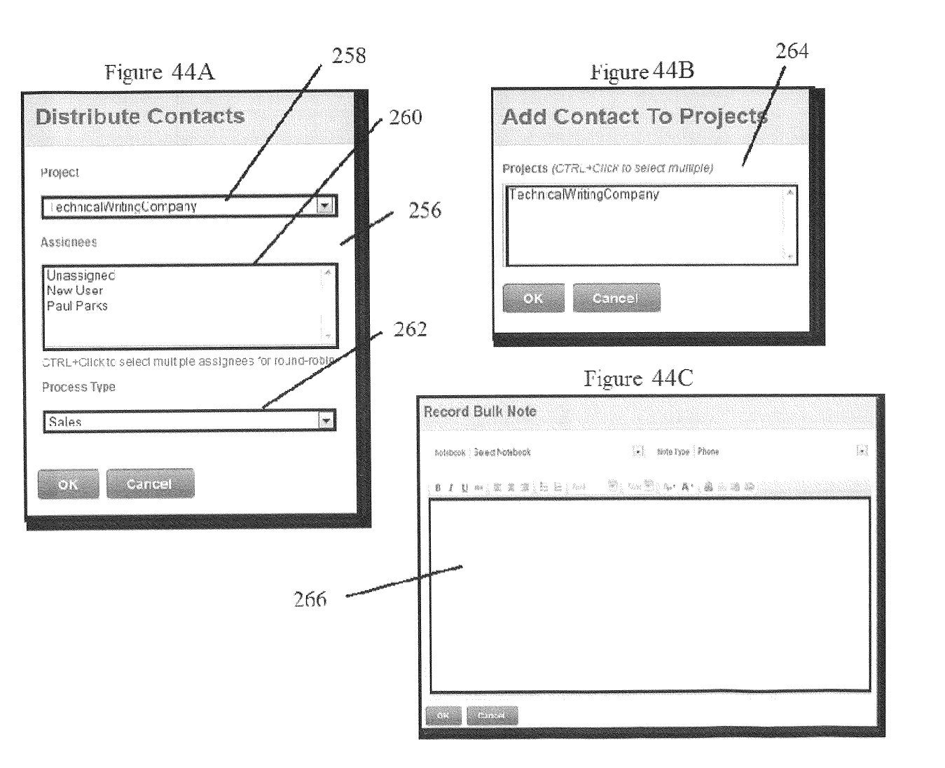

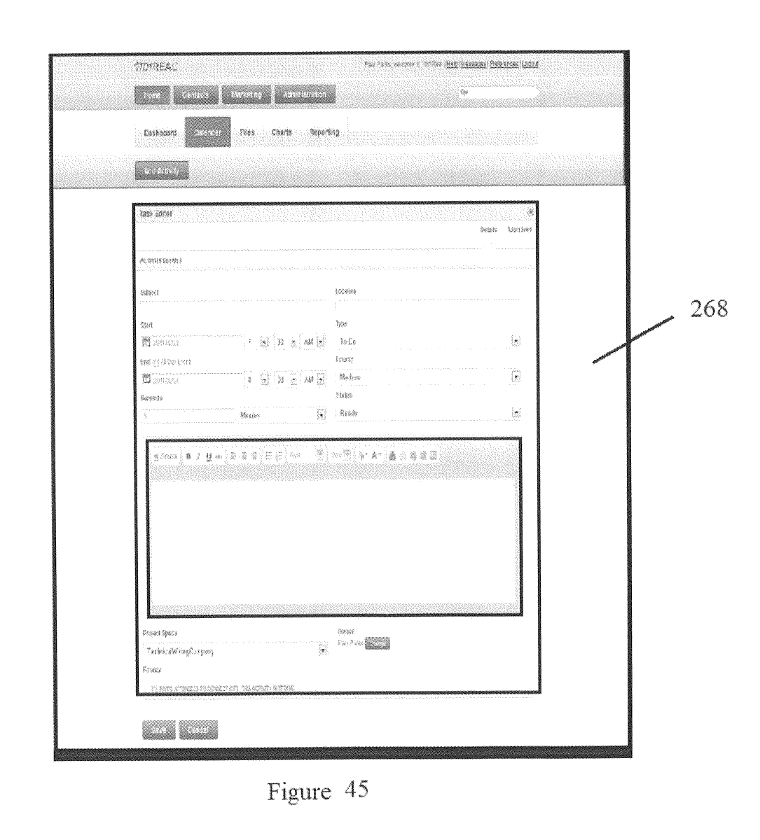

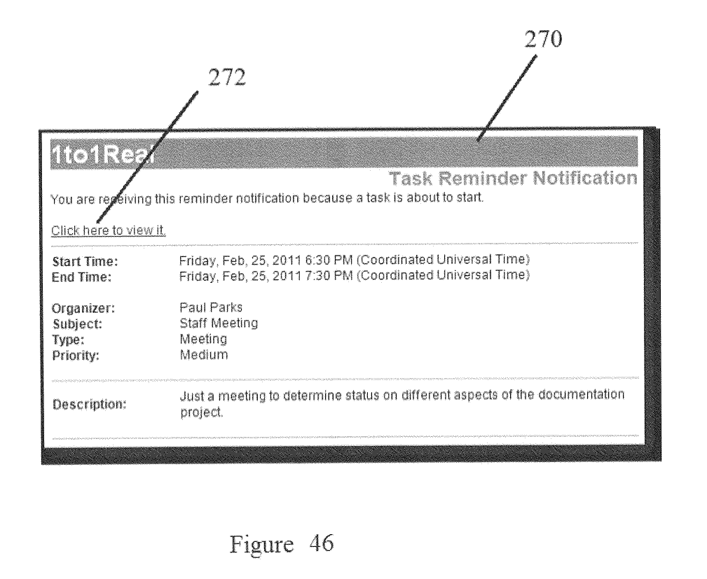

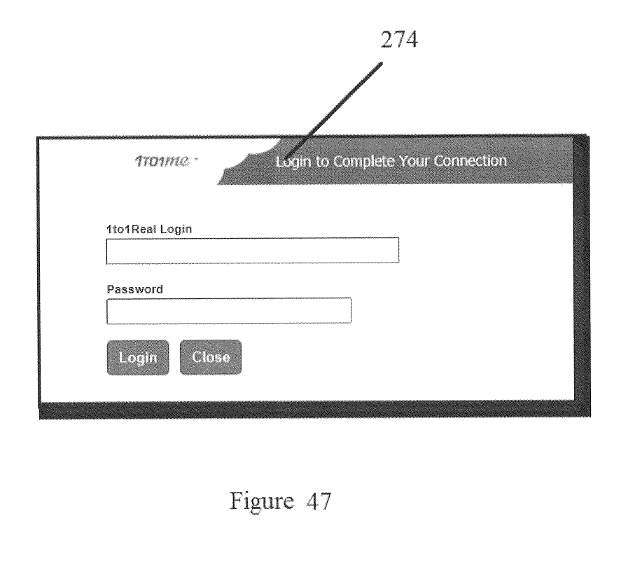

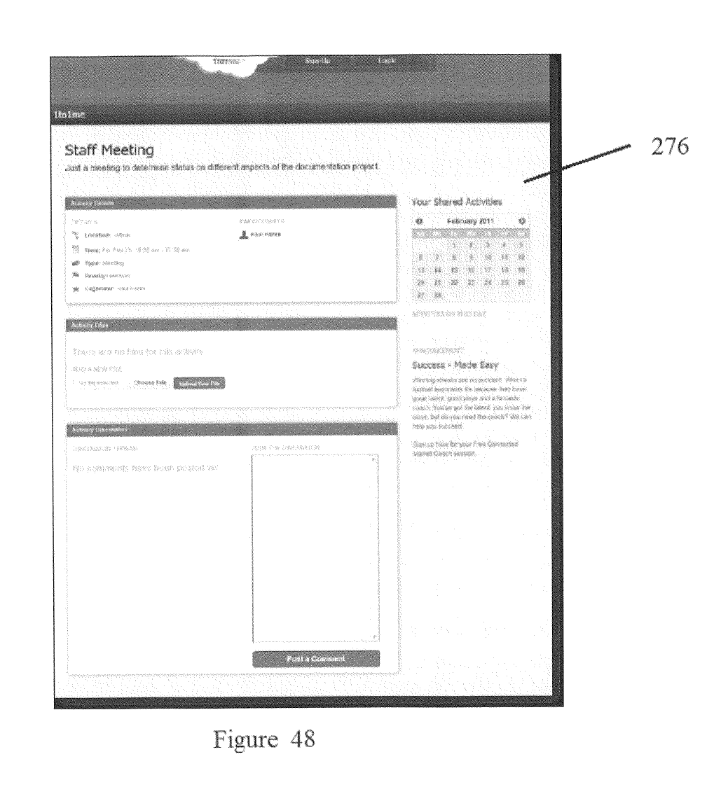

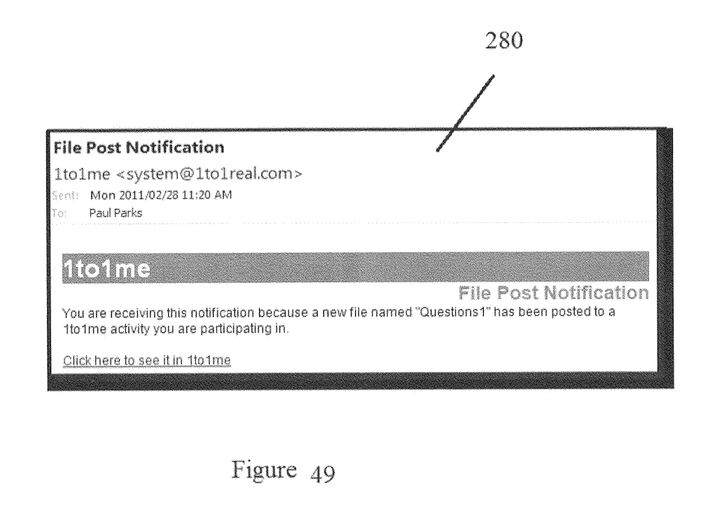

Referring now to FIGS. 45 and 46 a task can be created for contacts selected using the activity editor in window 268. In window 270 as a task approaches its start time a reminder notification will be sent to all contacts associated with the task. Those contacts will be invited to use link 272 which will take the user to a log in screen illustrated in FIG. 47 screen 274. Once logged in the user is taken to window 276 in FIG. 48 where a new task can be added at 276. Once a new task is added a confirmation message is sent to the task participants identifying a new file added to the system as shown in FIG. 49 Screen 280. Contacts can also be associated with marketing campaigns and with the automatic drive mechanism of the system.

Marketing

Referring back to the dashboard illustrated in FIG. 21 the marketing gadgets are found in marketing area 106. The gadgets including a campaign creator 106a, an automatic drive function 106b, a create list function 106c and an e-mail reports function 106d. The marketing feature of the dashboard permits the user to manage mass conversations with customized groups of contacts. The user chooses a group you want to send to, import your email data (either by copying and pasting HTML code, importing the file, or importing information from a URL), preview and send. The marketing feature permits the user to automate follow-up emails according to what are proven to be the most important criteria in an email campaign- allowing the user to keep the conversation going with no additional maintenance.

Campaign Creator

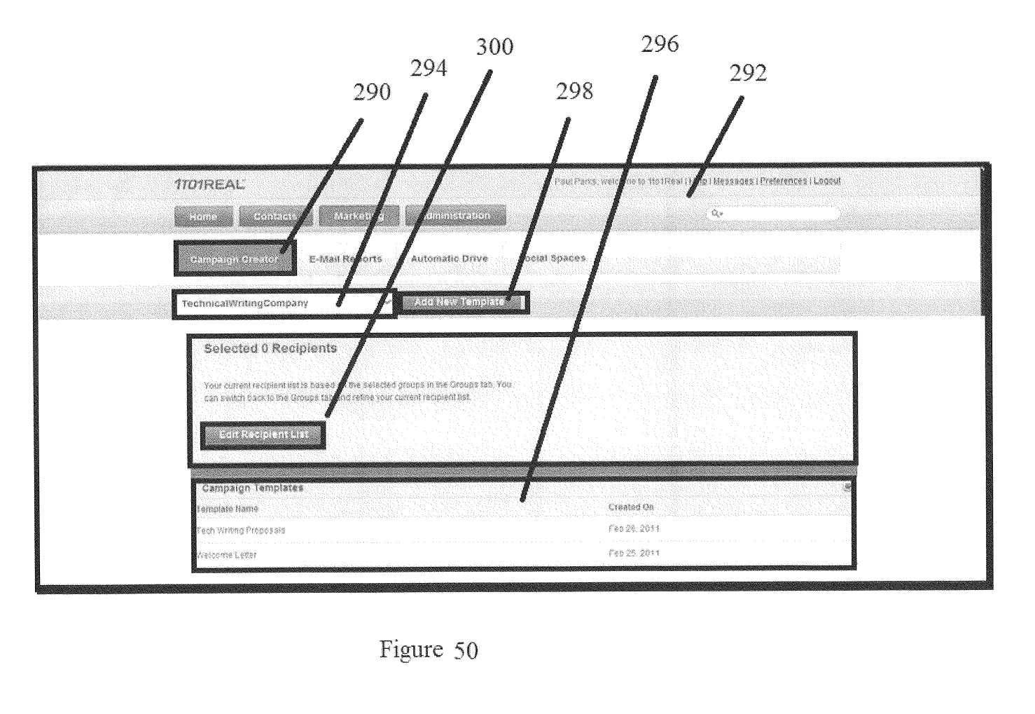

Campaign Creator gadget 290 is illustrated in FIG. 50 window 292. To commence the creation of a campaign the user will select a project space from the project space list 294. This will display a list of templates at 296 that were created on a campaign templates list. The user can also add a new campaign template at 298 and create and modify the recipient list 300 for a campaign template using this screen. A campaign is like a newsletter or an electronic flyer sent to converse with an audience. Based on a recipients handling of the message; (open or not, clicking links or not), a customized follow-up message can be sent automatically. For example, the user sends out an initial newsletter advertising services with links request ‘more information’ or ‘see our catalogue’. The campaign creator can create difference messages for various responses for example a ‘Don't Miss Out’ campaign or a ‘Take a 25% Coupon’ campaign message can be sent to recipients.

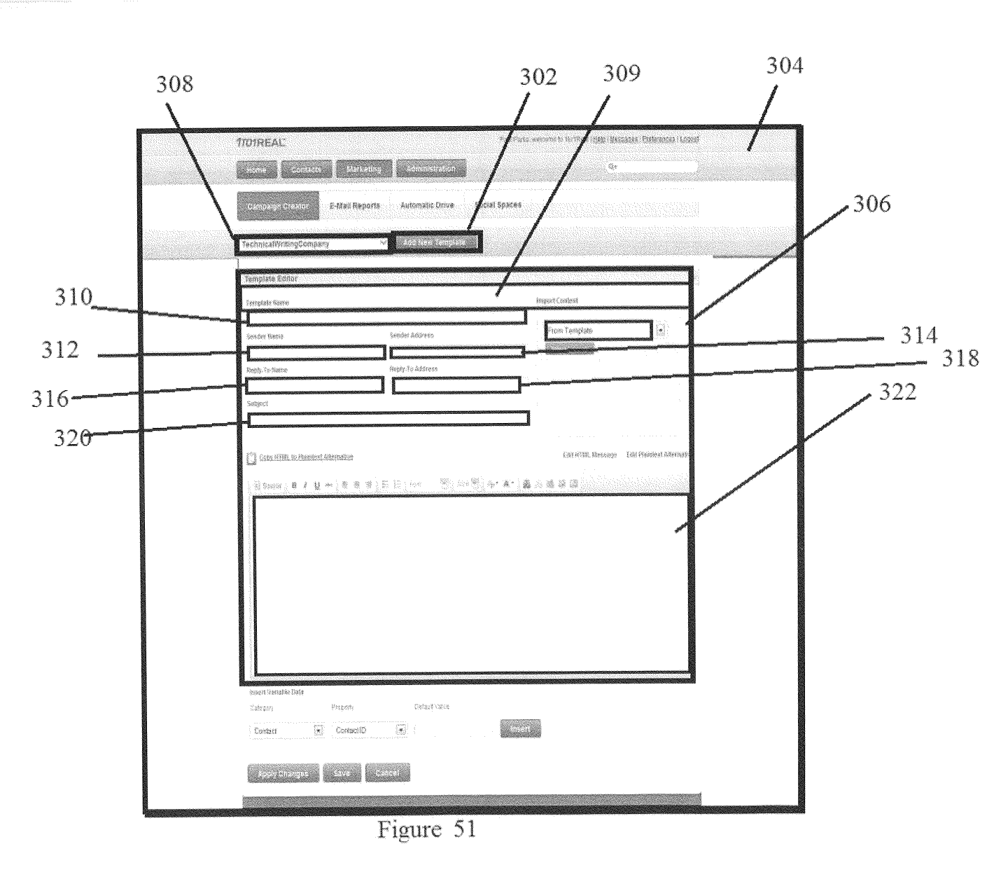

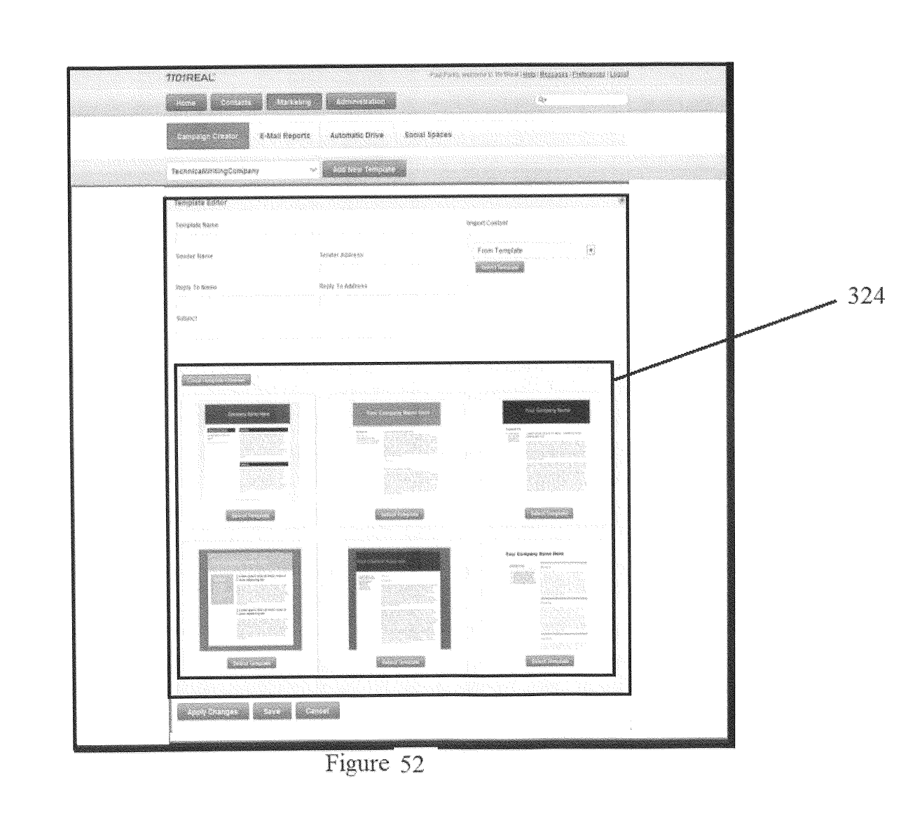

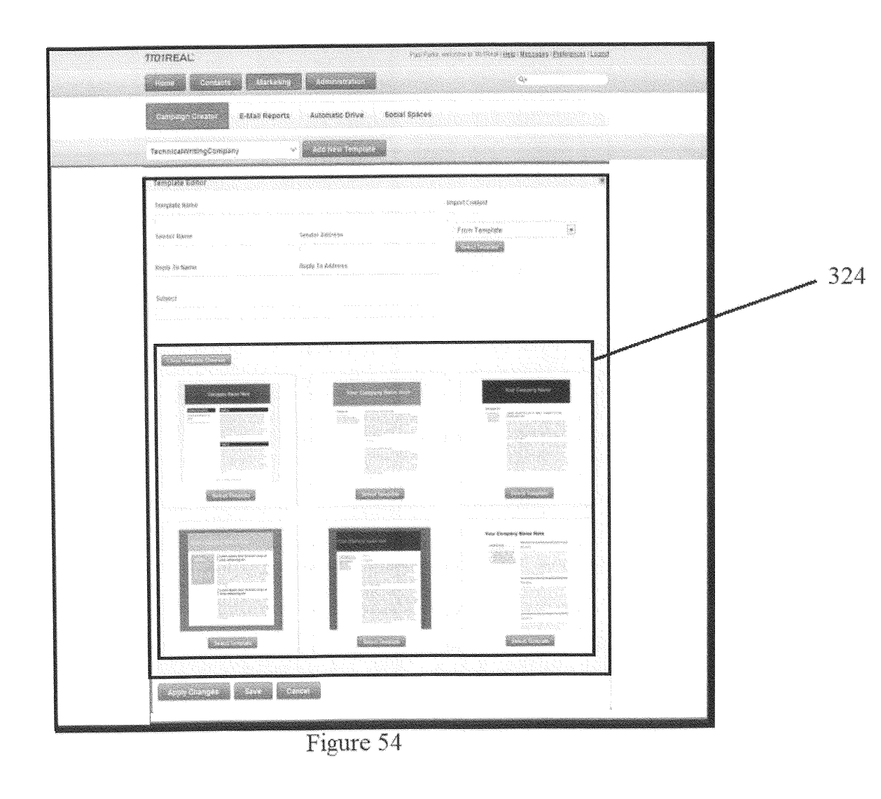

The following figures and text exemplify the creation of a campaign using the invention. Referring to FIG. 51 the user will select “add new template” 302 within window 304. This allows a user to configure a campaign using the template editor 306. The user selects a project space 308 with which to associate the new campaign from the select project space list. This will display the campaign template screen. A name is provided in field 310 and the name of the individual sending the campaign e-mail is provided in filed 312. The sender's address is provided in filed 314. A reply-to name is provided in field 316. The address for the reply-to is provided in field 318. A subject line is entered into field 320, content can be imported into screen 326 and then as illustrated in FIG. 52 screen 324 a variety of templates is displayed for the user.

Links

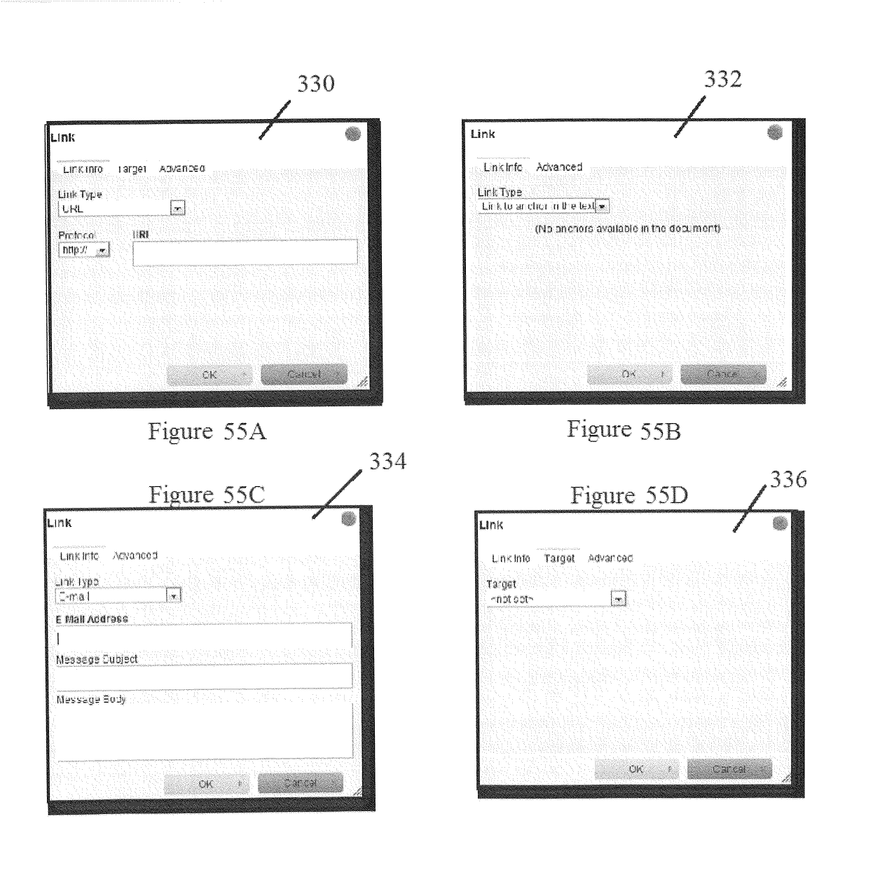

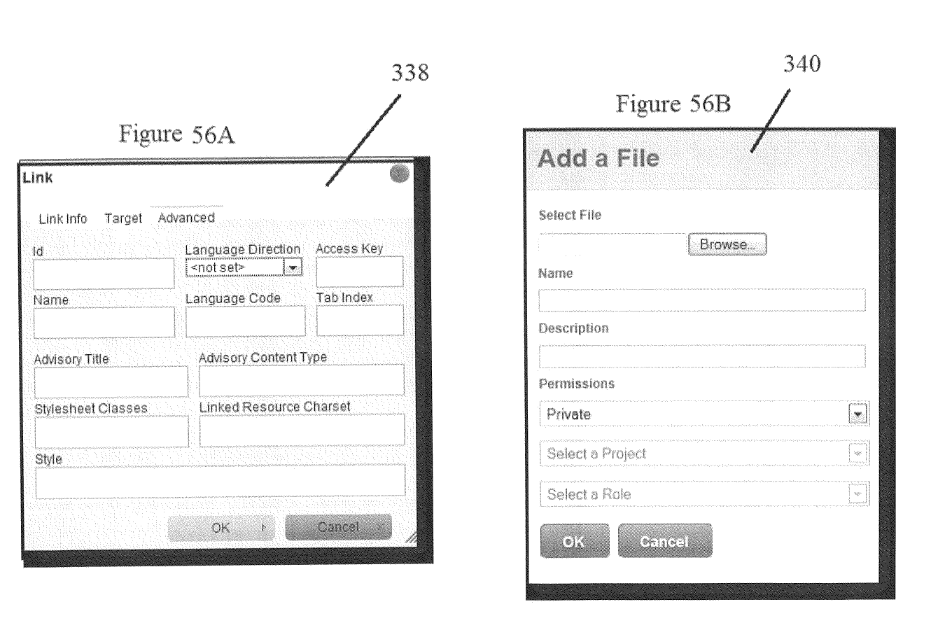

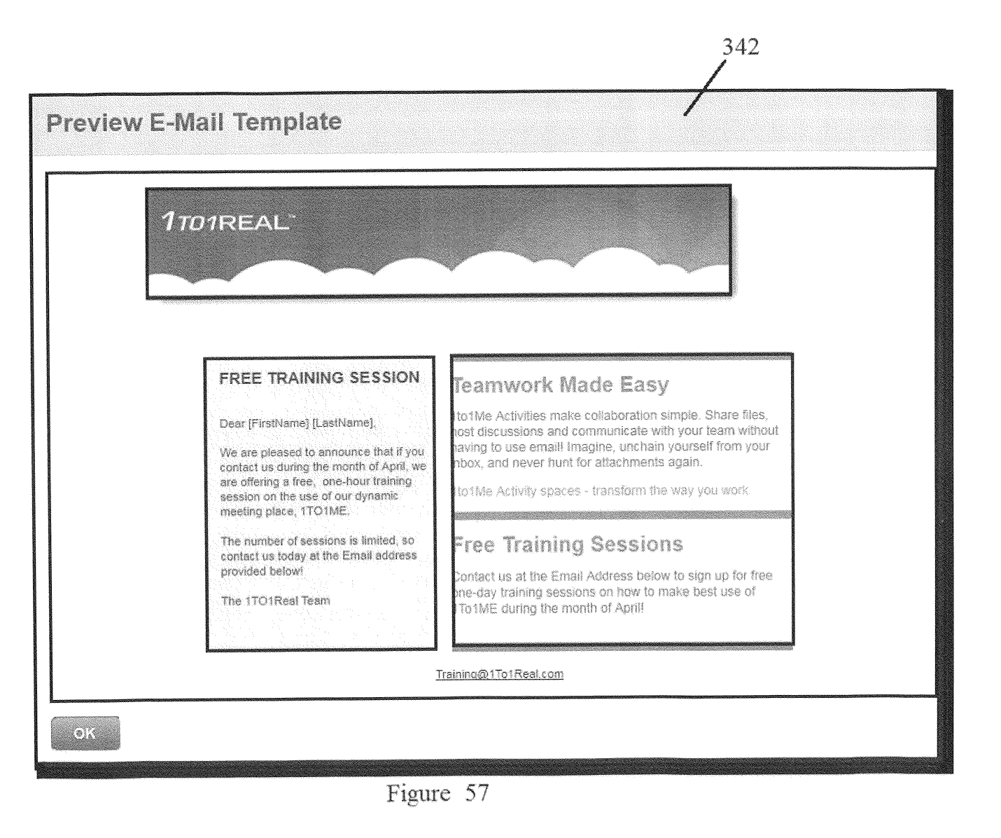

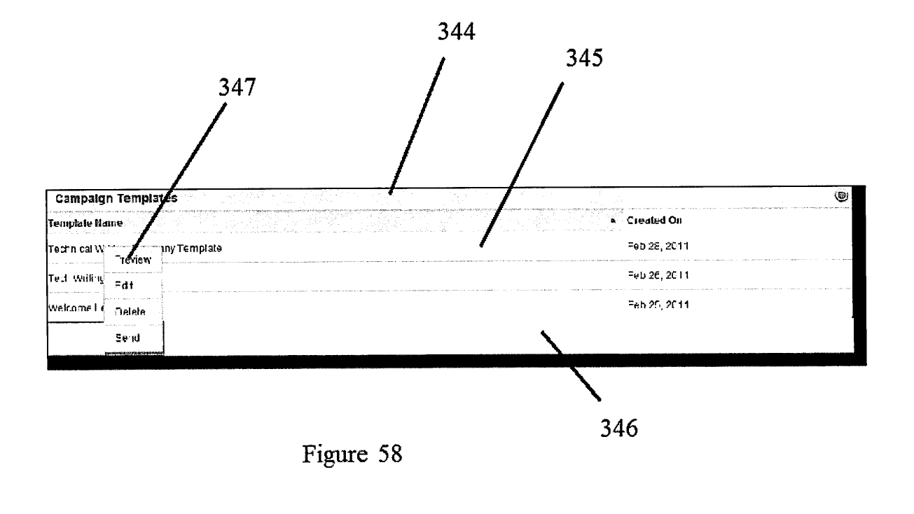

Referring to FIGS. 55A to 55D Items 330 to 336, links can be configured and used to see if the recipients of the message took the action of clicking on the link which indicates a level of interest on their part. Referring to FIG. 56A 338 and 56B 340 and FIG. 57 342 the e-mail template can be previewed and then a recipient list can be selected. The marketing feature permits a test sending of the e-mail message. Campaign e-mail addresses can be edited and deleted. Referring to FIG. 58 Screen 344 clicking a Template Name 345 on the Campaign Templates 346 list and selecting Preview 347 from the pop-up menu displays a preview of the Email Message shown in FIG. 57 screen 342. You will be sending in association with a Campaign as shown in the following illustration. Previewing the Email Message allows you to look for any errors you might have made when creating the message and correct them before you send out the message. Once you're satisfied that everything is perfect, you can confidently send the Email Messages to your selected Recipients, as described below. Referring to FIG. 58, Item 344 Now that the Campaign has been created, it's time to send the associated Campaign Email which will allow you to judge the effectiveness of the Campaign through the use of 1 To 1 Real™'s Email Reporting function, based whether or not the recipients of the newsletter you've just designed react to this Email message; i.e., whether or not they open it, click on any links contained within it, etc. Follow the steps below to send a Campaign Email.

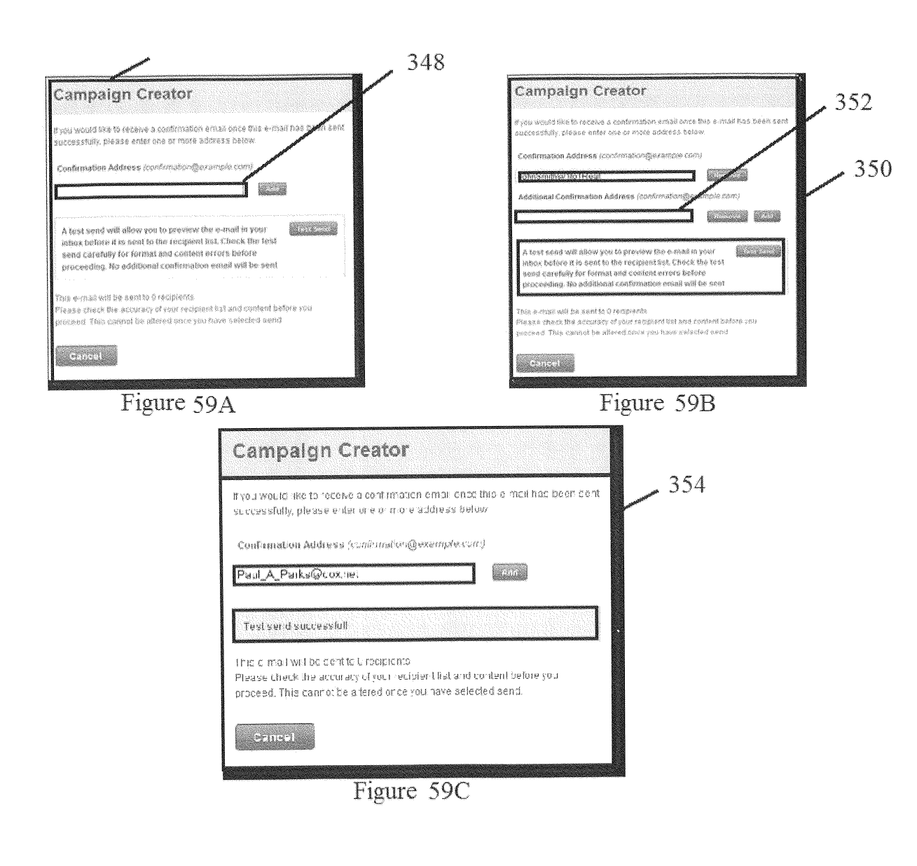

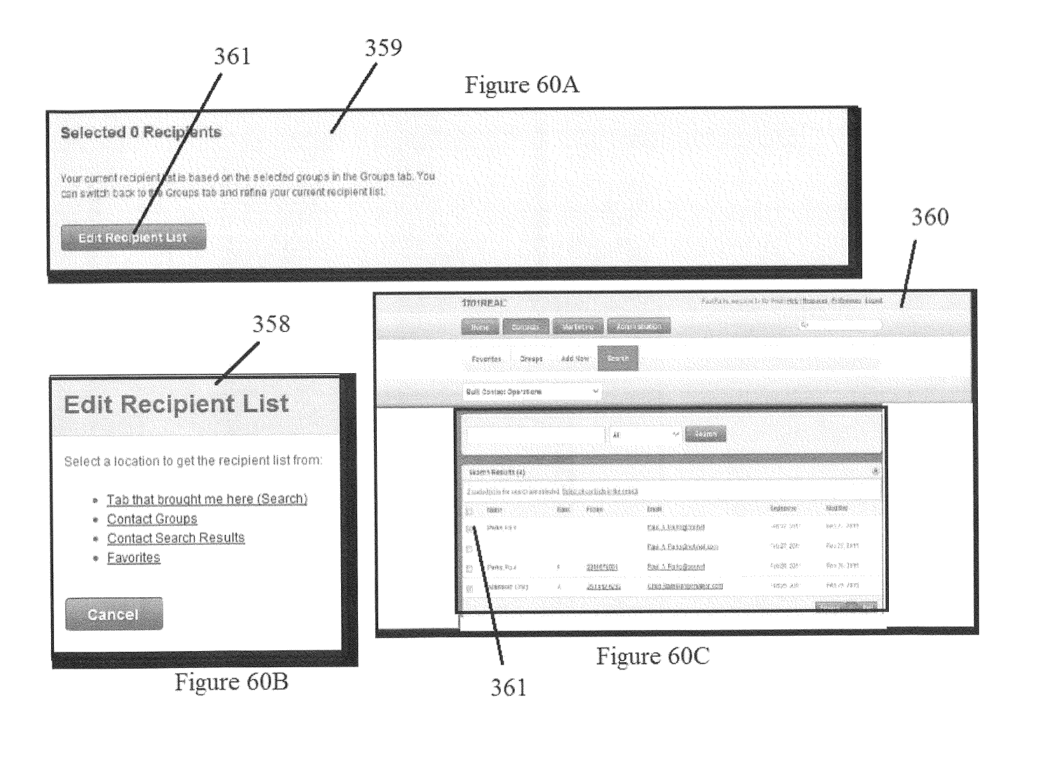

Referring to FIGS. 59A to 59C a relevant Email Addresses in to the Confirmation Address text field 348. Referring to FIG. 59B once the first Email Address is added an additional Confirmation Address text field 352 on screen 350 will be displayed permitting the user to add as many address as required or delete address that are not required. Referring to FIG. 59C FIG. 354 a test message can be sent to the Recipient list to ensure that the list is correct and does not contain errors. Referring to FIG. 60A window 359 the recipient list can be edited using button 361. In window 358 FIG. 60B contacts can be selected to include as recipients. Referring to FIG. 60C a selection of one of the links in the edit recipient list 358 displays the edit recipient in window 360 and permits editing of the recipient list by checking check boxes 361.

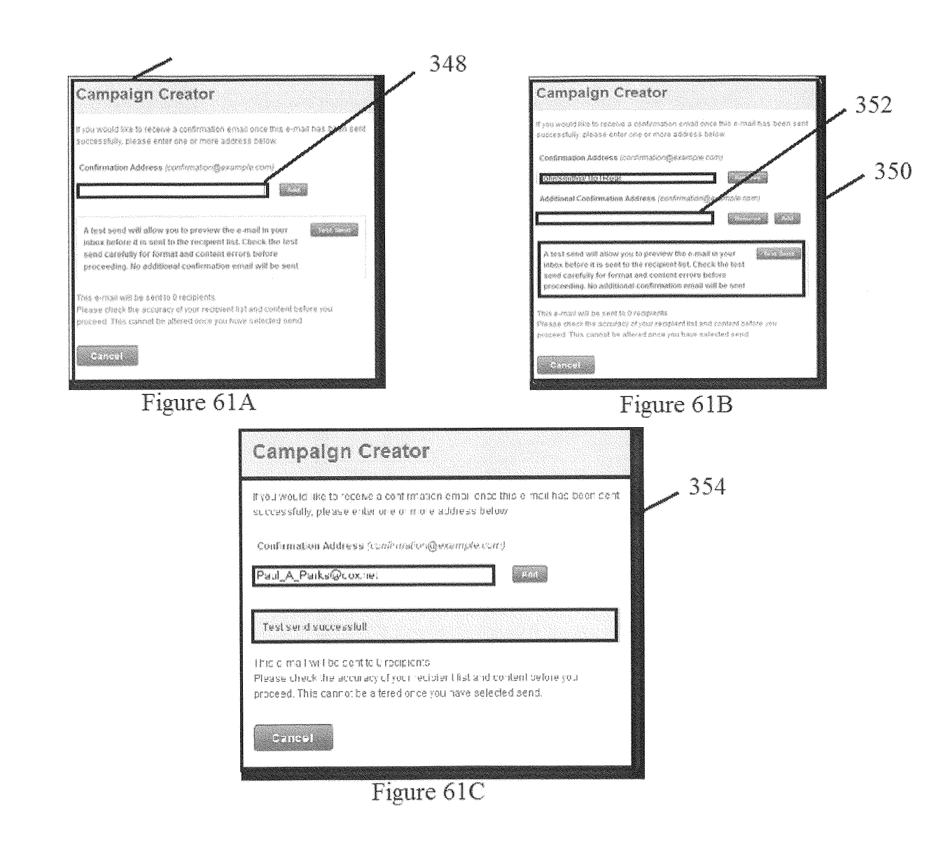

Referring to FIGS. 61A and 61C at screen 362 selecting the tab campaign creator from the bulk contact operations list permits the inclusion of those contacts as the recipients of the campaign e-mail. It is also possible to delete a campaign template as shown in FIGS. 61B screen 364.

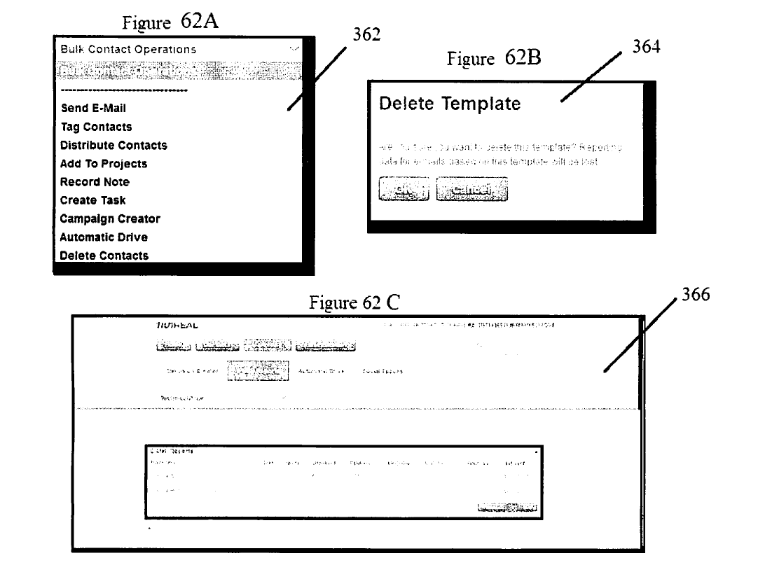

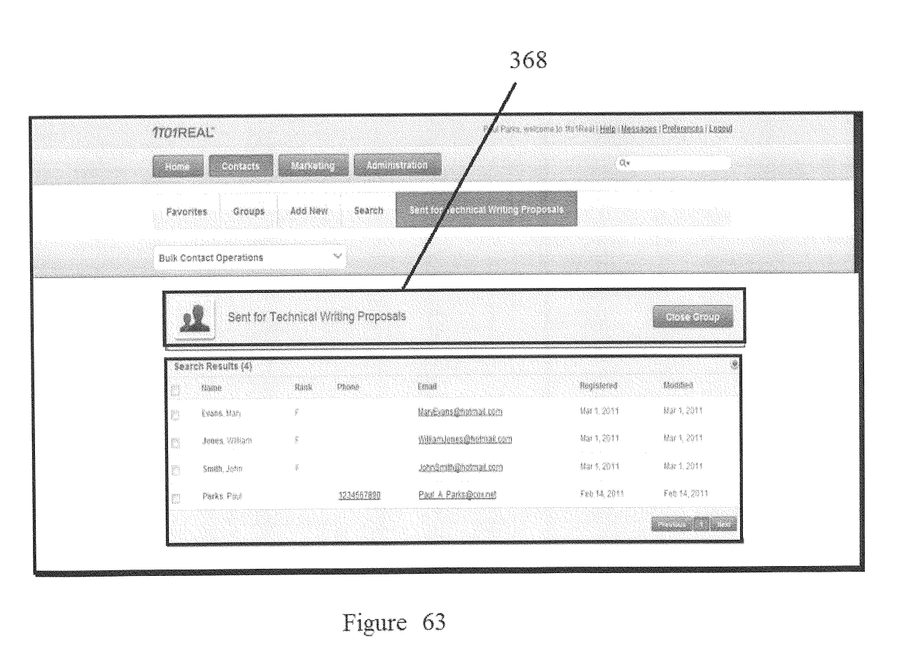

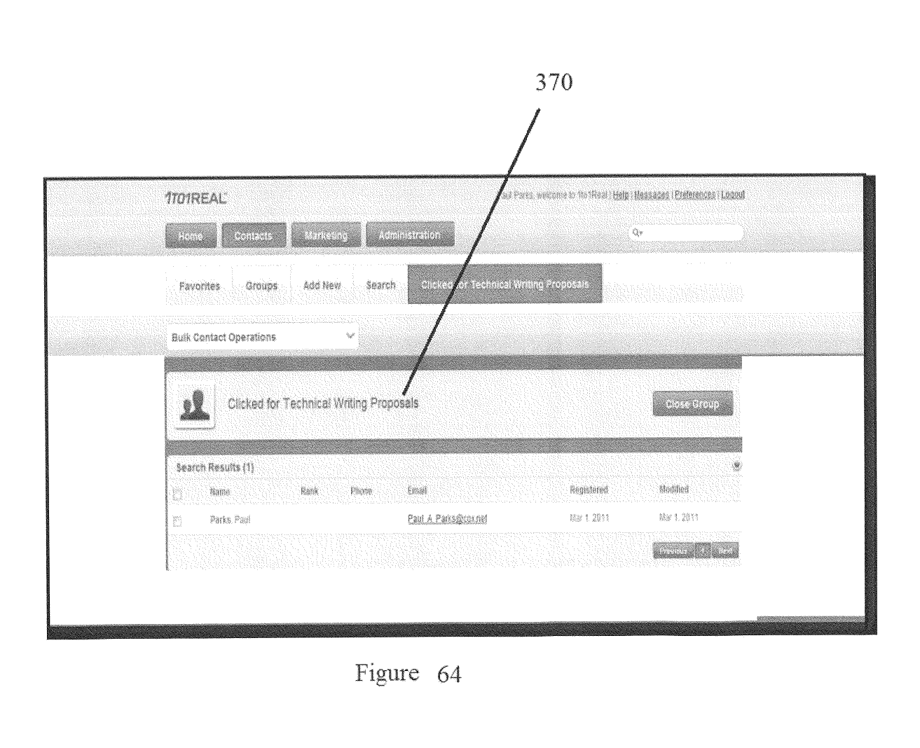

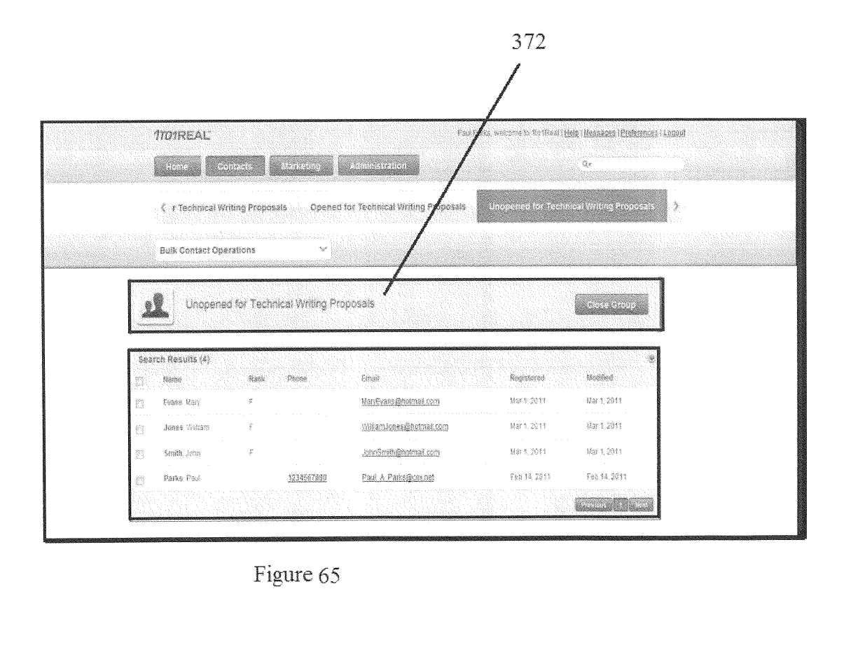

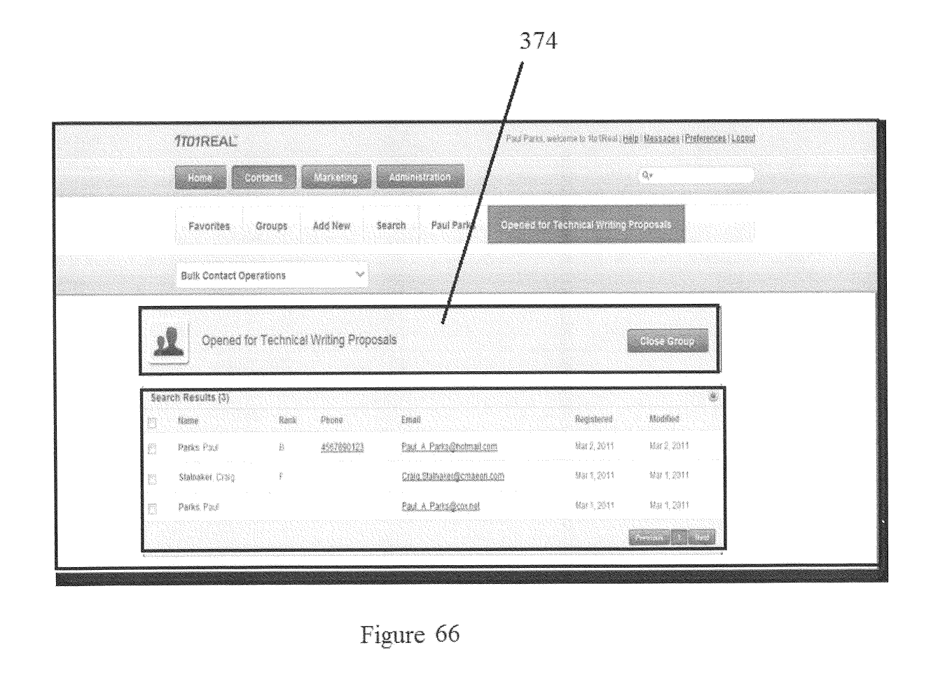

Referring to FIGS. 62 screen 366 e-mail reports allow the user to track the performance of the mass conversation e-mail by critical areas such as number of opens, click-thrus and yet to be opened e-mails. In FIG. 63 screen 368 there is shown a sent list listing the e-mails sent out for the campaign. FIG. 64 screen 370 shows the number of e-mails that were clicked and FIG. 65 screen 372 shows the number of e-mails that were unopened and FIG. 66 screen 374 shows the number of e-mails opened. Other windows show e-mails that were closed, clicked and bounced.

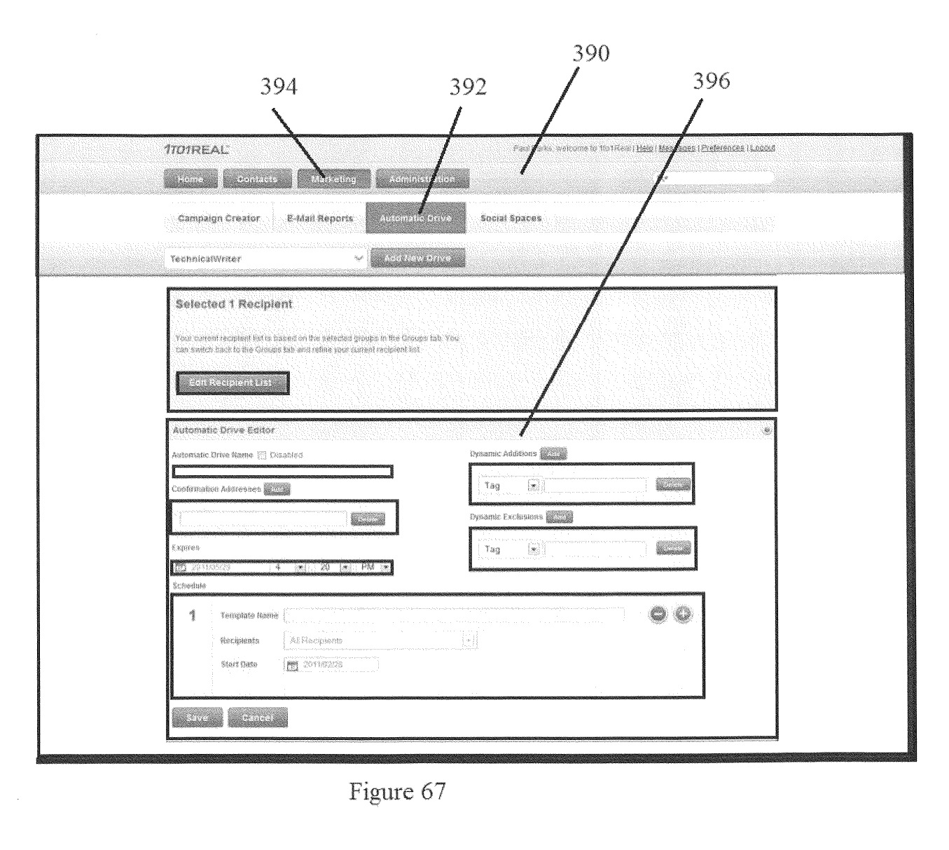

Referring now to FIG. 67 screen 390, selecting automatic drive 392 beneath marketing tab 394 displays the automatic drive editor 396. The automatic drive editor allows the user to create a mass e-mail that can be sent to as many or as few contacts as desired based on specifications for a campaign. When the user creates the campaign she also creates and sets parameters for automated follow-up e-mails according to what have proven to be the most important criteria in the campaign.

Social Spaces

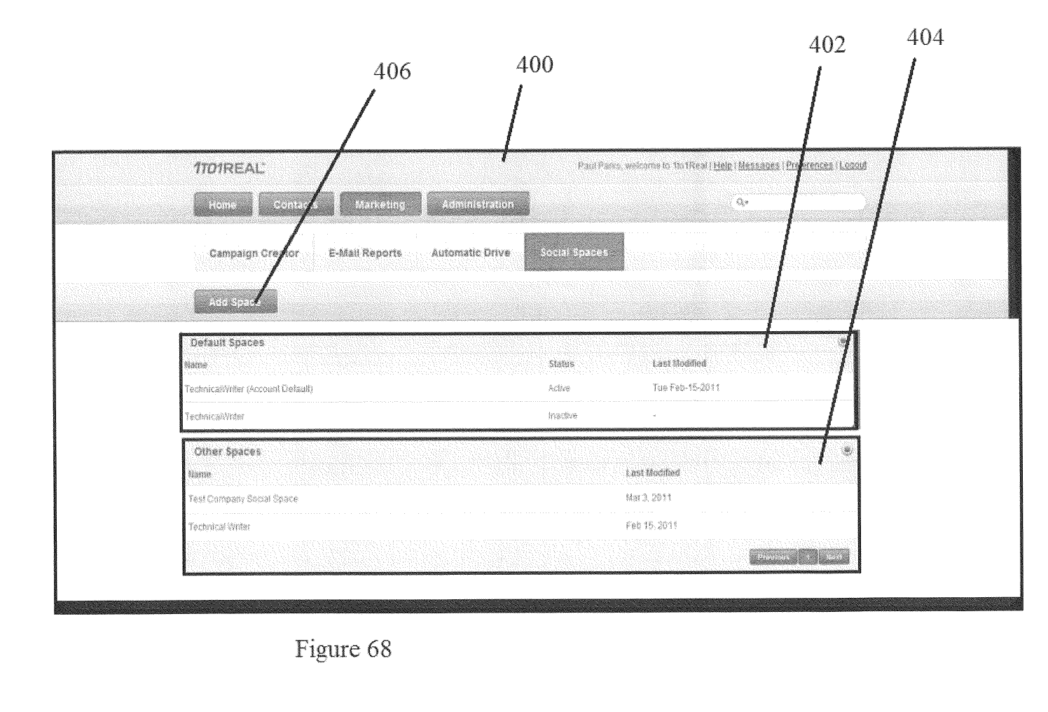

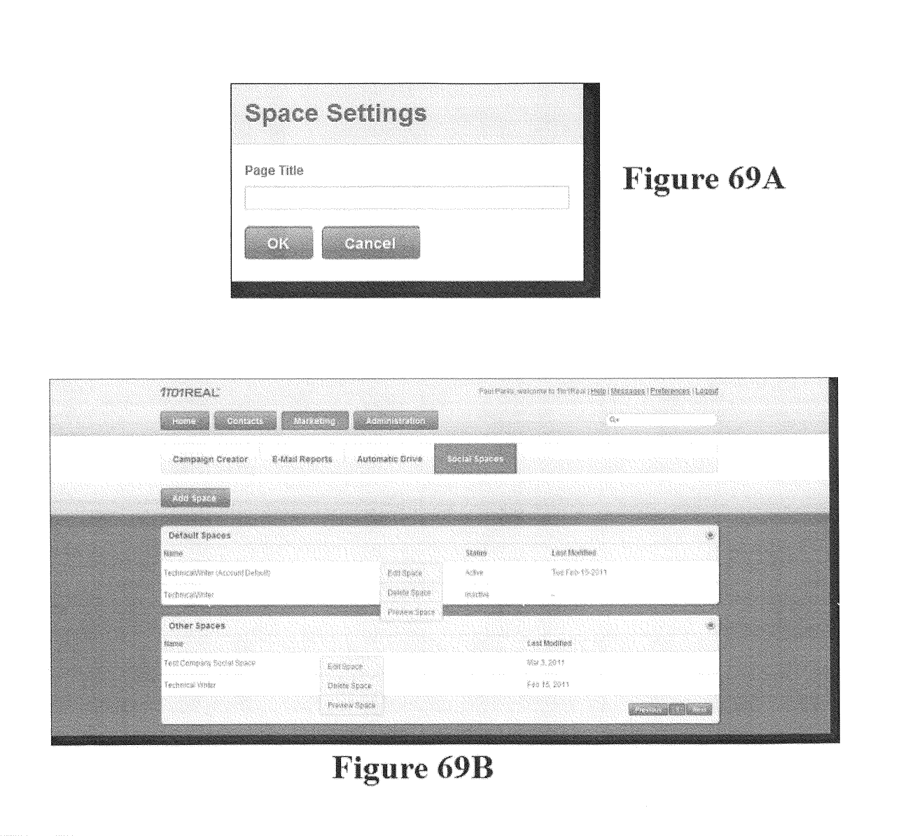

Referring to FIG. 68 screen 400 selecting the Social Spaces screen 402 for editing purposes with its name. status and last modified date information the Other Spaces portion of the screen 404 displays any other social spaces that the user creates within the system. Selecting add space 406 on the Social Spaces screen 400 displays space settings 408 in FIG. 69B. This is used to add additional Social Spaces. A relevant title can be added into the page title text field 410 and by clicking okay a new social space is created 412.

Configuring a Social Space

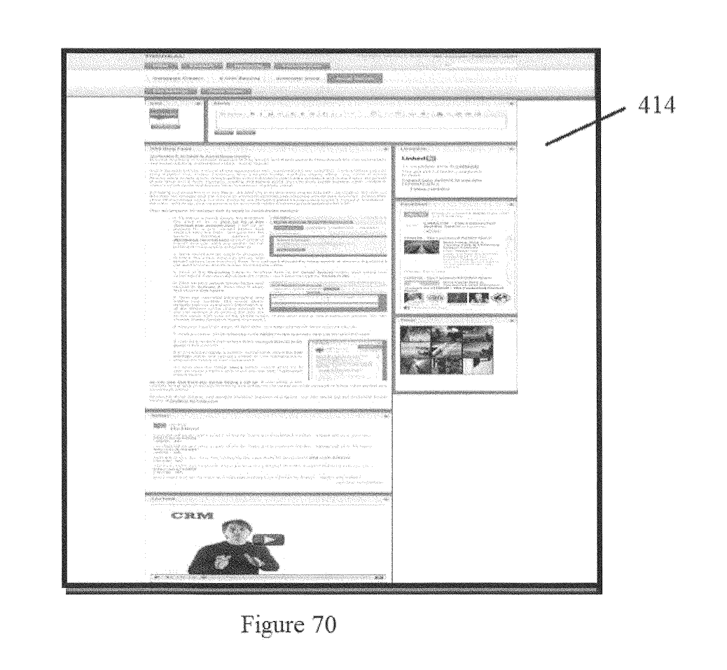

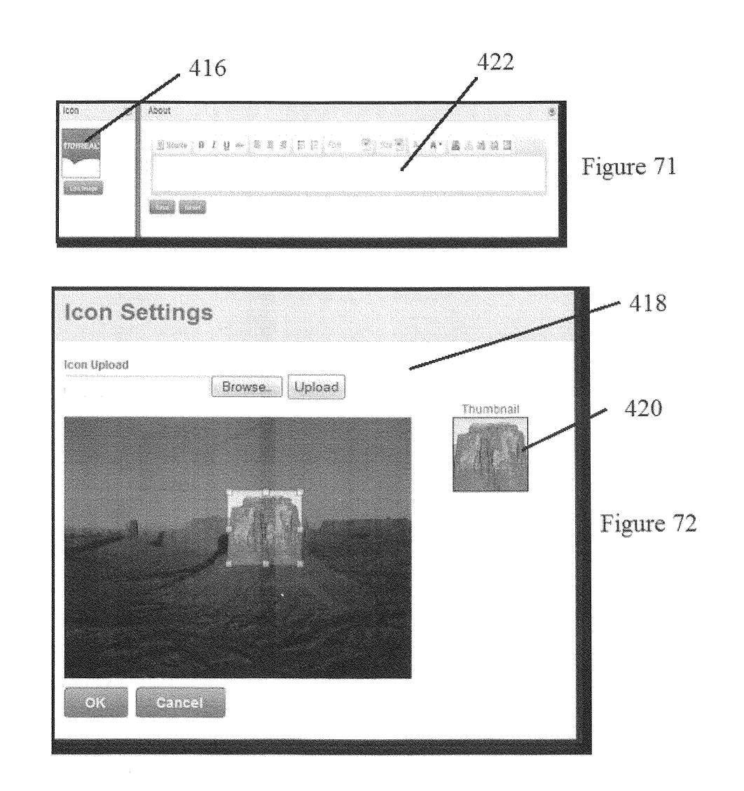

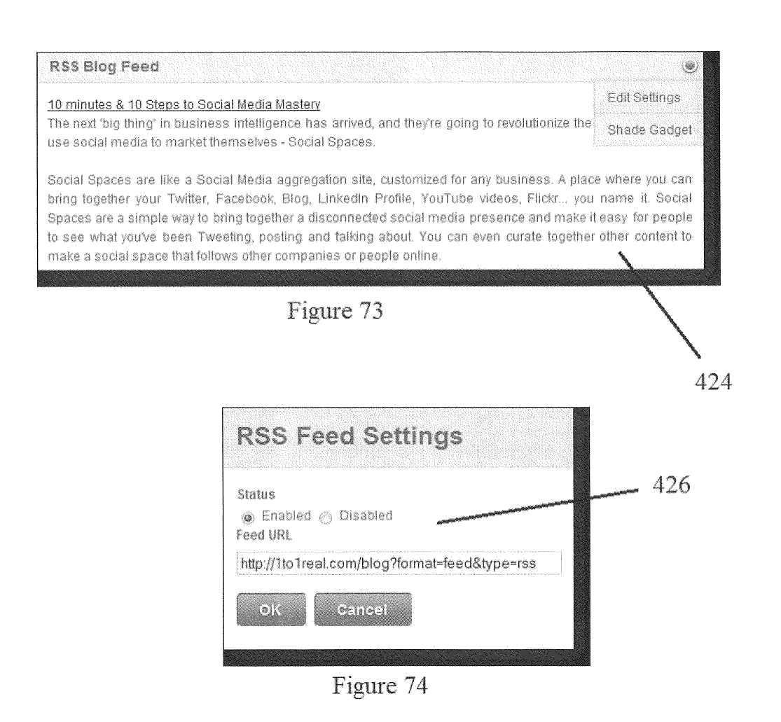

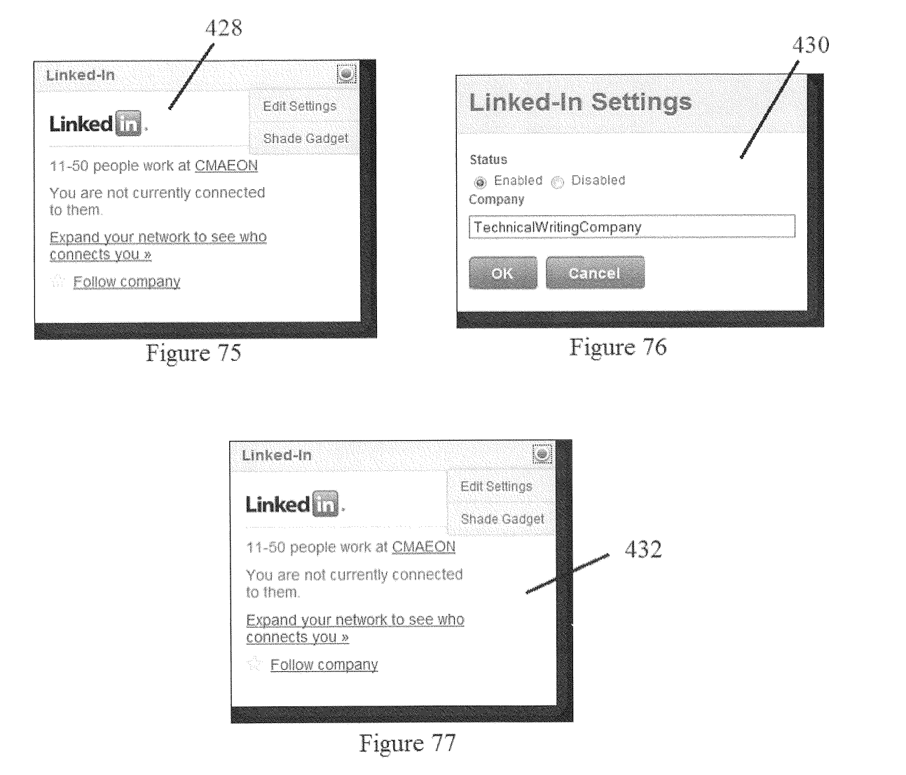

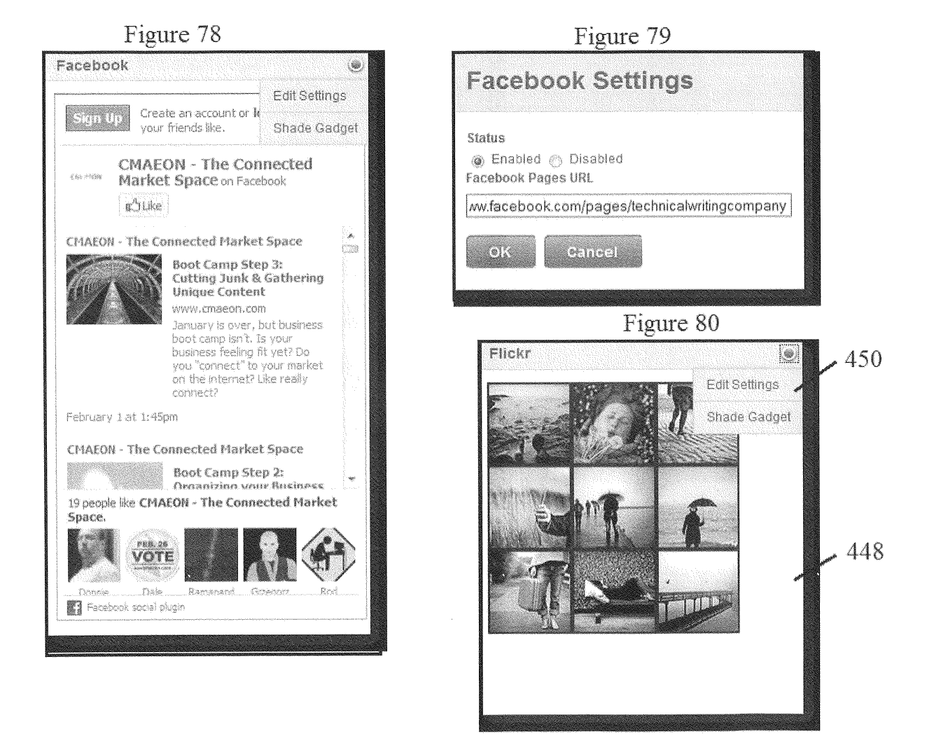

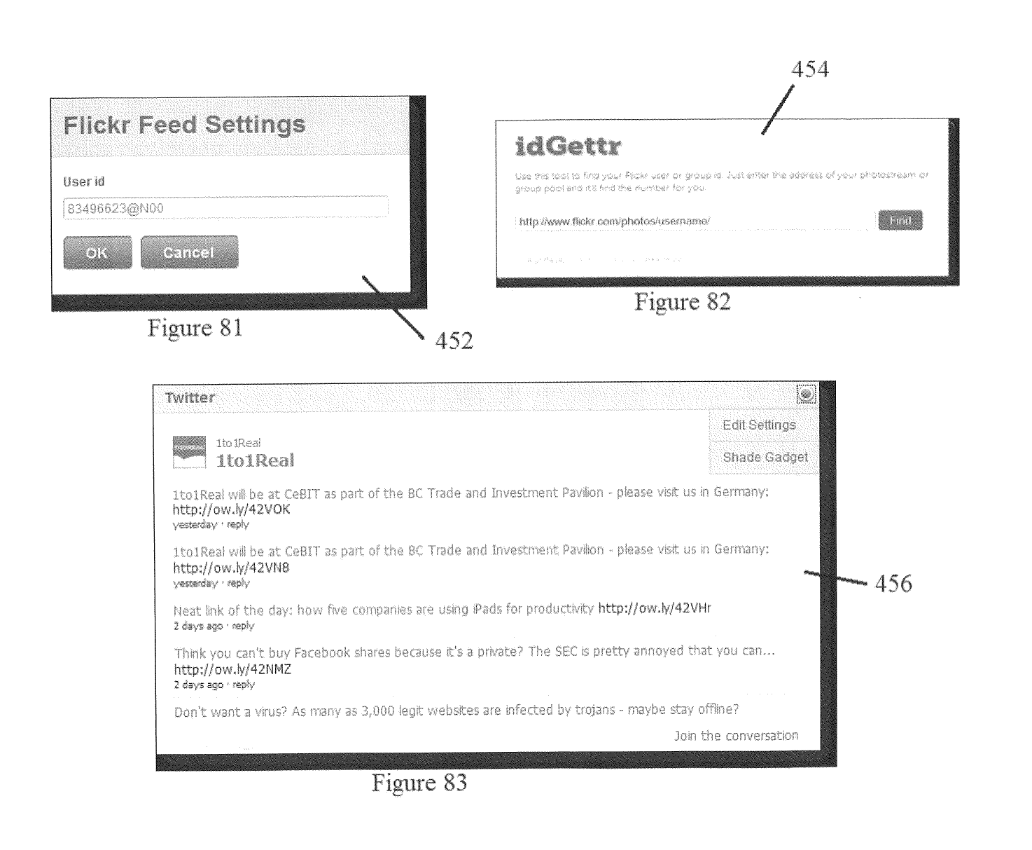

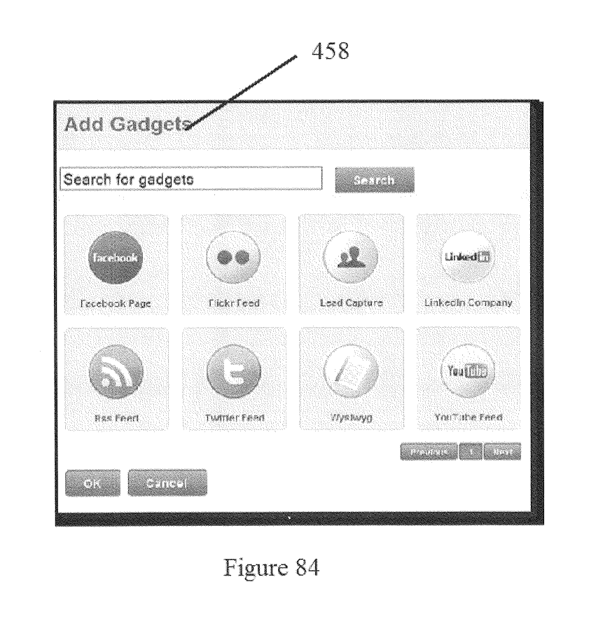

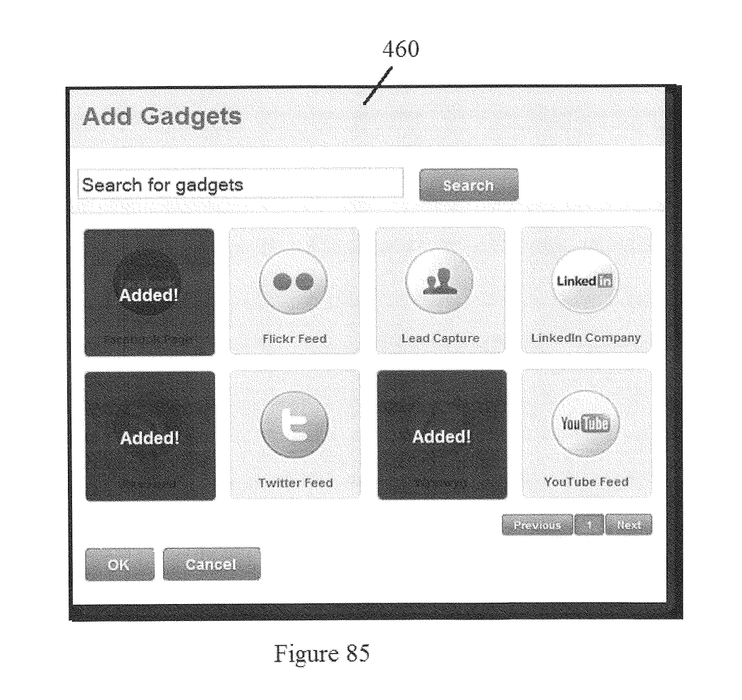

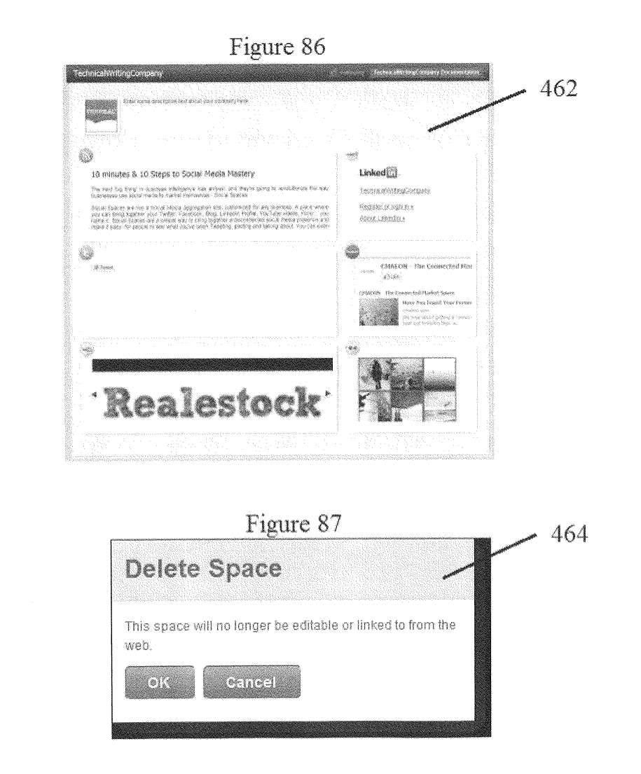

Referring to FIG. 70 screen 414 there is illustrated the various components of a social space which are available for editing. In FIG. 71 screen 416 the icon portion of this screen can be edited by adding a corporate logo. An image can be located on the computer as shown in FIG. 72 screen 418 and uploaded into a thumbnail box 420. In FIG. 71 text can be uploaded into a text field 422 pertaining to the company. In FIG. 73 screen 424 the RSS™ Feed settings dialogue is displayed for modifications. In FIG. 74 screen 426 RSS™ Feed settings can be enabled, edited or disabled. Referring to FIG. 75 screen 428 and FIG. 76 screen 430 the LinkedIn™ connection can also be enabled, disabled and edited. In FIG. 77 screen 432 the LinkedIn™ network can be expanded who will connect with your company. Referring to FIGS. 78 and 79 Facebook™ settings can be enabled, disabled and edited. Referring to FIG. 80 item 448 Flickr™ settings can be edited 450 which will take the user to FIG. 81 screen 452 where the Flickr™ account can be added or deleted. In FIG. 82 screen 454 the idGettr™ link can be added. In FIG. 83 screen 456 Twitter™ accounts can be added and amended. In a similar fashion YouTube® accounts can be added and edited. Referring to FIG. 84 gadgets can be added to a social space by selecting the add gadgets screen 458. The add gadgets screen illustrates a list of gadgets which are subsequently added to the social space and marked as added as shown in FIG. 85 screen 460. Referring to FIG. 86 screen 462 the created social space can be previewed and in FIG. 87 screen 464 a social space can be removed from the system.

Administration

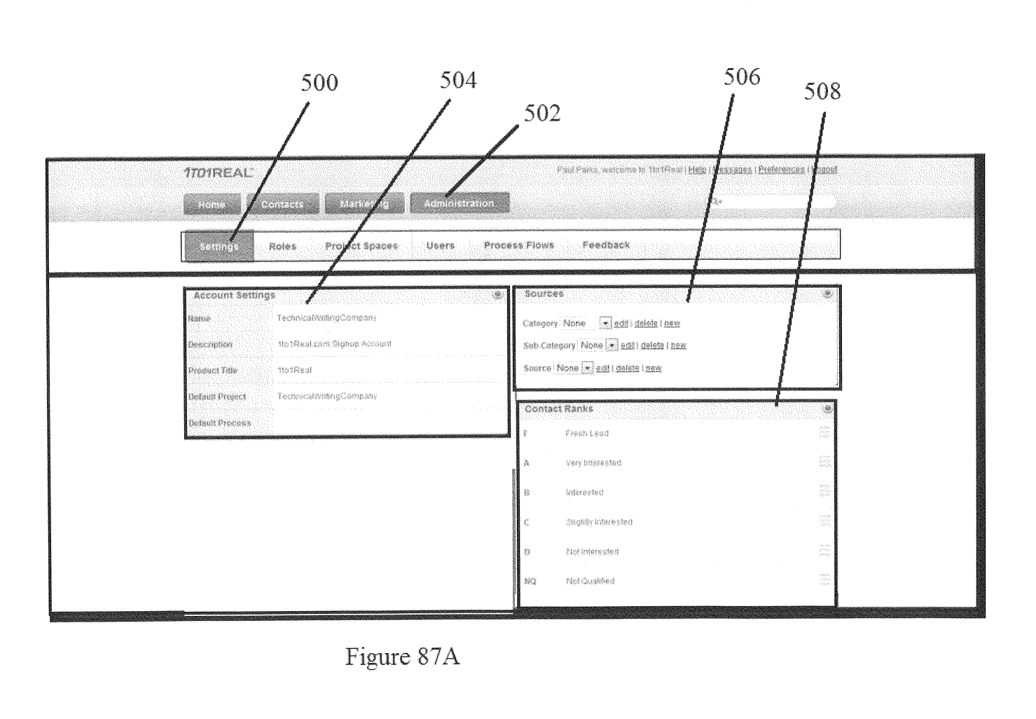

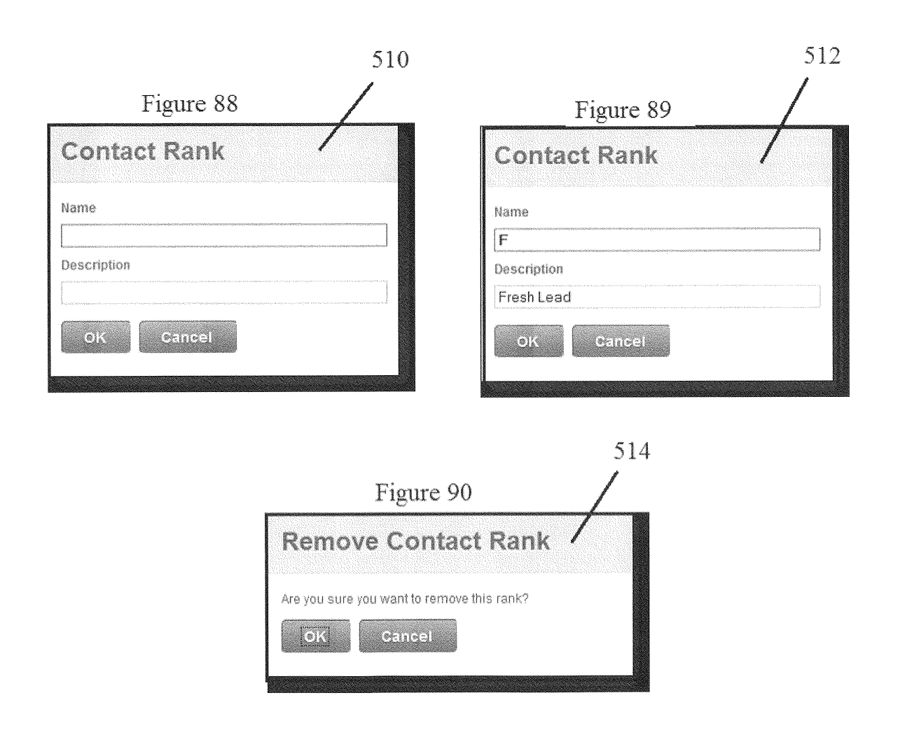

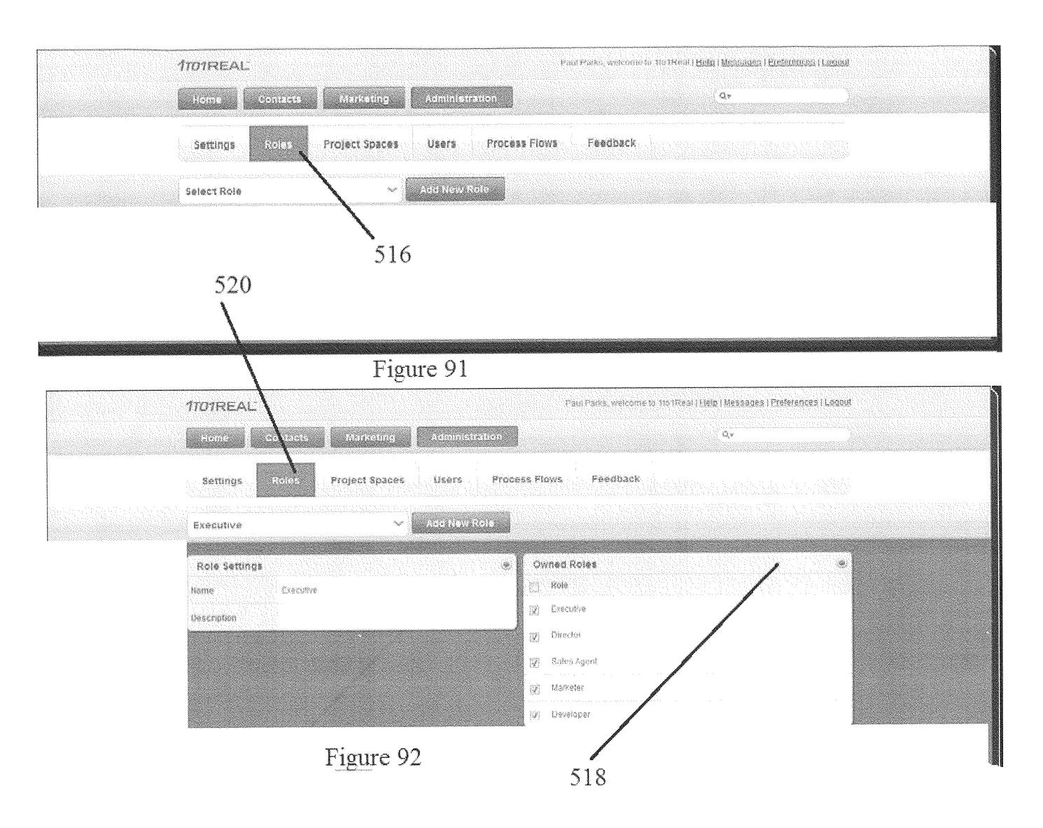

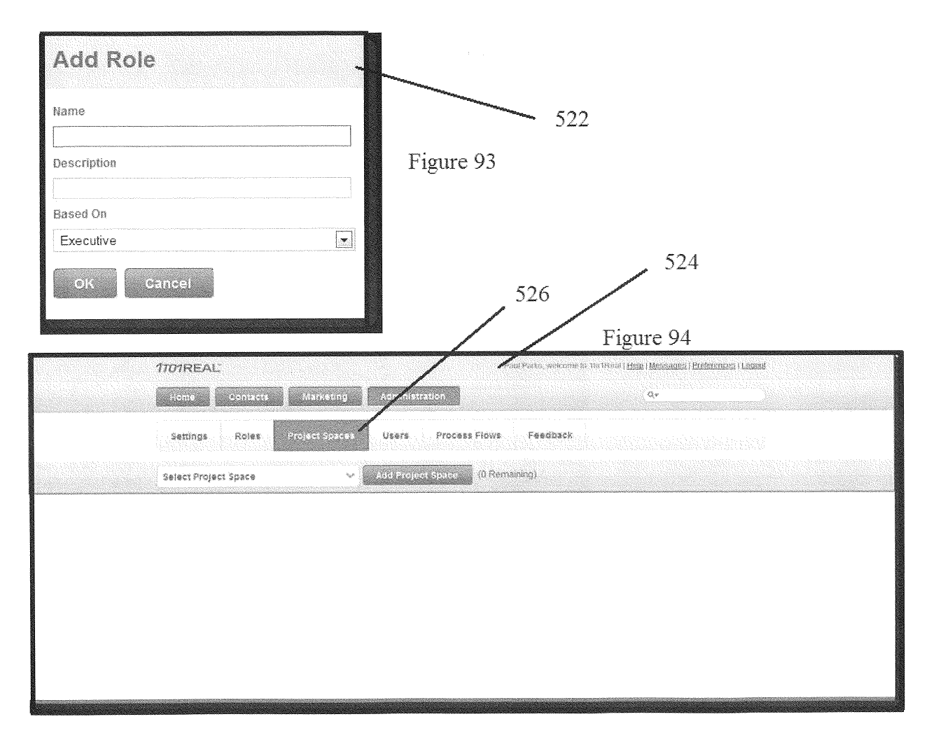

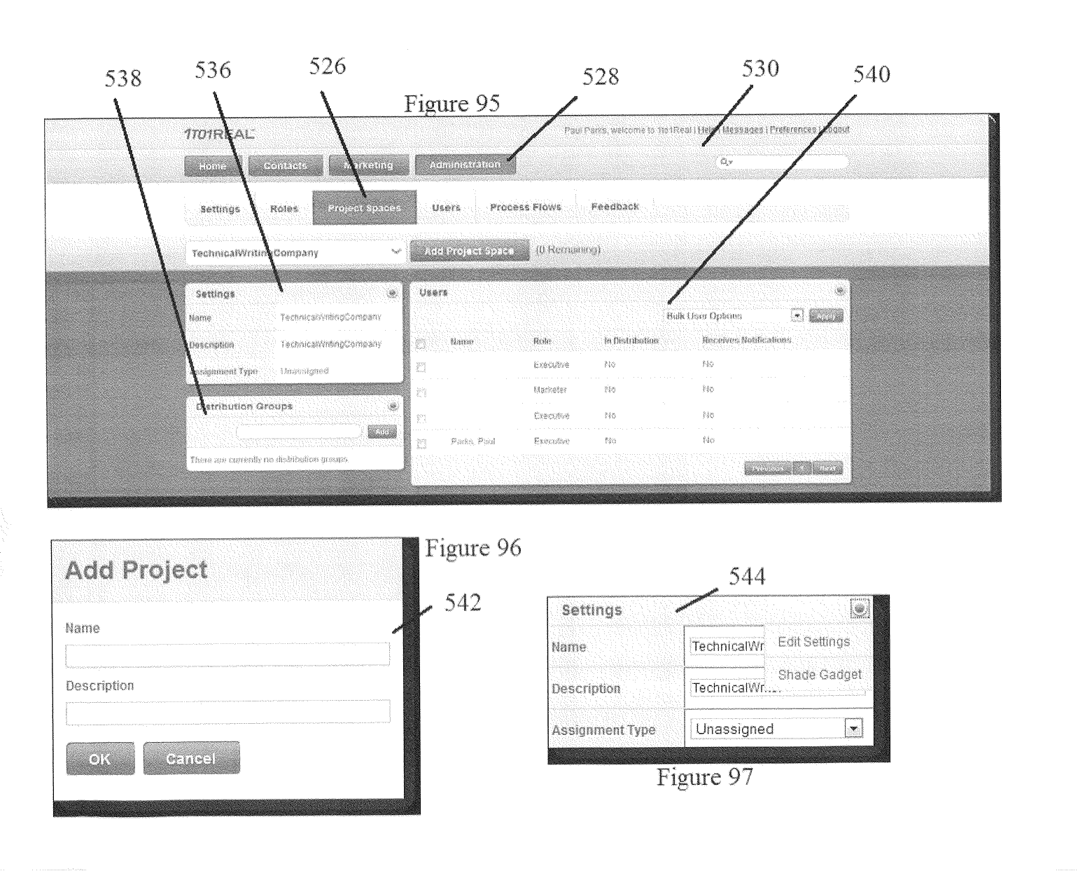

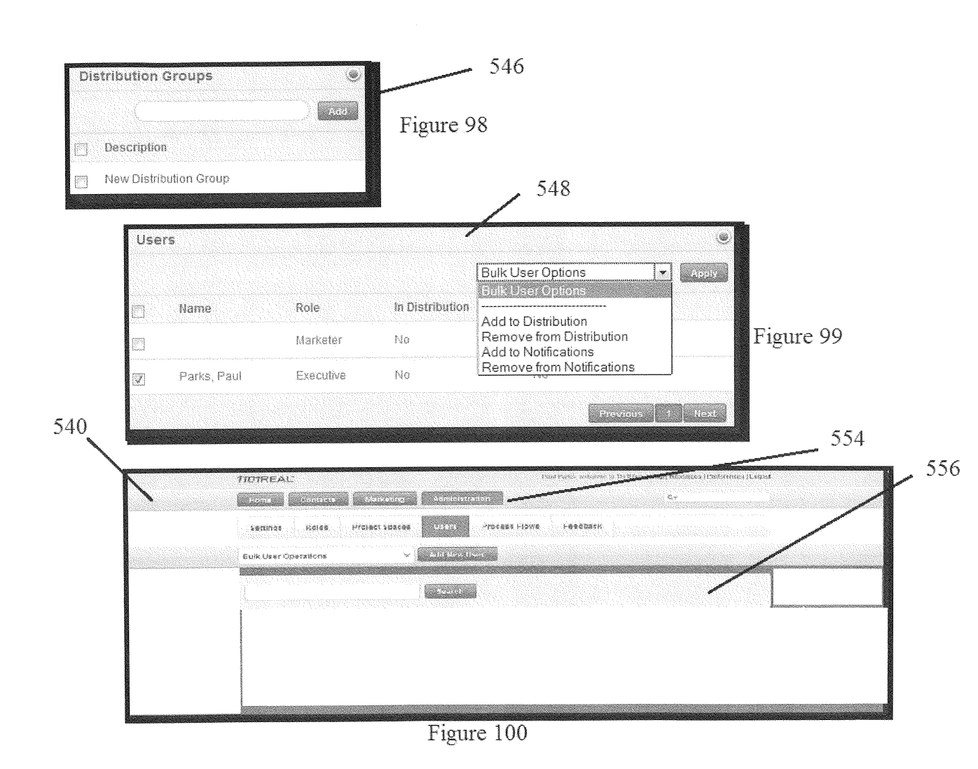

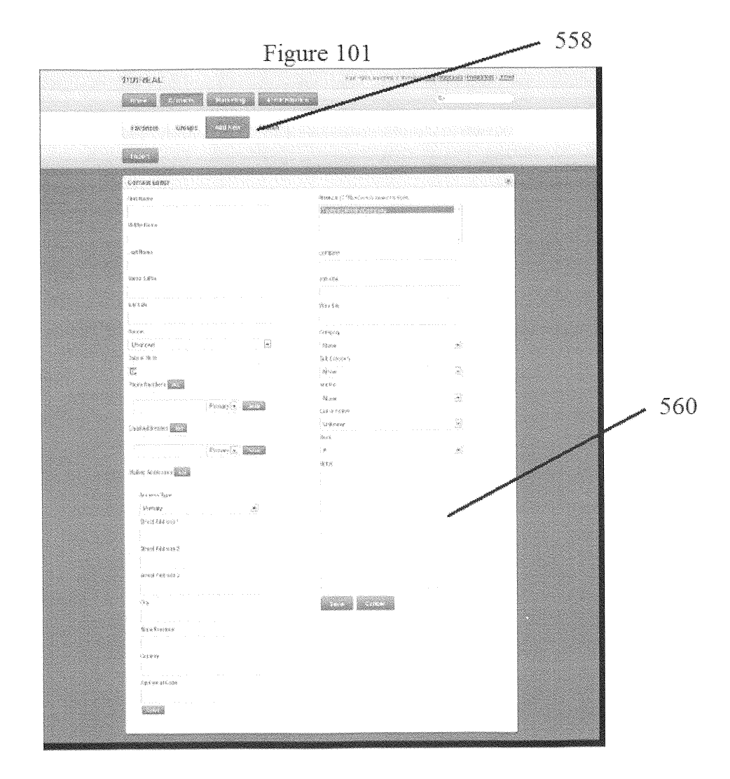

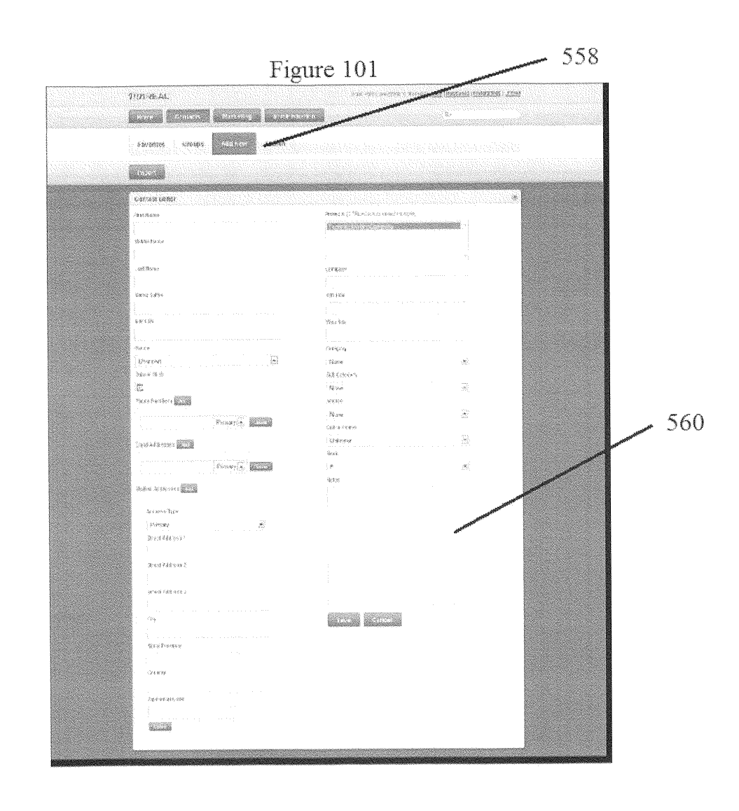

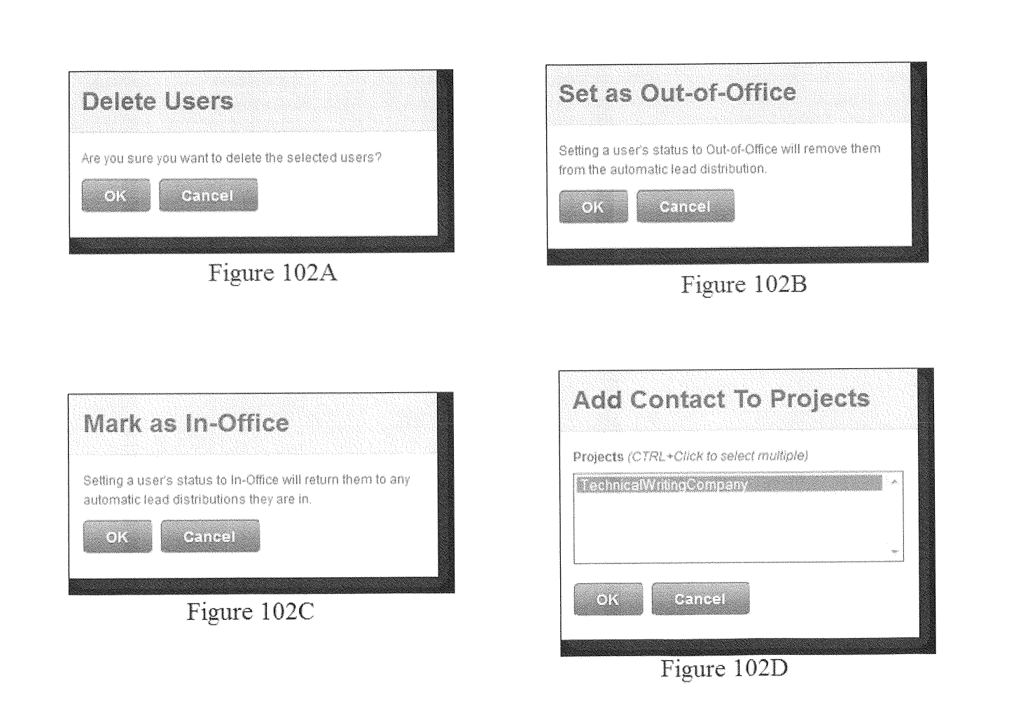

Referring to FIG. 87A selecting settings 500 beneath the administrative tab 502 displays all the basic information about the user customize connected market space. This includes account settings 504, contact sources 506 and contact ranks 508. In FIG. 88 contact ranks can be edited in window 510. In FIG. 89 window 512 the contact ranks can be edited and in FIG. 90 window 514 they can be deleted. Referring to FIG. 91 the roles gadget 516 permits the user to select roles or add roles such as the executive director, CEO or sales agent. This is illustrated in FIG. 92 window 518. Roles can be added by clicking on button 520 and using screen 522 shown in FIG. 93. Referring to FIG. 94 and screen 524 selecting project spaces 526 beneath the administration tab 528 displays the project spaces screen 530. Referring to FIG. 94 selecting a project space 534 on the select project spaces list displays the settings 536 distribution groups 538 and users 540. In FIGS. 95, 96 and 97 project spaces can be added at screen 542 edited at screen 544. A distribution group can be added to a project space at FIG. 98 screen 546. In FIG. 99 screen 548 bulk user options can be utilized. Referring to FIG. 100 screen 550 selecting users beneath the administration tab 554 displays a user screen 556 which allow the user to create and edit profiles, assign roles and add or delete users from the organization. It also permits the user to mark other users as in the office or out of the office. At FIG. 101 screen 558 new users can be added to the system in window 560. FIGS. 102A to 102D show a number of additional features such as deleting users, setting an out of office status, marking as in office, or adding users to project groups.

Process Flows

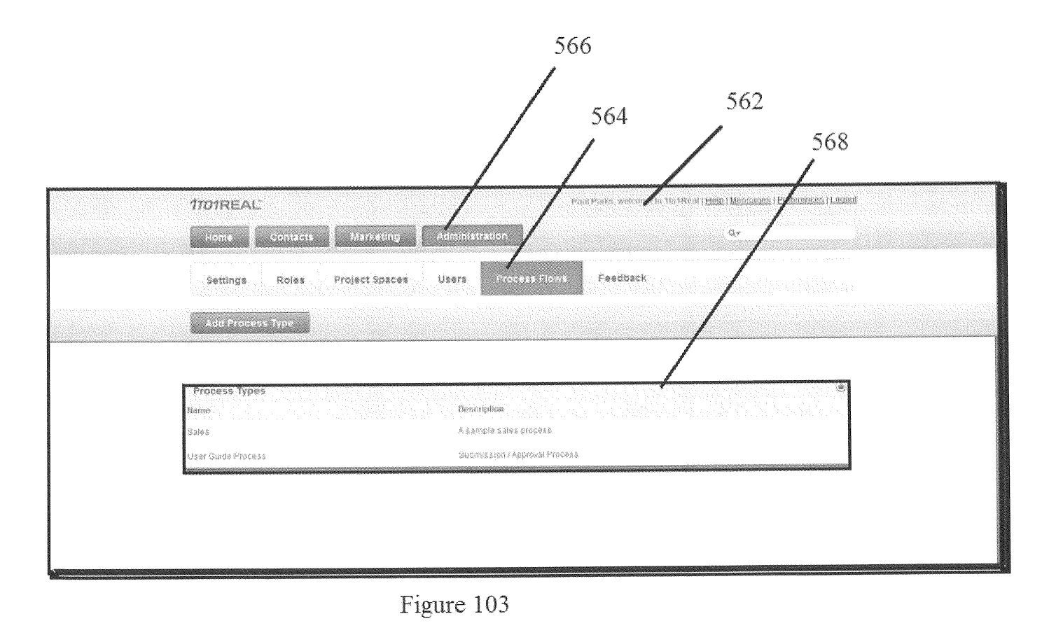

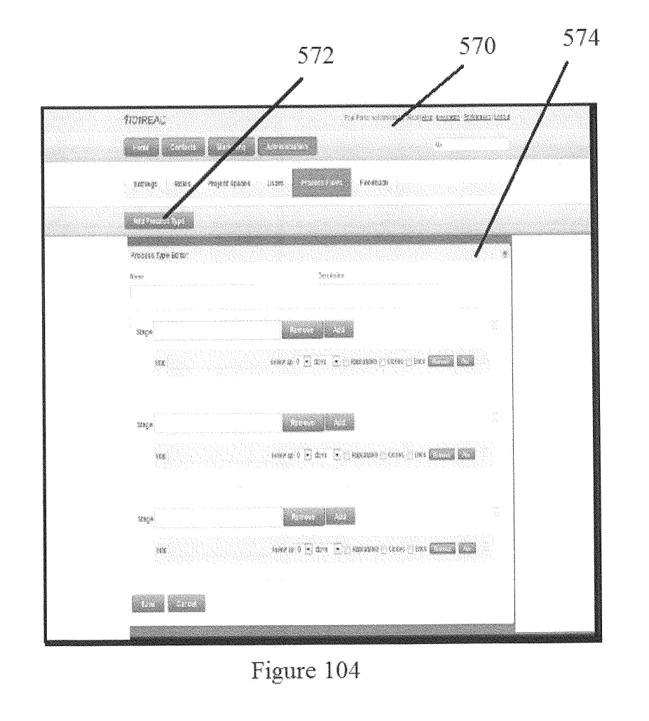

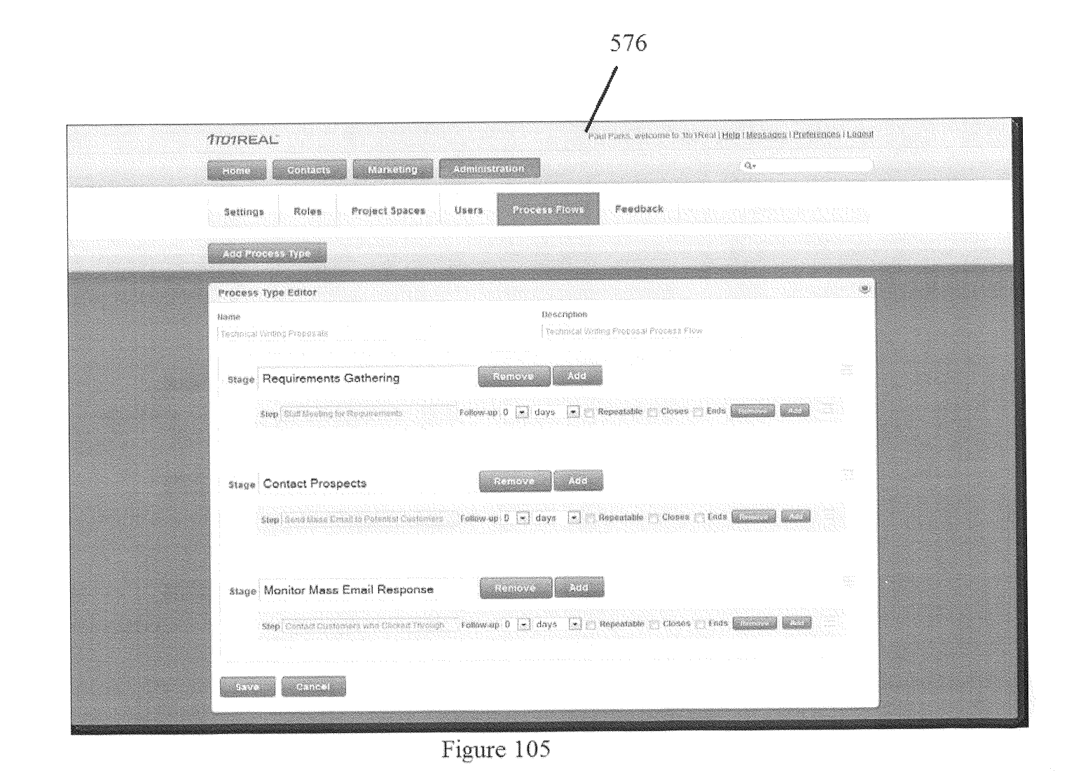

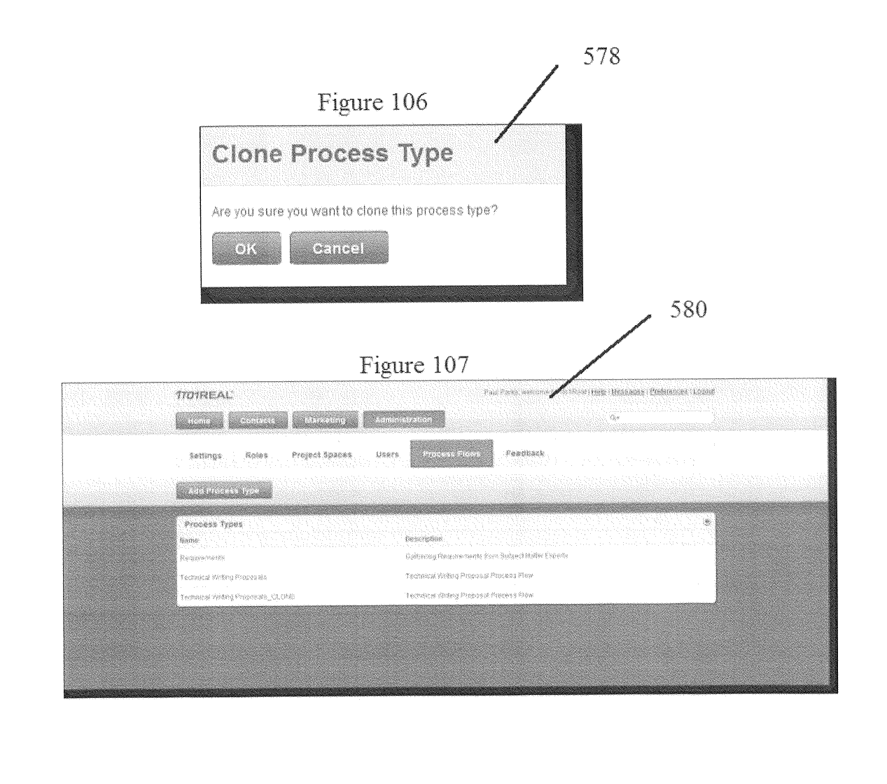

Referring to FIG. 103 screen 562 selecting process flows 564 from administrative tab 566 opens a process type screen 568. In this screen the user can create and maintain process types and find the various processes that are unique to the organization and the various departments within it. This will help the user to be more knowledgeable and coordinated in every facet of the business and it will also help the user to know exactly where everything stands in any department within the business. Referring to FIG. 104 screen 570 process types can be added 572 which display a process type editor screen 574. A new process can be entered within the screen by added a name and description. In FIG. 105 screen 576 a selected process type from the process types list can be edited. Referring to FIG. 106 screen 578 the user can create a process type that is similar to an existing process type by cloning it. In FIG. 107 screen 580 the cloned process type can be edited to make necessary modifications to satisfy the requirements of the new process.

Feedback

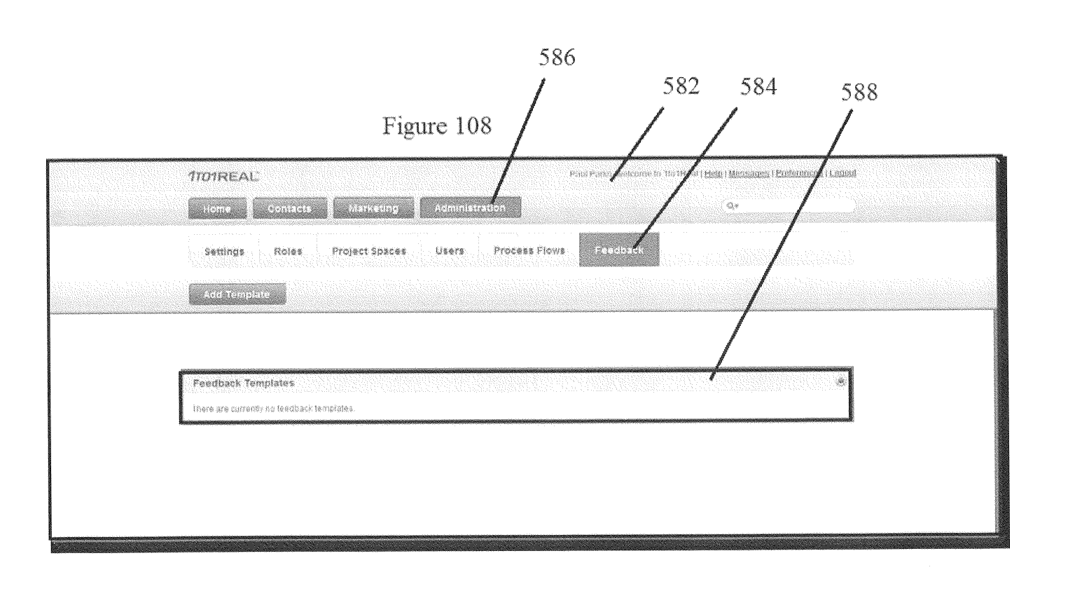

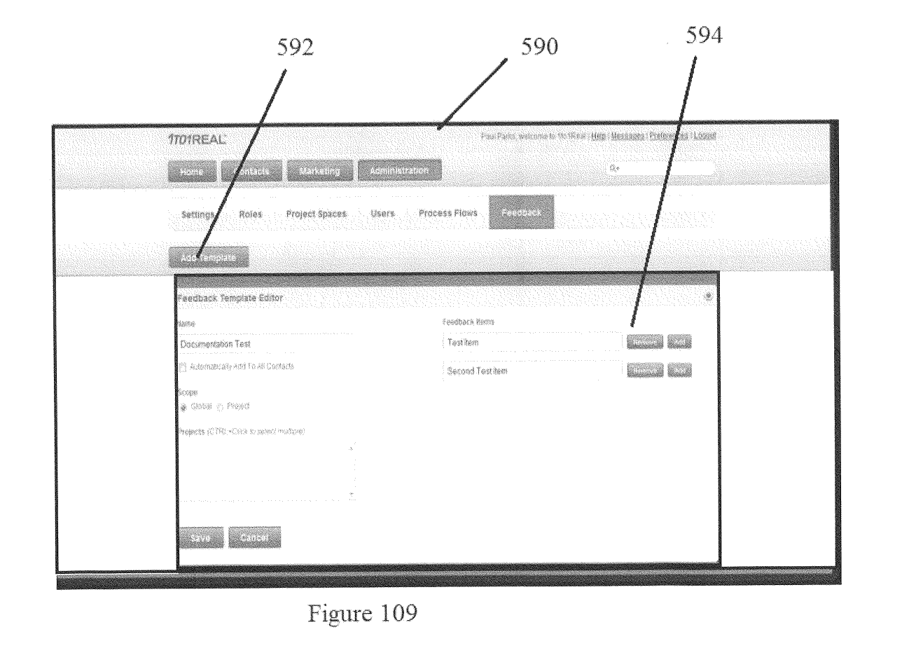

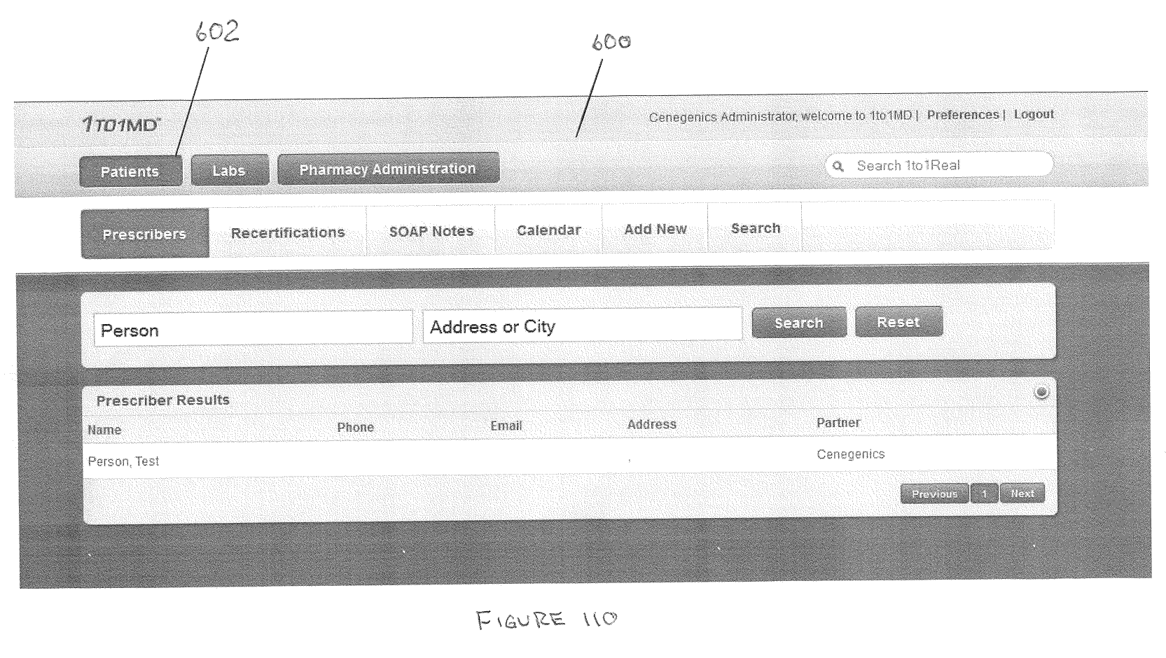

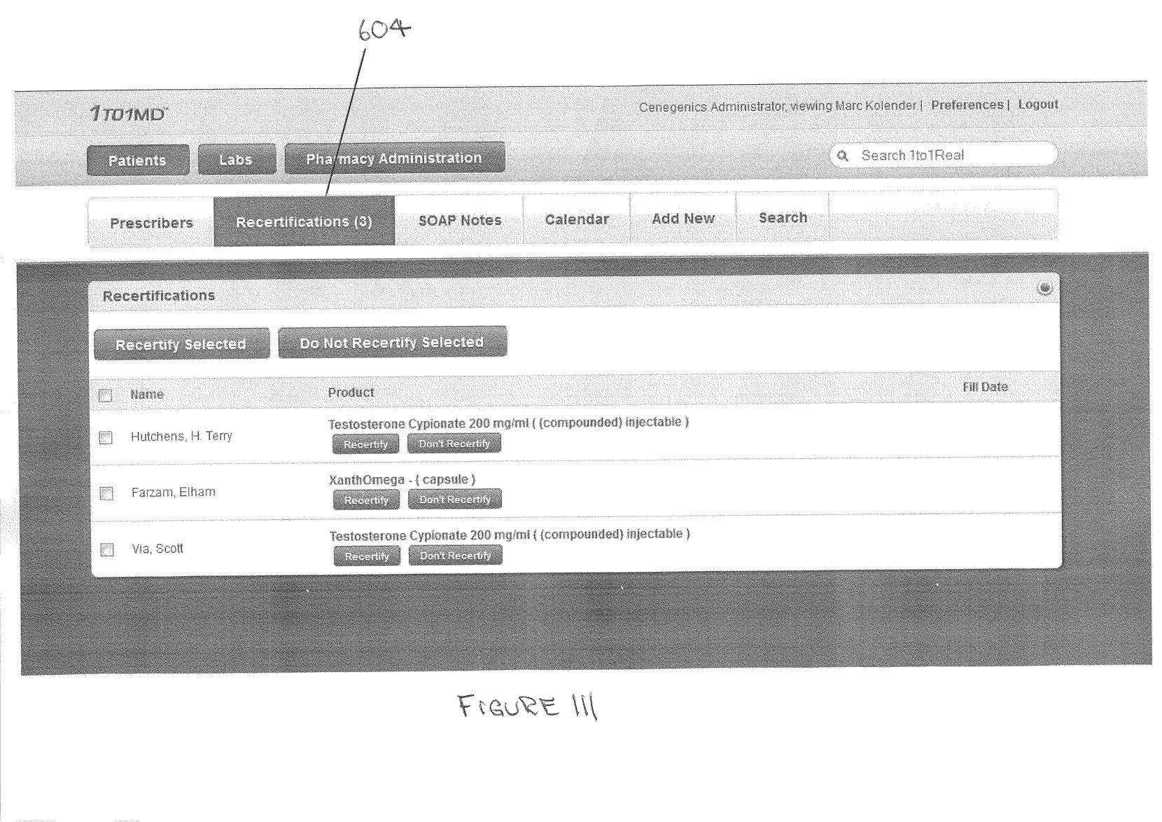

Referring to FIG. 108 and screen 582 selecting feedback 584 from the administrative button 586 displays the feedback template 588 permitting the creation of packages of new fields to specify any information the user wishes. These can then be applied to any contact in the database. Where this permits creation of a unique portrait of every contact and allows you to establish better connections with your clients. Referring to FIG. 109 and screen 590 by clicking add template 592 the screen at feedback template 594 is displayed permitting the addition of feedback templates to contacts.

Example: 1to1 MD™

One example of the invention is 1 to 1 MD which is a direct connection between the physician and the (compounding) pharmacy providing up to date formulary information, pricing (including shipping), and delivery reports. In this application a Hierarchical Partner System is established wherein medical office groups can share settings and behavior. A parent organization can provide settings for its child organizations. It is a practice management and patient relationship management system based on the platform previously described and allows a paperless way to manage patients.

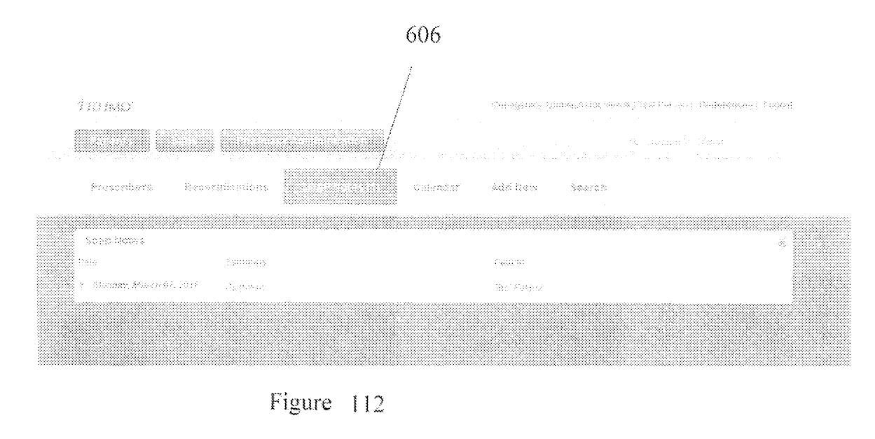

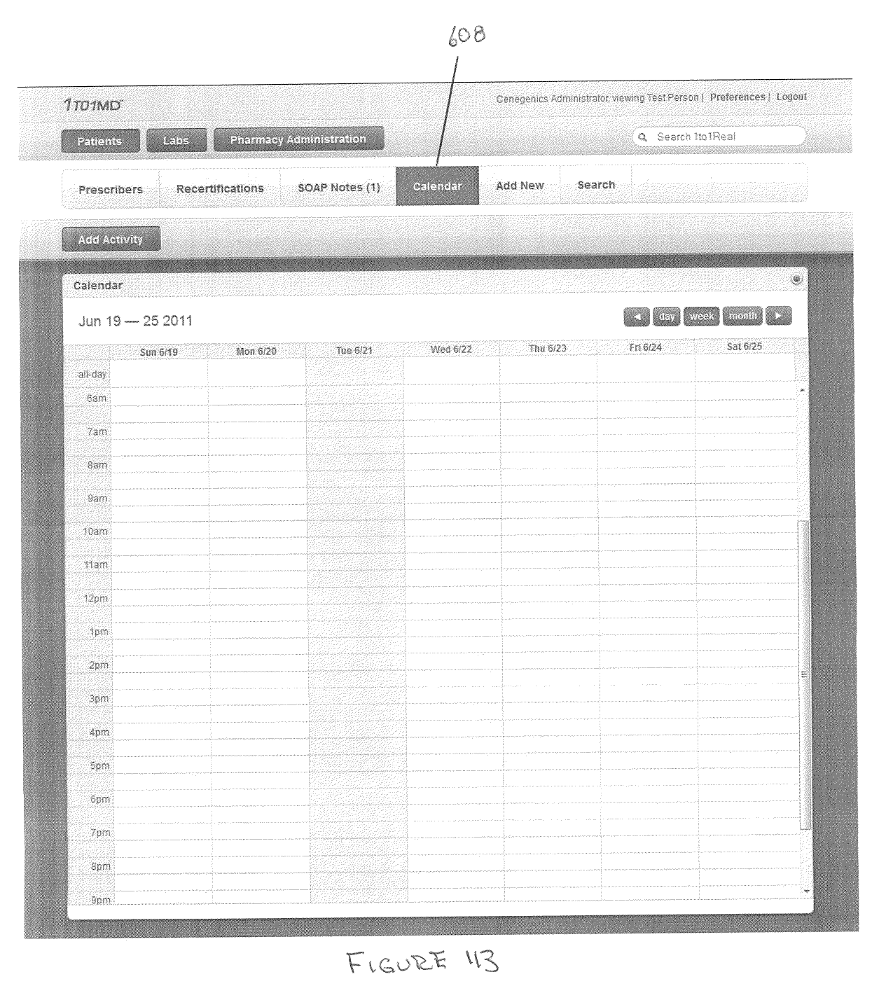

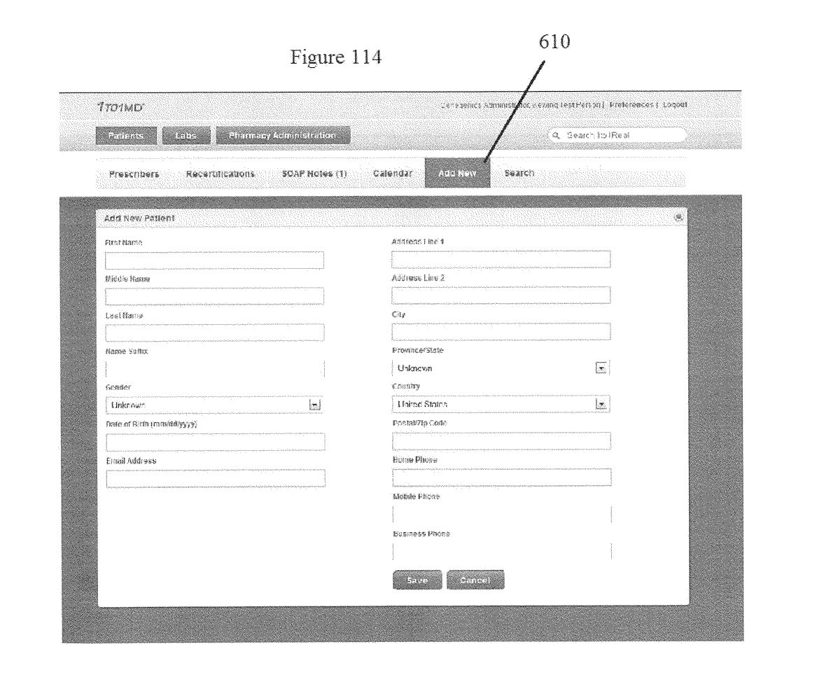

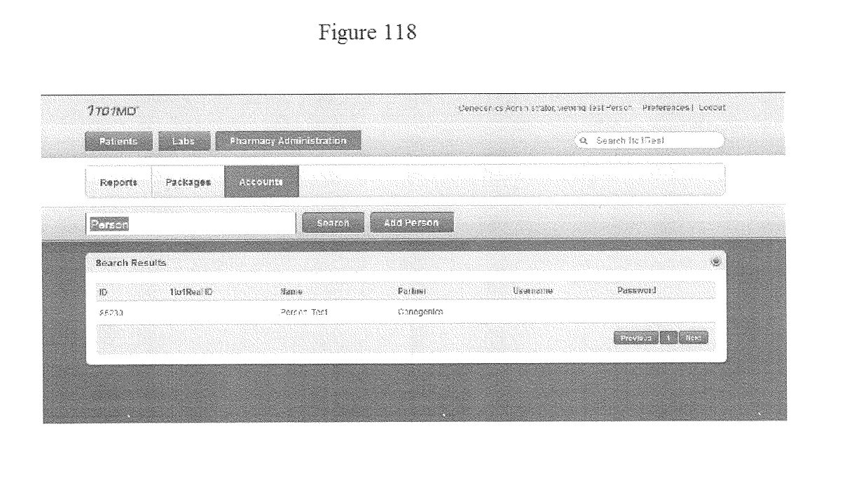

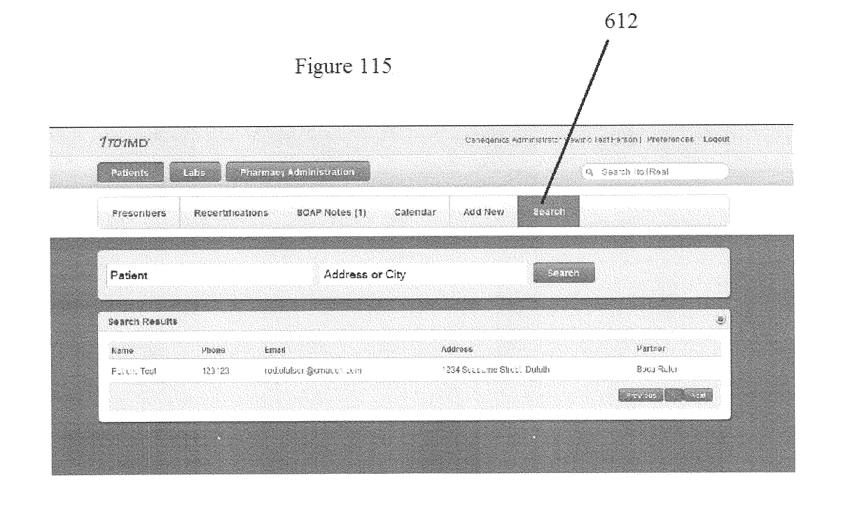

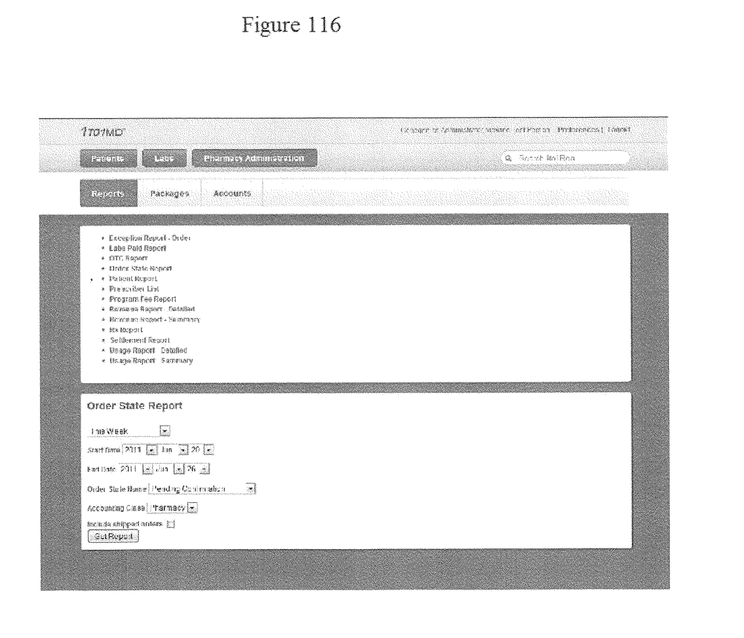

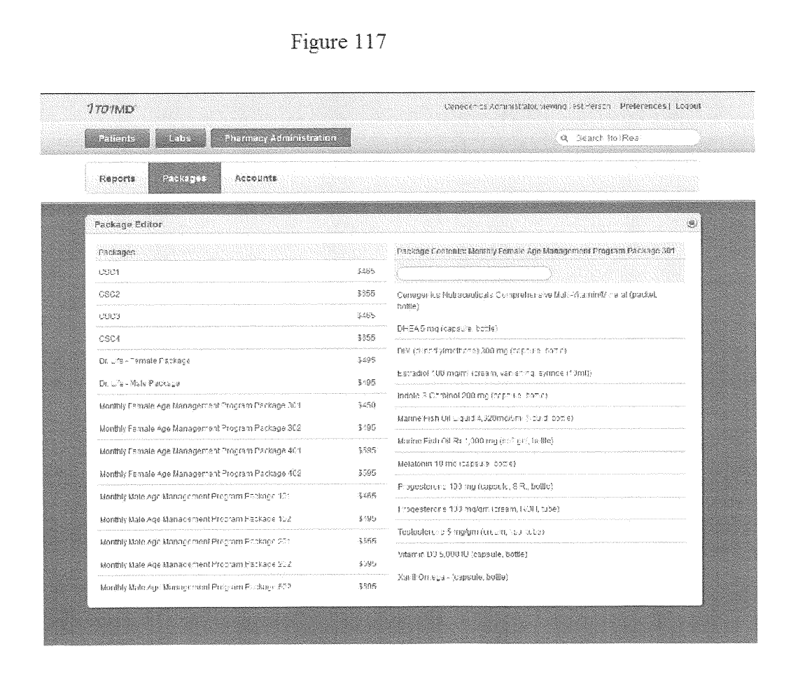

Following the dashboard configuration process described herein, the dashboard can be configured as shown in FIG. 110 screen 600. Under the patients tab 602 a patient/drug prescriber can be searched and located in the database. In FIG. 111, by clicking on the Recertifications Tab 604, the physician or pharmacy can see which patients need their medication prescriptions recertified or not. Referring to FIG. 112, the physician can add SOAP notes 606 (subjective, objective, assessment, and plan) to document practice workflow around a particular patient. In FIG. 113, screen 608, the physician can use the calendar to add patient appointments. The add new screen in FIG. 114 permits the physician to add new patients and the search screen in FIG. 115 permits the physician to search the patient database. FIGS. 116 to 118 show further attributes of the system wherein the physician can manage patient reports, patient prescription packages and patient accounts.

1) A computer implemented method for operating an Internet-based enterprise workflow and social marketing management system comprising a computer, a memory device communicating with said computer and a user interface having input fields, said method executable by a software program comprising a wizard program and a first plurality of user interface activities gadget programs wherein each user interface activities gadget program of said plurality of user interface activities gadget programs comprises a distinct application having a predefined functionality, the method comprising the following steps:
a) creating a plurality of enterprise data subsets comprising at least the following subsets: project spaces, internal and external connectivity tools, goals, achievements, organizational structures, personnel names, personnel roles, client contacts, supplier contacts, market sectors, goods produced, services produced, databases tools and social media marketing tools and storing said plurality of enterprise data subsets in said memory device;
b) identifying a set of enterprise work flow processes and storing said set of enterprise work flow processes in the memory device;
c) accessing the memory device for content by said wizard program and using the wizard program for guiding a user in creating said user interface;
d) using said first plurality of user interface activities gadget programs segmenting the user interface into a plurality of activity areas representative of the set of enterprise work flow processes;
e) associating a second plurality of user interface activities gadget programs with each of said plurality of activity areas; and,
f) using the wizard program customizing the user interface by inputting said content in said input fields.

2) The method of claim 1 wherein said plurality of activity areas comprise at least the following areas: marketing, social, daily activities, contacts, tag cloud and administration.

3) The method of claim 2 wherein a daily activity gadget program displays an editable daily activity list.

4) The method of claim 3 wherein a contacts gadget program displays an editable contacts list and wherein a tag cloud gadget program displays said editable contacts list by a predefined rank.

5) The method of claim 4 wherein said tag cloud gadget program further displays an editable list of search words associated with each contact on the editable contacts list so that clicking on a search word will display a list of contacts associated with said search word.

6) The method of claim 5 wherein a marketing gadget program displays a list of editable marketing campaign templates.

7) The method of claim 6 including creating a marketing campaign by selecting a desired marketing campaign template from said list of editable marketing campaign templates, adding a list of recipient e-mail addresses to a recipients data field within said desired marketing campaign template, populating the desired marketing campaign template with a plurality of marketing material, inserting at least one recipient response link into the marketing campaign template, forwarding said marketing campaign to said list of recipients and monitoring recipient response.

8) The method of claim 7 including generating a recipient e-mail response report comprising at least the following data: number and percent of e-mails sent, e-mails opened, e-mails unopened, e-mail address failures and recipient response links clicked.

9) The method of claim 8 including executing an automatic drive feature whereby the marketing campaign is sent to a list of recipients at a desired frequency over a desired period of time.

10) The method of claim 9 wherein a social gadget program displays an editable list of customizable social spaces.

11) The method of claim 10 wherein an administrative gadget program displays an editable list of account settings.

12) The method of claim 11 wherein a calendar gadget program displays a calendar.

13) The method of claim 12 wherein a files gadget program displays a list of files.

14) The method of claim 13 wherein a charts gadget program displays a list of viewable charts.

15) The method of claim 14 wherein a reports gadget program displays a list of available report formats.

16) The method of claim 15 wherein said contacts list is editable by favourites and groups.

17) The method of claim 16 wherein a campaign template selected from said list of editable campaign templates is linkable to a desired contacts list.

18) The method of claim 17 wherein said editable list of customizable social spaces includes Facebook, Flickr, Lead Capture, LinkedIn, RSS, Twitter, Wysiwyg and YouTube.

19) An computer implemented system for Internet-based enterprise workflow and social marketing management, said system comprising a computer connected to said Internet, a memory device and a user interface, wherein said memory device contains instructions comprising a wizard program and a first plurality of user interface gadget programs for commanding said computer to exercise a plurality of steps to create said user interface, including the following steps:
a) creating a plurality of enterprise data subsets comprising at least the following subsets: project spaces, internal and external connectivity tools, goals, achievements, organizational structures, personnel names, personnel roles, client contacts, supplier contacts, market sectors, goods produced, services produced, databases tools and social media marketing tools and storing said plurality of enterprise data subsets in the memory device;
b) identifying a set of enterprise work flow processes and storing said set of enterprise work flow processes in the memory device;
c) using said wizard program guiding a user in creating said user interface;
d) using said first plurality of user interface activities gadgets segmenting the user interface into a plurality of activity areas representative of the set of enterprise work flow processes;
e) associating a second plurality of user interface gadget programs with each of said plurality of activity areas; and,
f) using the wizard program customizing the user interface by inputting the plurality of enterprise data subsets.

20) A programmable storage medium tangibly embodying a program of machine-readable instructions executable by a digital processing apparatus to perform a computer implemented method for operating an Internet-based enterprise workflow and social marketing management system comprising a user interface having input fields, said program comprising a wizard program and a plurality of user interface activities gadget programs wherein each user interface activities gadget program of said plurality of user interface activities gadget programs comprises a distinct application having a predefined functionality, the method comprising the following steps:
a) creating a plurality of enterprise data subsets comprising at least the following subsets: project spaces, internal and external connectivity tools, goals, achievements, organizational structures, personnel names, personnel roles, client contacts, supplier contacts, market sectors, goods produced, services produced, databases tools and social media marketing tools and storing said plurality of enterprise data subsets in said memory device;
b) identifying a set of enterprise work flow processes and storing said set of enterprise work flow processes in the memory device;
c) accessing the memory device for content for said wizard program and using the wizard program for guiding a user in creating said user interface;
d) using said plurality of user interface activities gadget programs segmenting the user interface into a plurality of activity areas representative of the set of enterprise work flow processes; and,
e) using the wizard program customizing the user interface by inputting said content in said input fields.
